(19) United States
(12) Patent Application Publication
(10) Pub. No.: US 2025/0209366 A1
(43) Pub. Date: Jun. 26, 2025

(54) METHOD AND SYSTEM FOR QUANTUM ERROR MITIGATION

(71) Applicant: Yissum Research Development Company, Jerusalem (IL)

(72) Inventors: Raam UZDIN, Atzmon Segev (IL); Carlos Ivan HENAO OSORIO, Cundinamarca (CO); Jader PEREIRA DOS SANTOS, Ponta Grossa (BR)

(21) Appl. No.: 18/849,579

(22) PCT Filed: Mar. 7, 2023
(86) PCT No.: PCT/IL2023/050236

§ 371 Date: Sep. 23, 2024

Related U.S. Application Data
(60) Provisional application No. 63/269,828, filed on Mar. 23, 2022.

(51) Int. Cl. G06N 10/70

(52) U.S. Cl. CPC G06N 10/70

(57) ABSTRACT

Some embodiments relate to a method and system for quantum error mitigation (QEM) of noise in a quantum system configured to execute a quantum circuit, wherein the noise induces an error on a noise-free evolution U of the quantum circuit. The method comprises: defining a noisy evolution operator, [symbol] , associated with a noisy evolution of the quantum circuit, operator, [symbol] , configured to execute a Hamiltonian drive H(t) which generates the noise-free evolution U in the absence of noise; defining a corresponding inverse noisy evolution operator, [symbol] , being a pulse inverse operator configured to execute a corresponding inverse Hamiltonian drive H_{I}(t); and creating an operator [symbol] , which is an approximate square of a noise channel associated with the operator [symbol] , said operator [symbol] representing execution of the Hamiltonian drive H(t) followed by execution of the corresponding inverse Hamiltonian drive H_{I}(t) thereby enabling error mitigation of noise in the quantum system.

### CROSS-REFERENCE TO RELATED APPLICATIONS

This application is a national phase filing under 35 C.F.R. § 371 of and claims priority to PCT Patent Application No. PCT/IL2023/050236, filed on Mar. 7, 2023, which claims the priority benefit under 35 U.S.C. § 119 of U.S. Patent Application No. 63/296,828, filed on Mar. 23, 2022, the contents of each of which are hereby incorporated in their entireties by reference.

### TECHNOLOGICAL FIELD

The present disclosure is generally in the field of quantum computing and quantum devices [to be less restrictive], and relates to a method and system for quantum error mitigation (QEM) of noise in a quantum system.

### BACKGROUND ART

References considered to be relevant as background to the presently disclosed subject matter are listed below:
1. K. Temme, S. Bravyi, J. M. Gambetta, Error mitigation for short-depth quantum circuits. Physical review letters 119, 180509 (2017).
2. Y. Li, S. C. Benjamin, Efficient variational quantum simulator incorporating active error minimization. Physical Review X 7, 021050 (2017).
3. S. Endo, S. C. Benjamin, Y. Li, Practical quantum error mitigation for near-future applications. Physical Review X 8, 031027 (2018).
4. A. Strikis, D. Qin, Y. Chen, S. C. Benjamin, Y. Li, Learning-based quantum error mitigation. PRX Quantum 2, 040330 (2021).
5. P. Czarnik, A. Arrasmith, P. J. Coles, L. Cincio, Error mitigation with Clifford quantum-circuit data. Quantum 5, 592 (2021)
6. B. Koczor, Exponential error suppression for near-term quantum devices. Physical Review X 11, 031057 (2021).
7. W. J. Huggins, S. McArdle, T. E. OBrien, J. Lee, N. C. Rubin, S. Boixo, K. B. Whaley, R. Babbush, J. R. McClean, Virtual distillation for quantum error mitigation. Physical Review X 11, 041036 (2021).
8. T. Giurgica-Tiron, Y. Hindy, R. LaRose, A. Mari, W. J. Zeng, Digital zero noise extrapolation for quantum error mitigation. In 2020 IEEE International Conference on Quantum Computing and Engineering (QCE) (IEEE, 2020), 306-316 (2020).
9. Z. Cai, Quantum error mitigation using symmetry expansion. Quantum 5, 548 (2021).
10. A. Mari, N. Shammah, W. J. Zeng, Extending quantum probabilistic error cancellation by noise scaling. Physical Review A 104, 052607 (2021).
11. A. Lowe, M. H. Gordon, P. Czarnik, A. Arrasmith, P. J. Coles, L. Cincio, Unified approach to data-driven quantum error mitigation. Physical Review Research 3, 033098 (2021).
12. Y. Kim, C. J. Wood, T. J. Yoder, S. T. Merkel, J. M. Gambetta, K. Temme, A. Kandala, Scalable error mitigation for noisy quantum circuits produces competitive expectation values. https://arxiv.org/abs/2108.09197 (2021).
13. E. Berg, Z. K. Minev, A. Kandala, K. Temme, Probabilistic error cancellation with sparse Pauli-Lindblad on noisy models quantum processors. https://arxiv.org/abs/2201.09866 (2022).
14. S. Ferracin, A. Hashim, J. L. Ville, R. Naik, A. Carignan-Dugas, H. Qassim, A. Morvan, D. I. Santiago, I. Siddiqi, and J. J. Wallman, Efficiently improving the performance of noisy quantum computers. https://arxiv.org/pdf/2201.10672.pdf
15. S. Endo, Z. Cai, S. C. Benjamin, and X. Yuan, Hybrid Quantum-Classical Algorithms and Quantum Error Mitigation. J. Phys. Soc. Jpn. 90, 032001 (2021).
16. A. Kandala, K. Temme, A. D. Córcoles, A. Mezzacapo, J. M. Chow, J. M. Gambetta, Error mitigation extends the computational reach of a noisy quantum processor. Nature 567, 491 (2019).
17. C. Song, J. Cui, H. Wang, J. Hao, H. Feng, Y. Li, Quantum computation with universal error mitigation on a superconducting quantum processor. Science advances 5, eaaw5686 (2019).
18. M. Urbanek, B. Nachman, V. R. Pascuzzi, A. He, C. W. Bauer, and W. A. de Jong, Mitigating depolarizing noise on quantum computers with noise-estimation circuits. Physical Review Letters 127, 270502 (2021).
19. S. Zhang, Y. Lu, K. Zhang, W. Chen, Y. Li, J.-N. Zhang, K. Kim, Error-mitigated quantum gates exceeding physical fidelities in a trapped-ion system. Nature communications 11, 1-8 (2020).
20. R. Sagastizabal, X. Bonet-Monroig, M. Singh, M. A. Rol, C. Bultink, X. Fu, C. Price, V. Ostroukh, N. Muthusub-ramanian, A. Bruno, et al., Experimental error mitigation via symmetry verification in a variational quantum eigensolver. Physical Review A 100, 010302 (2019).
21. A. He, B. Nachman, W. A. de Jong, C. W. Bauer, Zero-noise extrapolation for quantum-gate error mitigation with identity insertions. Physical Review A 102, 012426 (2020).
22. B. Zhang, S. Majumder, P. H. Leung, S. Crain, Y. Wang, C. Fang, D. M. Debroy, J. Kim, K. R. Brown, Hidden Inverses: Coherent Error Cancellation at the Circuit Level. Phys. Rev. Applied 17, 034074 (2022).

Acknowledgement of the above references herein is not to be inferred as meaning that these are in any way relevant to the patentability of the presently disclosed subject matter.

### BACKGROUND

Quantum computers have now entered a stage where even the most powerful classical computers cannot rival them at certain specific tasks. Despite this enormous progress, current quantum computers are subjected to substantial levels of noise that must first be handled for quantum algorithms to be competitive in problems of practical interest. Quantum error correction stands as the primary candidate towards this goal, yet its integration in problems such as Shor's factoring algorithm may require thousands of physical qubits per each encoded logical qubit.

Quantum error mitigation (QEM) is a more recent alternative that has gained widespread attention over the last few years [1-15]. Its potential has also been demonstrated in various experiments with superconducting circuits [16-18], trapped ions [19], and circuit QED [20]. QEM protocols aim to estimate ideal expectation values from a set of noisy measurements, without the QEC hardware overhead. Hence, they stand out as a possible near future solution for achieving quantum advantage in useful computational tasks [12].

### GENERAL DESCRIPTION

There is a need in the art for a novel approach for quantum error mitigation (QEM) of noise in a quantum system which executes a specific quantum circuit. Such noise induces an error on a noise-free evolution U of the quantum circuit and error(s) associated with such noise are to be filtered out.

Noise is currently the main bottleneck in building better, larger, and more useful quantum devices. This applies to present-day quantum computers, quantum simulators, quantum sensors, and more.

The goal of QEM is to mitigate errors in post processing rather than correcting them in real time. For example, the zero-noise extrapolation (ZNE) approach [1] employs circuits that are logically equivalent to the ideal target evolution but have a controllable error rate. The noiseless quantity is estimated via extrapolation to the zero-noise limit, after a fitting of noisy data to some noise scaling ansatz. However, it has been noted that ZNE is typically restricted to weak noise and may fail to mitigate errors of moderate magnitude [1, 5]. In addition, a proper noise scaling for ZNE depends on simplified noise models such as time-independent noise [1] or global depolarization [8] or assumes the ability to precisely scale the noise via circuits that ideally reproduce the identity operation [21]. Alternative QEM approaches do not rely on these assumptions but consider errors featuring limited spatial or temporal correlations [1, 3, 4, 13, 14], or resort to machine learning protocols [4, 5] with a non-established computational cost. Consequently, it is unclear whether these alternatives are applicable to large quantum circuits.

The present disclosure provides a novel QEM technique, which is termed here as the “KIK method” for QEM based on pre-defined target evolution operators including a noisy evolution operator, [symbol] , of the quantum circuit and a corresponding inverse noisy evolution operator, [symbol] , which are configured, respectively, to execute a Hamiltonian drive H(t) which generates said noise-free evolution U in the absence of noise, and corresponding inverse Hamiltonian drive H_{I}(t)=−H(T−t) where T is total execution time of operator [symbol] . These operators are used to create operator [symbol] , which is an approximate square of a noise channel associated with [symbol] . Operationally, [symbol] corresponds to execution of the Hamiltonian drive H(t) followed by execution of the corresponding inverse Hamiltonian drive H_{I}(t).

This novel technique can be used to mitigate the effect of noise (in particular, time-dependent noise), by executing a predetermined ensemble (circuit sequencies) of the operators [symbol] and [symbol] in a predetermined order that only contain the target evolution and its inverse.

The present disclosure provides a protocol and supporting theory for mitigating Markovian noise. The protocol works for low to moderate noise and has no computational overhead or scaling issues.

Furthermore, the QEM accuracy is determined by the number of circuit sequences, irrespective of the size of the system. The KIK method adapts to the noise level of the quantum system (e.g., physical device) for improved QEM under strong noise. In the weak noise limit, the inventors have found that the QEM method explains how to properly carry out a known in the art method, the circuit unitary folding Richardson ZNE [8]. By using the correct inverse, the KIK method avoids the intrinsic errors associated with the circuit unitary folding.

According to the one broad aspect of the present disclosure, it provides a method for quantum error mitigation (QEM) of noise in a quantum system configured to execute a quantum circuit, said noise inducing an error on a noise-free evolution U of said quantum circuit the method comprising:
defining a noisy evolution operator, [symbol] , associated with a noisy evolution of said quantum circuit, said noisy evolution operator, [symbol] , being configured to execute a Hamiltonian drive H(t) which generates said noise-free evolution U in the absence of noise; and
defining a corresponding inverse noisy evolution operator, [symbol] _{I}, being a pulse inverse operator configured to execute a corresponding inverse Hamiltonian drive H_{I}(t)=−H(T−t) where T is total execution time of [symbol] ;
creating an operator [symbol] , which is an approximate square of a noise channel associated with [symbol] , said operator [symbol] representing execution of said Hamiltonian drive H(t) followed by execution of said corresponding inverse Hamiltonian drive H_{I}(t), thereby enabling error mitigation of noise in said quantum system.

The operator [symbol] is utilized to perform the quantum error mitigation of noise in said quantum system by executing a predetermined ensemble of said operators [symbol] and [symbol] in a predetermined order.

In some embodiments, said approximate square of the noise channel operator [symbol] is utilized to define a noise mitigated evolution operator, [symbol] _{KIK}, as

$${𝒰}_{KIK} = 𝒦 \frac{1}{\sqrt{{𝒦}_{I} 𝒦}} .$$

To this end, the following protocol can be executed to perform the quantum error mitigation:
defining an Mth-order (M≥0) approximation [symbol] _{KIK}^{(M)} of said noise mitigated evolution operator [symbol] _{KIK}, as [symbol] _{KIK}^{(M)}=Σₘ₌₀^{M}aₘ^{(M)} [symbol] ( [symbol] )^{m}, with coefficients {aₘ^{(M)}}ₘ₌₀^{M};
choosing said coefficients {aₘ^{(M)}}ₘ₌₀^{M} by minimizing a difference between the function

$$\frac{1}{\sqrt{x}} and {\sum }_{m = 0}^{M} {a}_{m}^{( M )} {x}^{2 m + 1} ;$$

defining (M+1) different circuits, each circuit comprising: preparation of the initial state; a single execution of a circuit sequence in the form of [symbol] ( [symbol] )^{m} on the initial state, for 0≤m≤M; and measurement of a final state;
for each of said (M+1) circuits, executing Nₘ shots (Nₘ≥1) to acquire predetermined statistical accuracy of a measured observable A of interest;
for each m-th circuit sequence, calculating mean value of the measured observable [symbol] A [symbol] ₘ; and
calculating an expectation value, being an average [symbol] A [symbol] of a weighted mean of M values of the measured observables [symbol] A [symbol] ₘ, where weigths are determined by coefficients {aₘ^{(M)}}ₘ₌₀^{M}.

For example, the above can include the following:
dividing a total number N of shots, N=Σₘ₌₀^{M}Nₘ, into S sets {n₀, . . . , n_{M}}, S≥1, where in each set s, nₘ=Nₘ/S shots are executed for each circuit [symbol] ( [symbol] )^{m};
executing said S sets, each comprising Nₛ=Σₘ₌₀^{M}nₘ shots, such that each set is executed faster than a noise drift time scale of the quantum system;
measuring a value [symbol] A [symbol] ₛ corresponding to said observable of interest for each set s; and
calculating a final mitigated value for the observable of interest as:

$${〈 A 〉}^{m i t} = \frac{1}{S} {\sum }_{s = 1}^{S} {〈 A 〉}_{s} ,$$

thereby minimizing the effect of drift in the noise parameters during the execution of the shots.

In some embodiments, the noise dynamics arises from at least one of the following: (i) different noise of different elements of said quantum circuit; and (ii) uncontrollable changes in noise parameters.

In some embodiments, the noise inducing the error on the noise-free evolution U of said quantum circuit is spatially correlated.

In some embodiments, the noise inducing the error on the noise-free evolution U of said quantum circuit is coherent noise, being mitigated by first converting coherent errors into incoherent errors by randomized compiling.

The noise inducing the error on the noise-free evolution U of said quantum circuit may be Markovian or non-Markovian noise, and in the latter case the method also comprises implementing dynamical decoupling.

In some embodiments, utilizing the above-described protocol, time t of the noise-free evolution U of said quantum circuit is divided into p several intervals (p=1 . . . P), t₁ . . . t_{P}; a total noise mitigated evolution operator is defined [symbol] _{KIK}^{tot} as [symbol] _{KIK}^{tot}= [symbol] _{KIK}^{t1}· . . . · [symbol] _{KIK}^{tP}, thereby enabling to neglect small-magnitude higher order noise components and improve accuracy of the QEM.

In some embodiments, the Mth order approximation is Mth order Taylor expansion.

In some embodiments, the operator

$$\frac{1}{\sqrt{{𝒦}_{I} 𝒦}}$$

is approximated with a power series in a finite noise range, the approximation being chosen adaptively to optimize the QEM in a predetermined desired range of noise.

The quantum system may be a quantum computer, a quantum simulator, a quantum sensor, etc.

According to another broad aspect of the present disclosure, it provides a control system for controlling operation of a quantum system executing a quantum circuit, by carrying out the method according to any one of the preceding claims for quantum error mitigation (QEM) of noise in the quantum system, the control system comprising:
a first processor configured and operable to carry out the following: define a noisy evolution operator, [symbol] , associated with a noisy evolution of the quantum circuit and configured to execute a Hamiltonian drive H(t) which generates noise-free evolution U of the quantum circuit in the absence of noise; define a corresponding inverse noisy evolution operator, [symbol] , being a pulse inverse operator configured to execute a corresponding inverse Hamiltonian drive H_{I}=−H(T−t) T being total execution time of [symbol] ; and create an operator [symbol] , which is an approximate square of a noise channel associated with [symbol] , said operator [symbol] representing execution of said inverse noisy evolution operator, [symbol] , immediately after said noisy evolution operator, [symbol] , thereby enabling error mitigation of noise in said quantum system;
a noise-associated error mitigator utility configured and operable to utilize said operator [symbol] , to execute a predetermined ensemble of said operators [symbol] in a predetermined order.

The present disclosure, in its further aspect, provides a quantum system configured to execute a quantum circuit on an input state providing a measured observable, where the quantum system comprises the above-described control system.

The inventors have tested the KIK method on a ten-swap circuit and for calibrating a CNOT gate, using the IBM quantum computing platform. The inventors have shown that the KIK method consistently outperforms non-adaptive QEM, and QEM based on circuit folding. In typical calibration experiments, noise induces a bias in the gate parameters that translates into coherent errors. KIK-based calibration can efficiently mitigate these coherent errors by reducing the associated bias. Conversely, the inventors have found that circuit folding produces erroneous and inconsistent results. Further, the inventors have also simulated the fidelity obtained with a noisy ten-step Trotterization of the transverse Ising model on five qubits. For unmitigated fidelities as low as 0.85, the inventors have shown that second order mitigation produces final fidelities beyond 0.99.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 is a block diagram describing schematically the configuration and operation of the system implementing the QEM technique of the present disclosure;

FIGS. 2A and 2B exemplify, by way of a flow diagram, the QEM method according to the principles of the technique of the present disclosure;

FIG. 2C exemplifies the QEM technique of the present disclosure using various expansions of Mth-order (M≥0) approximation the noise mitigated evolution operator [symbol] _{KIK}^{(M)}=Σₘ₌₀^{M}aₘ^{(M)} [symbol] ( [symbol] )^{m} defined according to the technique of the present disclosure;

FIG. 3A is an exemplary schematic illustration of the Hamitonian that generate the pulse inverse; and FIG. 3B shows how the time-dependent dissipator [symbol] (t) is being time reversed when executing the pulse inverse;

FIGS. 4A to 4E schematically exemplify the QEM technique of the present disclosure; wherein FIG. 4A shows an ideal expectation value of some measured observable [symbol] A [symbol] obtained by executing an ideal, noiseless unitary (circuit); FIG. 4B shows that in practice, the circuit is never perfectly isolated from the environment, and therefore the value of measured observable [symbol] A [symbol] is modified by the presence of noise; FIG. 4C shows the first-order error mitigation protocol (“first-order KIK”) of the technique based on running a sequence of the noisy circuit, its pulse inverse [symbol] (t), and finally another run of the noisy circuit; FIG. 4D shows the error mitigation post-processing equation where the outcomes of FIG. 4B and FIG. 4C are combined to mitigate the leading order of the Markovian noise; and FIG. 4E shows another equation used to improve the mitigation by running more K_{I}K cycles;

FIGS. 5A and 5B exemplify two strategies to collect data for second-order error mitigation, using the KIK method of the present disclosure (the arrows indicate the order of implementation of different circuits), wherein FIG. 5A shows a strategy where the implementations (shots) are separated into repetitions of each circuit [symbol] ( [symbol] )^{m}, for 0≤m≤2 (horizontal groups); and FIG. 5B shows a strategy where the shots are divided into S sets (vertical groups) that include implementations of all the circuits [symbol] ( [symbol] )^{m};

FIGS. 6A and 6B show the results of the KIK method applied to a system with drifting noise, wherein FIG. 6A shows four time-dependent noise amplitudes fₖ(t) that appear in the dissipator of Eq. (63); and FIG. 6B shows the results of first-order and second-order mitigation as a function of the number of sets S;

FIGS. 7A and 7B show, respectively, a comparison between Taylor-expansion-based and first-order and second-order Chebyshev-based KIK mitigations. The horizontal axis corresponds to different random two-qubit circuits with decoherence noise on both qubits. The blue points show the error in the survival probability without any mitigation, and the red (green) points show the 1^{st}-order Taylor-based (ChebyshevU-based) KIK mitigation (FIG. 7A). The red (green) curve in the inset shows the difference between 1/√(1−x) and its 1^{st}-order Taylor (Chebyshev) approximation. The 1st-order ChebyshevU polynomial P₍₁₎^{ChebU}(x) was fitted for the interval x∈[0,0.2]. The purple curve shows an alternative polynomial that reduces the maximal interpolation error in x∈[0,0.2]. This slight change reduces the average error by 24% with respect to the Chebyshev 1st-order polynomial. FIG. 7B shows respective results for 2nd-order mitigation;

FIG. 8 shows eigenvalues of the Hessian matrix of Eq. (100), as a function g=g(μ). One of the eigenvalues is not visible because of its closeness to zero for 0≤g≤1;

FIGS. 9A and 9B show error-mitigated fidelity F(ρ_{f}^{(id)}, ρ_{f}^{(M)}) in Ising model trotterization, between the final states |ρ_{f}^{(id)} [symbol] = [symbol] ₁₀|ρ [symbol] and |ρ_{f}^{(M)} [symbol] := [symbol] _{KIK}^{(M)}|ρ [symbol] . Each curve is obtained by evaluating the coefficients aₘ^{(M)}[g(μ)] in the Mth-order approximation [symbol] _{KIK}^{(M)}=Σₘ₌₀^{M}aₘ^{(M)}[g(μ)] [symbol] ( [symbol] )^{m} at the functions g(μ) indicated in FIG. 9A, wherein FIGS. 9A and 9B show, respectively, the results for ξ=0.00106 and ξ=0.00223.

FIGS. 10A and 10B show enhancement ratio, r_{F}(M) (Eq. 111) which is the ratio between the infidelity before QEM and after QEM and which quantifies the infidelity suppression provided by the KIK method, wherein FIG. 10A shows results for ξ=0.00106 and FIG. 10B shows results for ξ=0.00223.

FIGS. 11A and 11B show schematically the QEM circuits used in the experiments of ten-swap circuit and CNOT gate calibration, wherein FIG. 11A shows the general form of a KIK circuit [symbol] ( [symbol] )^{m}, and FIG. 11B shows the evolution [symbol] used for the CNOT calibration experiment (left), and for the ten-swap experiment (right);

FIGS. 12A and 12B show calibration of the pulse amplitude of a CNOT gate in the IBM processor Jakarta, using the KIK method. In FIG. 12A [symbol] is given by the pulse inverse and in FIG. 12B [symbol] is given by the circuit inverse [symbol] = [symbol] . The initial state is ρ=|ψ [symbol] [symbol] ψ|, with

$$\vert ψ 〉 = \frac{1}{\sqrt{2}} ( \vert 0 〉 + \vert 1 〉 ) ⊗ \vert 0 〉 .$$

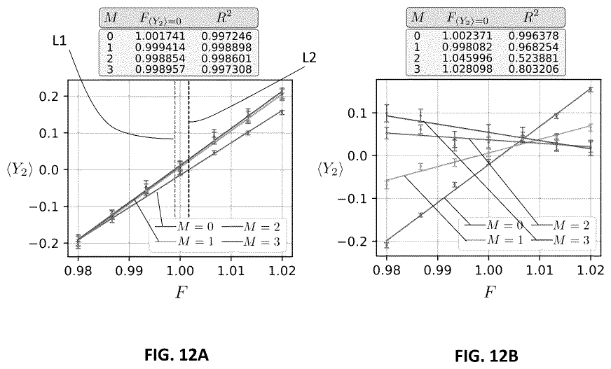

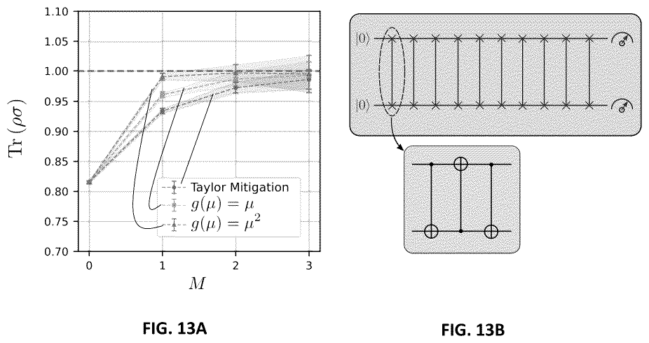

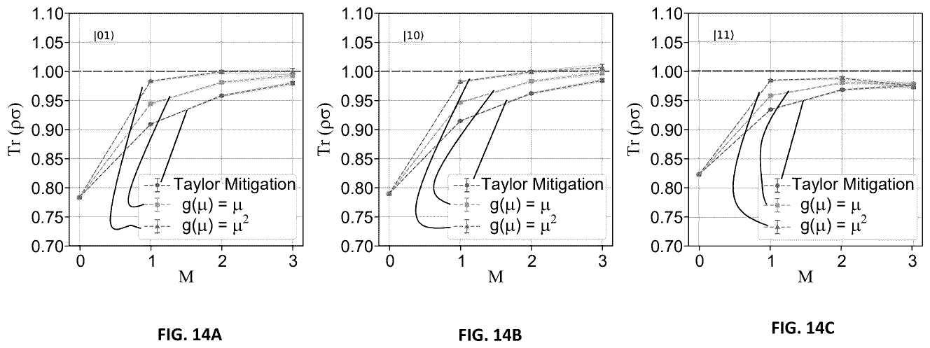

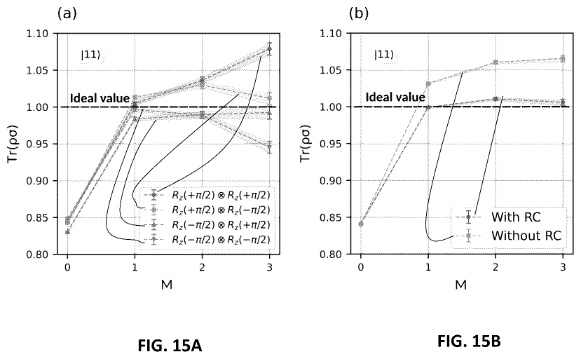

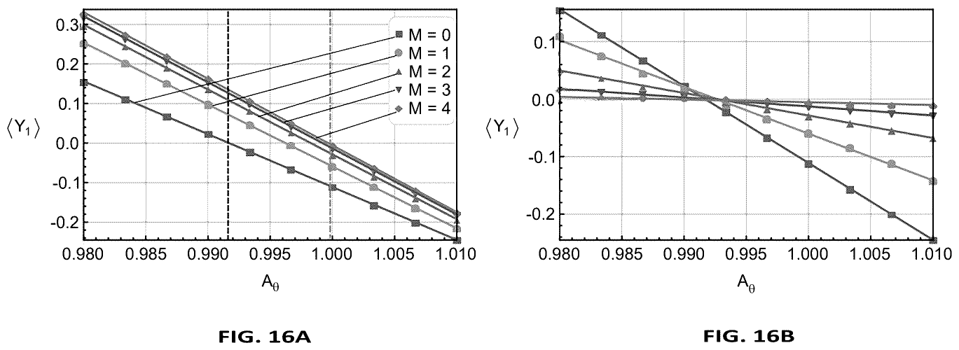

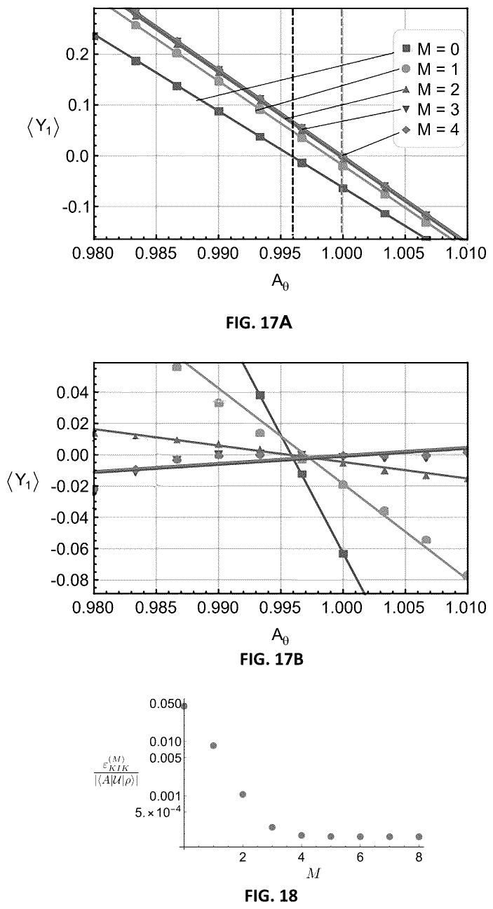

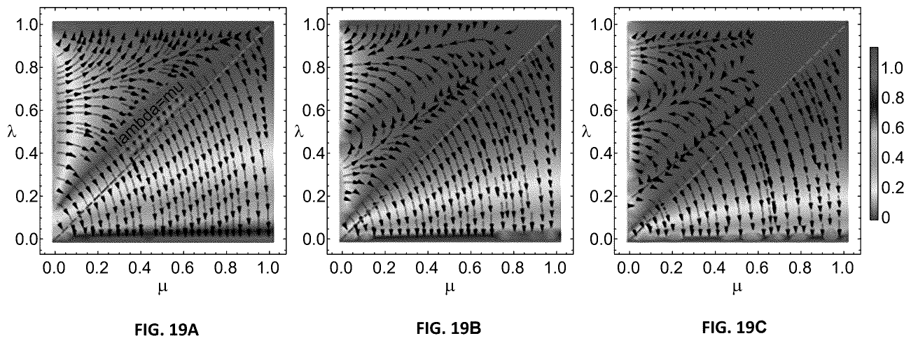

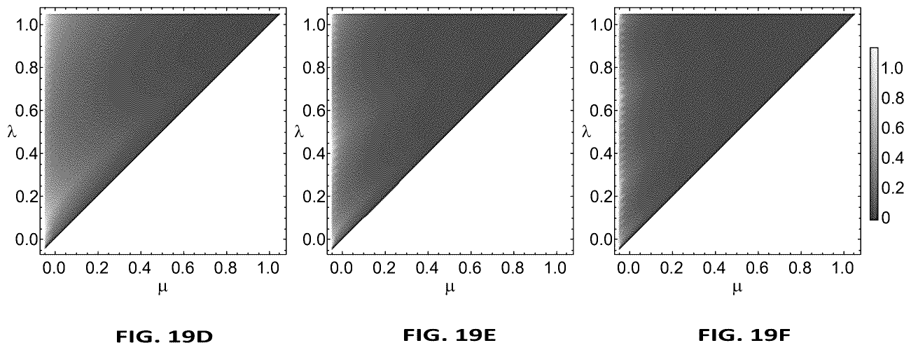

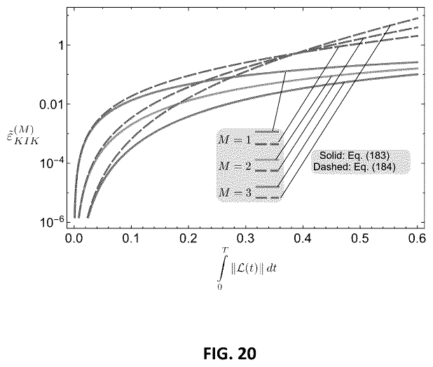

The default amplitude is increased by the factors F shown in x axis of the figures, and for each factor Eq. (28) is applied to evaluate the expectation value [symbol] Y₂ [symbol] , where Y₂ is the y-Pauli matrix acting on the target qubit. The factor [symbol] corresponds to the ideal expectation value [symbol] Y₂ [symbol] =0 and yields the calibrated amplitude. The factors [symbol] associated with the magenta and black dashed lines are different, which indicates a shift in the amplitude obtained without KIK calibration. In FIG. 12B, the convergence achieved for increasing M in FIG. 12A is spoiled by the use of the circuit inverse;

FIGS. 13A and 13B describe experimental QEM in the IBM processor Quito, wherein FIG. 13A shows the error-mitigated survival probability and FIG. 13B shows the circuit used in the experiment where each swap is implemented as a sequence of three CNOTs. In FIG. 13A the ideal survival probability is 1 (dashed red line), green and orange curves show QEM adapted to the noise intensity, and the blue curve stands for mitigation assuming weak noise (Taylor mitigation). The shaded area is the experimental uncertainty corresponding to one standard deviation. It can be seen that Taylor mitigation is outperformed by adapted mitigation;

FIGS. 14A to 14C describe the experimental QEM in the IBM processor Quito; wherein the error-mitigated survival probability for the ten-swap experiment, is shown for initial states |01 [symbol] (FIG. 14A), |10 [symbol] (FIG. 14B), and |11 [symbol] (FIG. 14C). The ideal survival probability is 1 (dashed red line). Green and orange curves show QEM adaptive to the noise intensity, and the blue curve stands for mitigation assuming weak noise (Taylor mitigation). The thin colored areas connect small experimental error bars.

FIGS. 15A and 15B describe the effect of coherent errors on the error-mitigated survival probability for the ten-swap experiment. The ideal survival probability is 1 (dashed black lines). All the plots show adaptive mitigation using g(μ)=μ²; wherein FIG. 15A shows the error-mitigated survival probability for different initial rotations. The thin colored areas connect small experimental error bars; FIG. 15B shows the error-mitigated survival probability obtained with randomized compiling (RC) (blue curve) and without RC (orange curve).

FIGS. 16A and 16B show simulation of the calibration of a noisy CNOT gate, for noise strength ξ= 2/100. The curves show the expectation value of Y₁=I⊗Y as a function of the angle amplitude A_{θ}, which determines the angle θ=A_{θ}(π/2) in the cross-resonance interaction H_{CR} (cf. Eq. (10)). The calibrated amplitude corresponds to [symbol] Y₁ [symbol] =0 (cyan dashed line). Different curves stand for different mitigation orders 0≤M≤4. FIG. 16A shows the results when using the pulse inverse as required by the KIK method and FIG. 16B shows the erroneous results when using the circuit folding method.

FIGS. 17A and 17B are the same as FIGS. 16A and 16B but with noise strength ξ= 1/100.

FIG. 18 shows KIK mitigation as a function of mitigation order, i.e., the number of KIK cycles. Two qubits interact via σₓ⊗σ_{z} interaction and each qubit undergoes decoherence. The chosen observable is A=|00 [symbol] 00| and the initial state is the ground state |00 [symbol] 00|. m=0 corresponds to the original noisy channel without mitigation. The graph shows that the KIK mitigation exponentially suppresses the error until a saturation is observed (in this example at m=5); Taylor coefficients were used in this simulation.

FIGS. 19A to 19F show plots used in the derivation of the bound in Eqs. (168) and (171). FIGS. 19A to 19C are color density plots of f_{M}(μ, λ):=|1−Σₘ₌₀^{M}a_{Adap,m}^{(M)}(μ)(λ)^{m+1/2}|, for M=1, M=2, and M=3, respectively. The streamlines depict the gradient of f_{M}(μ, λ); In particular, the figures show that for λ≤μ the functions f_{M}(μ, λ) are monotonically decreasing with respect to λ, and monotonically increasing with respect to μ; and FIGS. 19D to 19F are color density plots of f_{M}(μ, μ)−f_{M}(μ, λ) (with 1≤M≤3 increasing from left to right), for λ≥μ, and show that in this interval f_{M}(μ, μ)≥f_{M}(μ, λ); and

FIG. 20 shows the upper bounds of Eqs. (191) and (192) on

$${\tilde{ε}}_{KIK}^{( M )} := \frac{{ε}_{KIK}^{( M )}}{\sqrt{Tr ( {A}^{2} ) - \frac{{[ Tr ( A ) ]}^{2}}{Tr ( I )}}} ,$$

for mitigation orders M=1, 2, 3.

### DETAILED DESCRIPTION OF EMBODIMENTS

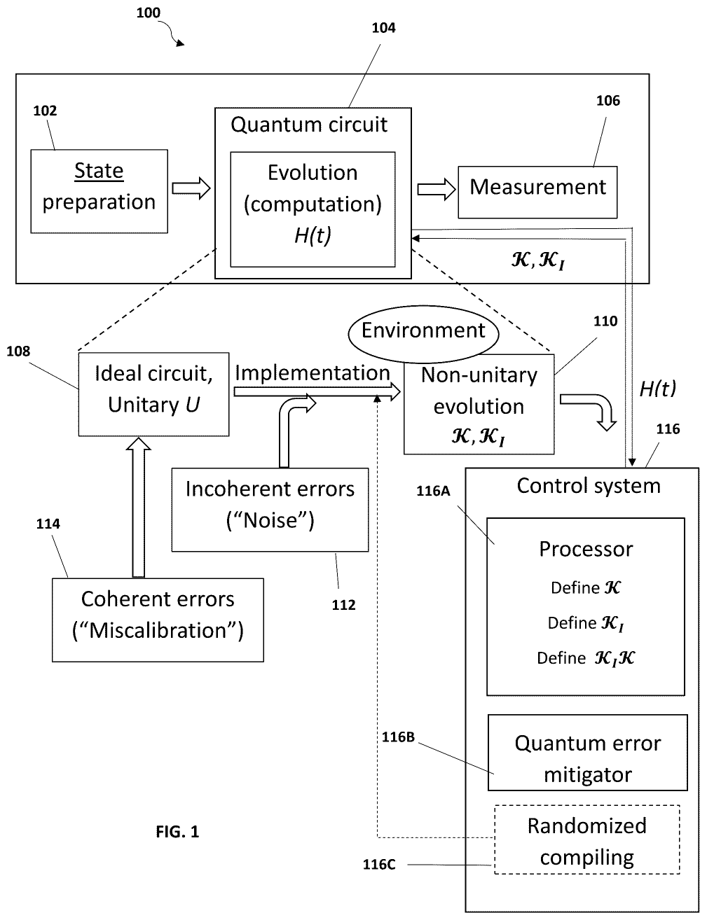

Reference is made to FIG. 1 showing schematically a quantum system 100 utilizing/associated with a control system 116 according to the present disclosure. The quantum system 100 may represent any one of a quantum computer, a quantum simulator or a quantum sensor, as well as any other physical device implementing quantum operations whose quality is affected by noise. Such noise is typically uncontrollably changing, and the uncontrollable changes in the noise parameters can be caused by many factors such as temperature variation, stray magnetic fields, any other physical agents that affect the noise parameters.

The quantum system 100 typically includes a quantum state preparation module 102 configured to initialize the quantum system into a certain known/given initial quantum state. The quantum system 100 is configured to execute a quantum circuit 104 to create a desired final state that can be determined as a measured observable of interest. In other words, quantum operations defined by the quantum circuit 104 evolve the initial quantum state such that information encoded in the final state of the quantum system after computation/sensing (execution of the quantum circuit) corresponds to the desired answer after measurement 106 with a high probability.

As further specifically illustrated in FIG. 1, at the device level, the execution of the computation/sensing is implemented by subjecting [steering is a technical term that can be confusing] the qubit(s) to a desired unitary evolution 108, which is achieved by proper operation of the control system 116 to provide control fields/signals. Coherent and/or incoherent noise-associated errors can take place in each one of the above-described stages, i.e., state preparation 102, evolution (computation) of the quantum circuit 104, and measurement 106.

Incoherent errors/noise 112 affecting the evolution stage 104, e.g., through interaction with the environment and subsequent decoherence, result in a non-ideal and non-unitary evolution 110 of the quantum circuit 104. Coherent errors 114, e.g., miscalibrations,, can affect the evolution of the total quantum circuit 104 and not only individual gates, leading to errors in the observables of interest. Although coherent error leaves the evolution of the quantum circuit unitary, the miscalibrated gate parameters typically feature erroneous values during measurement. Further below, the inventors have found that noise is a mechanism inducing coherent errors, occurring due to noise-induced biased gate parameters that translate into coherent errors.

Typically, execution of the modeled quantum circuit 104 on the quantum system 100 requires translating or compiling gate-level circuit instructions to a set of e.g., microwave control instructions, or pulses, which enact the desired state-transformations. In the circuit programming model (predefined execution protocol), an atomic circuit instruction is agnostic to its pulse-level implementation on hardware, and the vast majority of program optimization is often done at the gate level in the standard circuit model. Extracting the highest performance out of quantum hardware would require the ability to craft a pulse-level instruction schedule for the optimization of circuit partitions. The control signals applied on the device level offer much richer and more flexible controllability than the gate level quantum instruction set architecture.

The technique of the present disclosure utilizes the fact that any quantum circuit is ultimately generated by some pulse schedule Hamiltonian H(t) that can drive the quantum system's hardware to the desired quantum states. The Hamiltonian H(t) of the quantum system 100 is an operator that determines the evolution path of the quantum states. The ability to engineer the real-time system Hamiltonian allows one to navigate the quantum system to the quantum state of interest through generating accurate operating signals.

The control system 116 according to the present disclosure includes a processor 116A and a quantum error mitigator utility 116B. The processor 116A is configured (preprogrammed) to receive data indicative of such given Hamiltonian H(t) of the specific quantum circuit and define novel evolution operators by considering how noise comes into play for a given driving H(t). These operators include: noisy evolution operators, [symbol] and [symbol] , wherein operator [symbol] is associated with the noisy evolution of the quantum circuit 104 and is configured to execute the given Hamiltonian drive H(t) which generates the noise-free evolution U in the absence of noise, and operator [symbol] is a corresponding inverse noisy evolution operator which is configured to execute a corresponding inverse Hamiltonian drive H_{I}(t)=−H(T−t) where T is the total execution time of operator [symbol] . Further, the processor 116A creates an operator [symbol] , which is an approximate square of a noise channel associated with [symbol] , and represents execution of the inverse noisy evolution operator, [symbol] , immediately after the noisy evolution operator, [symbol] . The quantum error mitigator 116B generates data indicative of predetermined ensemble of said operators [symbol] and [symbol] in a predetermined order, and the quantum circuit 104 is updated with corresponding operational data causing the quantum circuit to perform non-unitary evolution 110 to thereby enable error mitigation of noise in the quantum system.

It should be noted that in the weak noise limit, the inventors have found that this technique of the present disclosure bares similarity to the Richardson zero noise extrapolation (ZNE) technique using circuit unitary folding [8]. The circuit folding approach [8] increases the noise during error mitigation by either employing “circuit folding” U†U or by using only gate-level control. This implies, that gates such as cnot, cphase, and swap are used as their own inverse. The technique of the present disclosure elucidates why circuit folding fails when the noise in the system is only slightly more complicated than the nonrealistic global depolarizing noise channel.

As will be described further below, the tests performed by the inventors on a ten-swap circuit and for calibrating a CNOT gate, using the IBM quantum computing platform have shown that the technique of the present disclosure consistently outperforms QEM based on circuit folding, regardless of the intensity of the noise. Conversely, the inventors have found that circuit folding [8] produces erroneous and inconsistent results. Thus, contrary to the circuit folding approach, the technique of the present disclosure utilizes proper implementation of the inverse operator through the definition of the inverse noisy evolution operator, [symbol] , as will be described more specifically further below.

As further shown in FIG. 1, the control system 116 may also include a processor 116C operable as a randomized compiling (RC) module which enables the mitigation of general coherent errors that can affect the total circuit and not only individual gates. The RC module converts the coherent errors into incoherent errors that can be effectively mitigated with the method described in the present disclosure.

As an alternative to mitigation of coherent errors using RC+KIK, in an exemplary calibration experiment described further below, the inventors exemplify that noise induces biased gate parameters that translate into coherent errors. Using calibration based on the technique of the present disclosure, it is shown that these coherent errors can be efficiently mitigated by reducing the associated bias. The performance observed is comparable to RC.

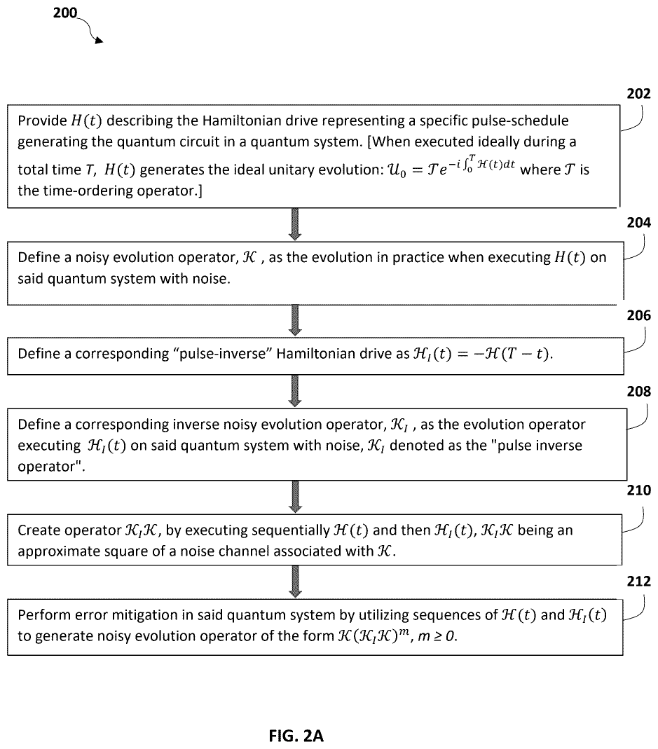

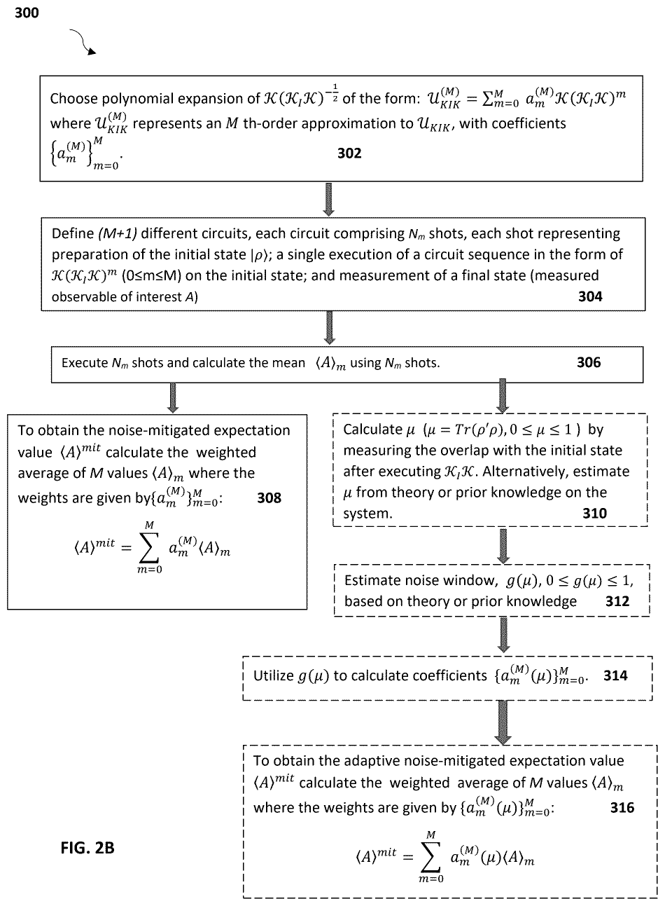

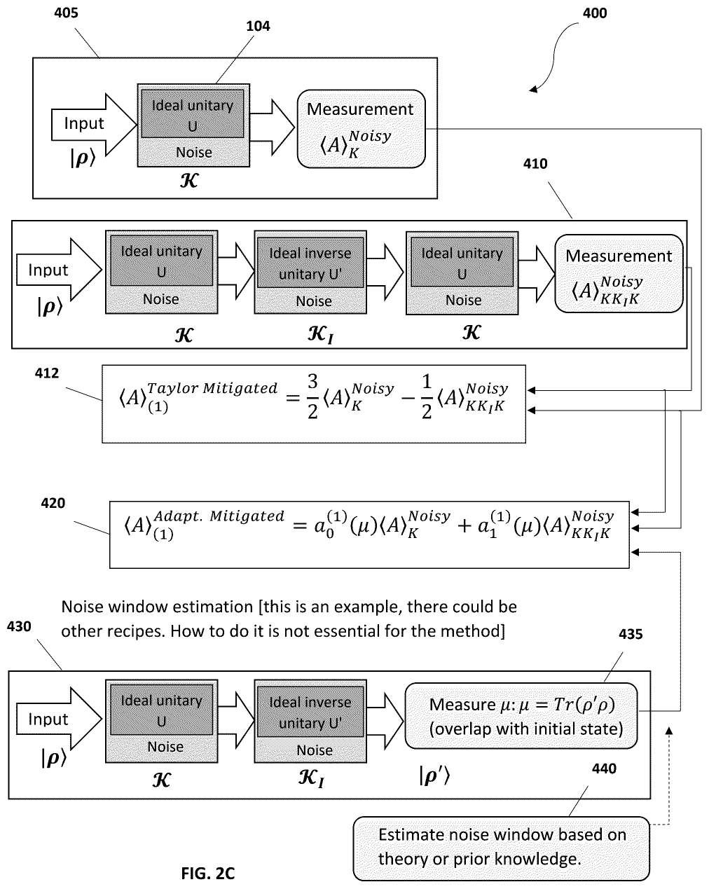

Reference is made to FIG. 2A showing an exemplary flow diagram 200 of a method of the present disclosure for quantum error mitigation (QEM) of noise in a quantum system configured to execute a quantum circuit. As mentioned above, any quantum circuit is ultimately generated by some pulse schedule Hamiltonian H(t) that drives the quantum system's hardware from an initial state to desired final quantum states.

Even in the circuit model of quantum computing, where unitary operations are composed of discrete quantum gates, each elementary gate is itself generated by a pulse schedule that can be represented as a time-dependent Hamiltonian.

Thus, in the first step 202, a time-dependent Hamiltonian H(t) is provided describing the Hamiltonian drive representing a specific pulse-schedule generating the quantum circuit in the quantum system. When executed ideally (in the absence of noise) during a total time T, the Hamiltonian drive H(t) generates the ideal (noise-free) unitary evolution:

$${𝒰}_{0} = 𝒯 {e}^{- i {\int }_{0}^{T} ℋ ( t ) dt}$$

where [symbol] is the time-ordering operator.

It should be understood that in applications involving quantum simulators, the Hamiltonian drive H(t) is to be explicitly provided/defined for the specific simulated quantum system, whereas, in applications involving quantum computers based on specific hardware and quantum sensing systems, the Hamiltonian drive H(t) needs to be provided/known in order to define the operators of the method.

In the next step 204, a noisy evolution operator, [symbol] , is defined as the evolution in practice, when executing Hamiltonian H(t) on the quantum system with noise. A corresponding “pulse inverse” Hamiltonian drive is then defined (step 206) as

$${ℋ}_{I} ( t ) = - ℋ ( T - t ) ,$$

implying that the level of control required for implementing [symbol] _{I}(t) is very similar to that used for H(t). In essence, one only needs to time-reverse the pulse schedule corresponding to H(t) and flip its sign.

A corresponding inverse noisy evolution operator, [symbol] , is defined (step 208) as the evolution operator executing the pulse inverse Hamiltonian drive [symbol] _{I}(t) on the quantum system with noise. This operator [symbol] is denoted as the “pulse inverse operator”.

In the absence of noise, the pulse inverse operator [symbol] coincides with the inverse unitary [symbol] †₀; and relates in a simple way to the pulse schedule used for the noisy evolution operator [symbol] . The two operators, the noisy evolution operator [symbol] and the corresponding pulse inverse operator [symbol] , are utilized to create an operator [symbol] (step 210), where the term “KIK method” is a reference to the product [symbol] . The [symbol] operator implies executing sequentially the noisy evolution operator [symbol] (i.e., executing H(t)), and then the pulse inverse operator [symbol] (i.e., executing [symbol] _{I}(t)), operator [symbol] being an approximate square of a noise channel associated with noisy evolution operator [symbol] .

It should be noted that although in the absence of noise execution of both [symbol] and [symbol] reproduces the identity operation, in the presence of noise one cannot substitute [symbol] by [symbol] . This is clarified further below in detail, where the inventors show that to a leading order in the noise in holds that

[symbol]

= [symbol] †.

The error mitigation in the quantum system is performed (step 212) by utilizing sequences of [symbol] (t) and [symbol] _{I}(t) to generate noisy evolution operator of the form [symbol] ( [symbol] )^{m}, m≥0.

In the following, non-limiting examples are described in which the operator [symbol] is utilized to perform the quantum error mitigation of noise in the quantum system by executing a predetermined ensemble of the operators [symbol] and [symbol] in a predetermined order.

Reference is made to FIG. 2B exemplifying a protocol 300 to perform QEM in a quantum system. Utilizing the approximate square of the noise channel operator [symbol] , the inventors define a novel noise mitigated evolution operator, [symbol] _{KIK}, as

$${𝒰}_{KIK} = 𝒦 \frac{1}{\sqrt{{𝒦}_{I} 𝒦}}$$

and call the above definition as “KIK formula”.

The KIK formula is derived analytically further below, however here one could gain a simplistic/qualitative insight to its significance by considering that since single execution of noisy evolution operator [symbol] produces one batch of noise, and single execution of operator [symbol] produces noise squared, a single execution of the noise mitigated evolution operator [symbol] _{KIK} effectively cancels/mitigates the noise.

However, the operator ( [symbol] )^{-1/2} is not directly implementable in a quantum device. Therefore, in the first step 302 of method 300 a polynomial expansion of [symbol] ( [symbol] )^{-1/2} in the form:

$${𝒰}_{KIK}^{( M )} = {\sum }_{m = 0}^{M} {a}_{m}^{( M )} {𝒦 ( {𝒦}_{I} 𝒦 )}^{m}$$

is chosen, where [symbol] _{KIK}^{(M)} represents an Mth-order approximation to [symbol] _{KIK}, with coefficients {aₘ^{(M)}}ₘ₌₀^{M}. In the next step 304, the inventors define (M+1) different circuits, each circuit comprising Nₘ shots, where each shot represents preparation of the initial state |ρ [symbol] ; a single execution of a circuit sequence in the form of [symbol] ( [symbol] )^{m} (0≤m≤M) on the initial state; and measurement of a final state to obtain a measured observable of interest A. In step 306, the shots Nₘ shots are executed, and, for each m-th circuit sequence the mean value [symbol] A [symbol] ₘ for measured observable is calculated. In the last step 308, in order to obtain the noise-mitigated expectation value [symbol] A [symbol] ^{mit}, the weighted average of M values [symbol] A [symbol] ₘ is calculated, where the weights are given by {aₘ^{(M)}}ₘ₌₀^{M}:

$${〈 A 〉}^{mit} = {\sum }_{m = 0}^{M} {a}_{m}^{( M )} {〈 A 〉}_{m} .$$

Steps 310-316 exemplify an alternative stage (alternative to step 308) of obtaining the adaptive noise-mitigated expectation value. According to this alternative approach, the approximation is chosen adaptively to optimize the QEM in a predetermined desired range of noise. In this connection reference is also made to FIG. 2C which exemplifies a scheme 400 of implementation of a first order QEM using Taylor expansion to approximate [symbol] _{KIK}. In general, in this scheme 400 provides an algorithmic scheme that mitigates the noise in the expectation value of a quantum circuit 104 by post-processing outputs from an ensemble of quantum circuit runs, and the error mitigation is obtained after post-processing the whole ensemble of circuit runs. In the example of FIG. 2C, a first circuit 405 includes preparation of the initial state |ρ [symbol] ; a single execution of the noisy evolution operator [symbol] ; and a measurement of the noisy observable [symbol] A [symbol] _{K}^{Noisy} (this sequence of actions performed in circuit 405 is termed as “shot” in standard terminology of quantum computing). The second circuit 410 includes preparation of the initial state |ρ [symbol] ; a single execution of the noisy evolution operator [symbol] followed by a single execution of the noise channel operator [symbol] ; and a measurement of the noisy observable [symbol] A [symbol] _{KK}_{_{I}}_{K}^{Noisy} containing a tripled noise with a correct noise profile to serve for error mitigation.

The first-order error-mitigated value of the observable [symbol] A [symbol] may be written as

$${〈 A 〉}_{( 1 )}^{Taylor Mitigated} = \frac{3}{2} {〈 A 〉}_{K}^{Noisy} - \frac{1}{2} {〈 A 〉}_{{KK}_{I} K}^{Noisy}$$

where the weights in equation 412 are the two first coefficients of a Taylor expansion of the operator

$$\frac{1}{\sqrt{{K}_{I} K}} ,$$

assuming that the eigenvalue λ of the noise channel operator [symbol] is close to 1 and Taylor expanding λ^{-1/2} around λ=1.

It is noted that Taylor expansion gives a small error only in the vicinity of weak (close to zero) noise. However, the technique of the present disclosure is not limited to weak noise, and the inventors have shown that the operator

$$\frac{1}{\sqrt{{K}_{I} K}}$$

can be approximated with a power series in a finite noise range, the approximation being chosen adaptively to optimize the QEM in a predetermined desired range of noise.

Thus, the technique of the present disclosure adapts to the noise strength of the target device and can handle moderate-to-strong noise, as will be described in more detail further below.

FIG. 2C further shows a circuit 430 configured to execute the noise channel operator [symbol] on the initial state |ρ [symbol] to obtain the final state |ρ′ [symbol] . Several shots of this circuit are performed and the survival probability μ defined as μ=Tr(ρ′ρ) (overlap with initial state) is calculated (435 in FIG. 2C). μ does not have to be evaluated with high accuracy. As such, the overhead associated with its evaluation is negligible. This step 310 may follow step 306 of FIG. 2B as a preparatory step for adaptive QEM. In the next step 312, the noise window g(μ) is estimated which represents the expected noise range of the quantum system. The noise window g(μ) is used to calculate the coefficients {aₘ^{(M)}(μ)}ₘ₌₀^{M} (step 314) which optimally approximate [symbol] _{KIK} in the chosen noise window g(μ). To obtain the adaptive noise-mitigated expectation value [symbol] A [symbol] ^{mit} (step 316) the weighted average of M values [symbol] A [symbol] ₘ is calculated (316) where the weights are given by {aₘ^{(M)}(μ)}ₘ₌₀^{M}:

$${〈 A 〉}^{mit} = {\sum }_{m = 0}^{M} {a}_{m}^{( M )} ( μ ) {〈 A 〉}_{m}$$

Block 420 exemplifies schematically a first order adapted mitigation based on measured survival probability μ and analytically calculated noise window g(μ) (the calculation details will be described further below). Alternatively, estimation of g(μ) (step 440 in FIG. 2C) can be based on theory or on prior knowledge about the target device.

In the present disclosure, the Liouville-space formalism of Quantum Mechanics is adopted, in which density matrices that describe quantum states are written as vectors, and quantum operations as matrices that act on these vectors. In the following, calligraphic fonts are employed to denote quantum operations. For example, the unitary evolution associated with an ideal (noise-free) quantum circuit and its noisy implementation will be written as [symbol] and [symbol] , respectively.

In the standard description of Quantum Mechanics, a system of dimension d is represented by a density matrix ρ of dimension d×d. Moreover, a general quantum operation can be expressed as

$${ρ}^{′} = {\sum }_{i} {K}_{i} ρ {K}_{i}^{†} , \qquad ( 1 )$$

where ρ′ is a density matrix and {Kᵢ} are Kraus operators that satisfy the completeness relation ΣᵢK†ᵢKᵢ=I (I being the d×d identity matrix). Observables correspond to hermitian operators A, and the associated expectation value for system in the state ρ reads:

$$〈 A 〉 = Tr ( A ρ ) . \qquad ( 2 )$$

The Liouville space formalism is an alternative formulation that is particularly useful to simplify notation and handle quantum operations. In this framework, a density matrix is replaced by a vector |ρ [symbol] of dimension d² and a quantum operation is a matrix of dimension d²×d² Using the calligraphic notation [symbol] for a general quantum operation, the analogous of Eq. (1) in Liouville space is given by:

$$\vert {ρ}^{′} 〉 = \vert ρ 〉 . \qquad ( 3 )$$

Here, the approach of Ref. [13] is adopted, where |ρ [symbol] is the column vector whose first d components correspond to the first row of ρ, the next d components correspond to the second row of ρ, and so forth. More formally, the vector representation of a d×d generic matrix B (not necessarily a density matrix) is given by:

$$\vert B 〉 = {( {B}_{11} , {B}_{12} , … , {B}_{1 d} , {B}_{21} , {B}_{22} , … , {B}_{2 d} , … , {B}_{d 1} , {B}_{d 2} , … , {B}_{dd} )}^{T} ,$$

where Bᵢⱼ is the ij entry of B. With this convention, in Liouville space the quantum operation (1) takes the form [13]

$$\vert {ρ}^{′} 〉 = {\sum }_{i} {K}_{i} ⊗ {K}_{i}^{*} \vert ρ 〉 , \qquad ( 4 )$$

where K*ᵢ is the element-wise complex conjugate of Kᵢ. For example, a unitary operation ρ′=UρU† is written as |ρ′ [symbol] = [symbol] |ρ [symbol] , where [symbol] =U⊗U*.

Eq. (4) is obtained by following the rule to vectorize a product of three matrices B, C and D. Denoting the associated vector as |BCD [symbol] , this rule states that [13]

$$\vert BCD 〉 = B ⊗ {D}^{T} \vert C 〉 , \qquad ( 5 )$$

where the superscript T denotes transposition. Setting B=Kᵢ, C=ρ, and D=K†ᵢ, Eq. (4) follows by applying (5) to (1) and using the linearity property of the vectorization, which can be easily checked.

Finally, to express the expectation value (2) in Liouville space one writes A as a column row vector [symbol] A|=(A*₁₁, A*₁₂, . . . , A*_{1d}, . . . , A*_{d1}, A*_{d2}, . . . , A*_{dd}). In this way, the hermiticity of A leads to

$$\begin{matrix}〈 A \vert ρ 〉 = {\sum }_{i , j} {A}_{ij}^{*} {ρ}_{ij} \\ = {\sum }_{i , j} {A}_{ji} {ρ}_{ij} \\ = 〈 A 〉\end{matrix} . \qquad ( 6 )$$

As mentioned above, [symbol] is the unitary evolution operator associated with an ideal (noise-free) quantum circuit, and [symbol] is its noisy implementation. The KIK method of the present disclosure operates by executing circuit sequences where [symbol] is alternated with a suitable inverse evolution [symbol] . In the absence of noise, the inverse noisy evolution operator [symbol] coincides with the inverse unitary [symbol] †, and it is performed through a pulse schedule that relates in a simple way to the pulse schedule used for the noisy evolution operator [symbol] . Therefore, both operators [symbol] and [symbol] require the same level of control.

In the following, a detailed description of the operators [symbol] and [symbol] is presented.

The present disclosure considers a continuous-time description of the system evolution, modeled by the master equation:

$$\frac{d}{dt} ρ = - i [ H ( t ) , ρ ] + \hat{L} ( t ) [ ρ ] . \qquad ( 7 )$$

Here, H(t) is a time-dependent Hamiltonian and \hat{L}(t) is a time-dependent dissipator that accounts for the nonunitary contribution to the dynamics. The hat symbol in \hat{L}(t) is used to emphasize that it represents a superoperator in Hilbert space.

To specify the form of \hat{L}(t), one could invoke a microscopic description of the dynamics, where the system is coupled to some external environment and the total system obeys the Schrodinger equation. The time-independent case is extensively studied in the art, and various time-dependent Markovian master equations have been derived. The dissipator is often given in the Lindblad form, which represents the most general dissipator for Markovian and CPTP (completely positive and trace preserving) evolution. For the purposes of the present disclosure, this is not necessary. For example, \hat{L}(t) could incorporate leakage noise, which does not preserve probability and thus is not trace-preserving.

Now, Eq. (7) is rewritten in Liouville space. Using the linearity of the vectorization operation, one obtains:

$$\frac{d}{dt} \vert ρ 〉 = - i \vert [ H ( t ) , ρ ] 〉 + \vert \hat{L} ( t ) [ ρ ] 〉 , \qquad ( 8 )$$

where |[H(t), ρ] [symbol] and |\hat{L}(t)[ρ] [symbol] are the vectors corresponding to [H(t), ρ] and \hat{L}(t)[ρ], respectively. By applying the rule of Eq. (5) to the commutator [H(t), ρ]=H(t)ρ−ρH(t), one obtains:

$$\begin{matrix}\vert [ H ( t ) , ρ ] 〉 = \vert H ( t ) ρ 〉 - \vert ρ H ( t ) 〉 \\ = ( H ( t ) ⊗ I - I ⊗ {H ( t )}^{T} ) \vert ρ 〉 \\ := ℋ ( t ) \vert ρ 〉\end{matrix} , \qquad ( 9 )$$

where D is identified with the identity I for the product H(t)ρ, and with H(t) for ρH(t). In both cases, C is associated with ρ. For a general dissipator \hat{L}(t) one can simply write |\hat{L}(t)[ρ] [symbol] = [symbol] (t)|ρ [symbol] , because ρ can always be associated with C in Eq. (5).

In this way, the Liouville-space representation of Eq. (7) reads:

$$\frac{d}{dt} \vert ρ 〉 = ( - i ℋ ( t ) + ℒ ( t ) ) \vert ρ 〉 . \qquad ( 10 )$$

It should be noted that both [symbol] (t) and [symbol] (t) are linear operators that correspond to matrices of dimension d²×d². Restrictions on [symbol] (t) will be specified in what follows.

Suppose that applying the driving [symbol] (t) in Eq. (10) during a total time T leads to an ideal unitary evolution [symbol] = [symbol] e⁻ [symbol] , where [symbol] is the time-ordering operator. Even in the circuit model of quantum computing, where unitary operations are composed of discrete quantum gates, each elementary gate is itself generated by a pulse schedule that can be represented as a time-dependent Hamiltonian. Hence, any quantum circuit is ultimately generated by some pulse schedule [symbol] (t).

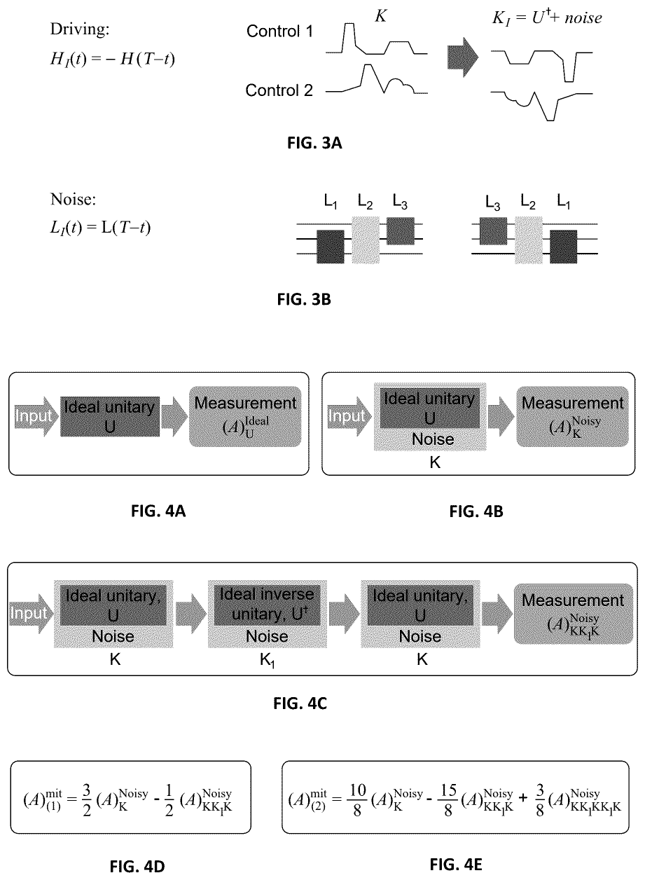

Different pulse schedules can result in the same ideal evolution [symbol] , and naturally the same is true for its inverse [symbol] †. However, in the presence of noise this equivalence does not hold in general. The derivation of the KIK formula relies on relating the pulse schedule for [symbol] † with the pulse schedule for [symbol] in a specific manner. FIG. 3A exemplifies definition of noisy evolution operator, [symbol] , configured to execute a Hamiltonian drive H(t), and the corresponding pulse inverse operator, [symbol] , configured to execute the inverse Hamiltonian drive H_{I}(t)=−H(T−t). Denoting the driving that generates [symbol] † by [symbol] _{I}(t), this relationship reads:

$${ℋ}_{I} ( t ) = - ℋ ( T - t ) . \qquad ( 11 )$$

In combination with Eq. (11), the other ingredient for obtaining the KIK formula has to do with how noise comes into play for a given driving [symbol] (t). On the one hand, Eq. (10) describes noise that acts locally in time, i.e., that [symbol] (t) only depends on the current instant t and not on the previous history of the evolution. On the other hand, this time dependence can have two origins. One of them is the time-dependence of [symbol] (t) itself, and the other are intrinsic fluctuations of the noise that are related e.g., to changes in the environment or miscalibrations that occur during the execution of an experiment. The second possibility is discussed in detail further below. As for the influence of the driving [symbol] (t) on the noise, the inventors assume that [symbol] (t) does not depend on the sign of [symbol] (t), but only on its amplitude. This reflects the fact that noise cannot be undone when running the reverse schedule described in Eq. (11). Taking into account the same equation, the dissipator [symbol] _{I}(t) for the “pulse inverse” [symbol] _{I}(t) should then satisfy:

$${ℒ}_{I} ( t ) = ℒ ( T - t ) . \qquad ( 12 )$$

Eq. (12) implies that if different gates are affected by different noise mechanisms (e.g., very fast gates may be prone to leakage noise due to non-adiabatic couplings to the levels outside the computational basis), the order in which these noise mechanisms operate is reversed when applying the pulse inverse (11). This is a consequence of the time locality of both [symbol] (t) and [symbol] _{I}(t), and the reversed time ordering that [symbol] _{I}(t) imprints on the corresponding inverse gates.

FIG. 3B schematically illustrates the different noise mechanisms associated with the dissipators [symbol] _{I}(t) and [symbol] _{I}(t), for a quantum circuit composed of three gates that act on three qubits. If each gate is affected by a dissipator [symbol] ᵢ, 1≤i≤3, the sequence on which these dissipators operate is reversed alongside the reversed order of the gates in the implementation of the inverse circuit. Hence, if ∘ denotes composition and [symbol] (t)= [symbol] ₃∘ [symbol] ₂∘ [symbol] ₁, then [symbol] _{I}(t)= [symbol] ₁∘ [symbol] ₂∘ [symbol] ₃.

Thus, the dissipator [symbol] (t) is assumed to be characterized by linearity and time locality. Consequently Eq. (11) implies Eq. (12).

It should be noted that [symbol] (t) is not restricted to have a Lindblad form or to give rise to a trace preserving map. For example, it can incorporate leakage noise, which does not conserve the total probability and therefore is not trace preserving.

Following Eq. (10), the noisy evolutions [symbol] and [symbol] that appear in the KIK formula are thus given by:

$$𝒦 = 𝒯 {e}^{{\int }_{0}^{T} ( - i ℋ ( t ) + ℒ ( t ) ) dt} , \qquad ( 13 )$$

$${𝒦}_{I} = 𝒯 {e}^{{\int }_{0}^{T} ( - i {ℋ}_{I} ( t ) + {ℒ}_{I} ( t ) ) dt} \qquad ( 14 )$$

It should be noted that no restrictions are imposed on the pulse [symbol] (t), so long as it reproduces the noise-free evolution [symbol] . On the other hand, it will be shown further below that Eqs. (11) and (12) allow to approximate the noise channel for [symbol] as ( [symbol] )^{1/2}. Therefore, the form of the inverse driving in (11) is important.

It should also be noted that the level of control required for implementing [symbol] _{I}(t) is very similar to that used for [symbol] (t). In essence, it is only needed to time-reverse the pulse schedule corresponding to [symbol] (t) and flip its sign. In this disclosure, the inventors use the pulse-gate capabilities of the IBM processors to implement [symbol] _{I}(t). No stretching of the pulses or any modification of their shape is involved. Therefore, the powers of [symbol] that enter the implementation of the KIK method are basically as easy to execute as [symbol] itself.

According to the present disclosure, a novel noise mitigated evolution operator, K_{mit,}, (or [symbol] _{KIK}) is created which approximates the unitary noise-free evolution operator, [symbol] , associated with the quantum circuit while providing error mitigation over the noise affecting the noisy evolution operator K, thereby enabling transpiling the noise mitigated evolution operator Kₘᵢₜ into said quantum circuit to obtain error mitigated measured observable. The operator [symbol] _{KIK} is defined by the “KIK formula”:

$${𝒰}_{KIK} = {𝒦 ( {𝒦}_{I} 𝒦 )}^{- \frac{1}{2}} , \qquad ( 15 )$$

where [symbol] _{KIK} denotes a (not necessarily unitary) approximation to [symbol] derived further below and the name “KIK” is a reference to the product [symbol] in Eq. (15). To derive this equation, the inventors solve the open-system dynamics for the noisy evolution and represent the solution to [symbol] using a Magnus expansion, from which they extract the approximation [symbol] _{KIK} by neglecting Magnus terms beyond the first order. Details on the master equation used to characterize the noisy evolution were described above.

Hereafter, [symbol] and [symbol] will be at times referred to as target evolution and inverse evolution, respectively. In particular, [symbol] is the noisy evolution over which the inventors intend to perform error mitigation. For now, it is assumed that the noise-free unitary is given by [symbol] = [symbol] , meaning that the pulse schedule [symbol] (t) is perfectly calibrated. Hence, the KIK formula is useful to mitigate errors caused by the dissipator [symbol] (t). For mitigating coherent errors, related to miscalibrations of [symbol] (t), methods such as randomized compiling can be applied. The relation between this technique and the KIK formula will be discussed further below.

In the following, the method of the inventors to arrive at Eq. (15) is detailed.

It is considered that the driving [symbol] (t) acts in the time interval (0, T) and the driving [symbol] _{I}(t) is applied in the interval (T, 2T). In this way, the total evolution at time t=2T is [symbol] . For any time t∈(0,2T) the dynamics is modeled according to

$$\frac{d}{dt} \vert ρ 〉 = ( - i \tilde{ℋ} ( t ) + \tilde{ℒ} ( t ) ) \vert ρ 〉 , \qquad ( 16 )$$

$$where$$

$$\tilde{ℋ} ( t ) = \{ \begin{matrix}ℋ ( t ) for t ∈ ( 0 , T ) \\ {ℋ}_{I} ( t - T ) for t ∈ ( T , 2 T )\end{matrix} , \\ \tilde{ℒ} ( t ) = \{ \begin{matrix}ℒ ( t ) for t ∈ ( 0 , T ) \\ {ℒ}_{I} ( t - T ) for t ∈ ( T , 2 T )\end{matrix} . \qquad ( 17 )$$

Note that the action of [symbol] _{I} and [symbol] _{I} on (T, 2T) requires the shifting by T as described in Eqs. (17). With this notation, the ideal and noisy evolutions for t∈(0,2T) are respectively given by [symbol] (t)= [symbol] , and [symbol] (t)= [symbol] . For t=T and t=2T one obtains [symbol] (T)= [symbol] , [symbol] (T)= [symbol] , [symbol] (2T)= [symbol] , and [symbol] (2T)= [symbol] I [symbol] .

The general solutions for [symbol] and [symbol] are derived, by first expressing Eq. (16) in the interaction picture and using the Magnus expansion [35] to write the solutions in this picture. In this way, it can be seen that [symbol] takes the form [symbol] = [symbol] , where the noise channel [symbol] is precisely the solution to Eq. (16) in interaction picture, at time t=T. By expressing [symbol] and the solution at time t=2T using Magnus expansions, the inventors are furthermore able to relate [symbol] with ( [symbol] )^{1/2} after performing a suitable approximation. To define the transformed states and operators in interaction picture, the noiseless evolution [symbol] (t) is used. Denoting interaction picture vectors and matrices with the subscript “int”, it is shown that:

$$\vert {ρ}_{int} ( t ) 〉 = {\tilde{𝒰}}^{†} ( t ) \vert ρ ( t ) 〉 , \qquad ( 18 )$$

$${\tilde{ℒ}}_{int} ( t ) = {\tilde{𝒰}}^{†} ( t ) \tilde{ℒ} ( t ) \tilde{𝒰} ( t ) \qquad ( 19 )$$

$$\frac{d}{dt} \vert {ρ}_{int} ( t ) 〉 = \tilde{ℒ} ( t ) \vert {ρ}_{int} ( t ) 〉 \qquad ( 20 )$$

The solution |ρᵢₙₜ(t) [symbol] = [symbol] ᵢₙₜ(t)|ρᵢₙₜ(0) [symbol] to Eq. (20) is related to the original (Schrodinger-picture) solution by [symbol] ᵢₙₜ(t)= [symbol] †(t) [symbol] (t). Therefore,

$$\begin{matrix}\tilde{𝒦} ( t ) = \tilde{𝒰} ( t ) {\tilde{𝒦}}_{int} ( t ) \\ = \tilde{𝒰} ( t ) {e}^{Ω ( t )}\end{matrix} , \qquad ( 21 )$$

where Ω(t)=Σₙ₌₁^{∞}Ωₙ(t) is the Magnus expansion [35]. Because this expansion is applied here to [symbol] ᵢₙₜ(t), each Magnus term Ωₙ(t) is constructed from the dissipator [symbol] ᵢₙₜ(t). In particular, the first-order term Ω₁(t) is central for the analysis of the disclosure and is given by:

$${Ω}_{1} ( t ) = {\int }_{0}^{t} {\tilde{ℒ}}_{int} ( {t}^{′} ) {dt}^{′} . \qquad ( 22 )$$

Regarding higher order terms Ω_{n≥2}(t), it can be noted that they contain nested commutators that obey time ordering. For example:

$${Ω}_{2} ( t ) = \frac{1}{2} {\int }_{0}^{t} {dt}^{′} {\int }_{0}^{{t}^{′}} {dt}^{″} [ {ℒ}_{i n t} ( {t}^{′} ) , {ℒ}_{i n t} ( {t}^{″} ) ] .$$

Setting t=T and t=2T in Eq. (21) leads to

$$𝒦 = 𝒰 {e}^{Ω ( T )} , \qquad ( 23 )$$

$${𝒦}_{I} 𝒦 = {e}^{Ω ( 2 T )} . \qquad ( 24 )$$

From these expressions, the final step in the derivation of Eq. (15) is to show that:

$${Ω}_{1} ( 2 T ) = 2 {Ω}_{1} ( T ) ⇔ {\int }_{0}^{T} {\tilde{ℒ}}_{i n t} ( {t}^{′} ) {dt}^{′} = {\int }_{T}^{2 T} {\tilde{ℒ}}_{i n t} ( {t}^{′} ) {dt}^{′} . \qquad ( 25 )$$

If e^{Ω(T)} and e^{Ω(2T)} are approximated by keeping only the first Magnus term in the corresponding exponents, Eq. (25) implies that the noise channel [symbol] =e^{Ω(T)} in (23) can be approximated by:

$$𝒩 \approx {𝒩}_{KIK} := {( {𝒦}_{I} 𝒦 )}^{\frac{1}{2}} . \qquad ( 26 )$$

In this way, the KIK formula is obtained by multiplying [symbol] ≈ [symbol] _{KIK} by the inverse:

$${𝒩}_{KIK}^{- 1} = {( {𝒦}_{I} 𝒦 )}^{- \frac{1}{2}} .$$

Now, Eq. (25) is proven. First, it is noted that:

$$\tilde{𝒰} ( t ) = {𝒰}^{†} ( t - T ) 𝒰 ( T ) = 𝒰 ( 2 T - t ) for t ∈ ( T , 2 T ) .$$

In addition, for the same time interval Eqs. (12) and (17) lead to

$$\tilde{ℒ} ( t ) = ℒ ( 2 T - t ) . \qquad ( 27 )$$

$$Therefore ,$$

$$\begin{matrix}{\int }_{T}^{2 T} {\tilde{ℒ}}_{i n t} ( t ) dt = {\int }_{T}^{2 T} {\tilde{𝒰}}^{†} ( t ) \tilde{ℒ} ( t ) \tilde{𝒰} ( t ) dt \\ = {\int }_{T}^{2 T} {𝒰}^{†} ( 2 T - t ) ℒ ( 2 T - t ) 𝒰 ( 2 T - t ) dt \\ = {\int }_{0}^{T} {𝒰}^{†} ( {t}^{′} ) ℒ ( {t}^{′} ) 𝒰 ( {t}^{′} ) {dt}^{′} \\ = {\int }_{0}^{T} {\tilde{ℒ}}_{i n t} ( t ) dt\end{matrix}$$

where the last line follows by performing the change of variable t′=2T−t.

It should be noted that Eq. (12) is key for the proof of Eq. (25). In turn, within the characterization of noise in the present disclosure it is specifically the inverse driving described by Eq. (11) which provides the form taken by the dissipator of Eq. (12). This implies that in the KIK formula the inverse [symbol] is specifically associated with the pulse schedule described by Eq. (12).

It should be noted that Eq. (15) is applicable to quantum circuits [symbol] subjected to time-dependent and spatially correlated noise, and also encompasses gate-dependent errors. Further below the inventors also discuss the scenario where noise parameters drift during the experiment, which occurs, for example, due to temperature variations or laser instability. In these and similar cases, the inventors show that the impact of noise drifts can be practically eliminated, if the execution order of the circuits [symbol] ( [symbol] )^{m} in Eq. (15) is properly chosen.

In the following, quantum error mitigation (QEM) using the KIK formula is exemplified. Since ( [symbol] )^{-1/2} is not directly implementable in a quantum device, the inventors utilize polynomial expansions of ( [symbol] )^{-1/2} of the form:

$${𝒰}_{KIK}^{( M )} = {\sum }_{m = 0}^{M} {a}_{m}^{( M )} {𝒦 ( {𝒦}_{I} 𝒦 )}^{m} \qquad ( 28 )$$

The notation [symbol] _{KIK}^{(M)} represents an M th-order approximation to [symbol] _{KIK}, with real coefficients {aₘ^{(M)}}ₘ₌₀^{M}. To estimate an error-free expectation value circuits of the form [symbol] ( [symbol] )^{m} are separately executed on the initial state ρ, for 0≤m≤M, the observable of interest is measured on the resulting final states, and the sum of the outcomes weighted by the aₘ^{(M)} is computed. Following standard terminology in quantum computing, a single execution of a circuit sequence of the form [symbol] ( [symbol] )^{m} for any m, 0≤m≤M, including the preparation of the initial state |ρ [symbol] and the measurement of the final state, is dubbed a “shot” and will be used here as well.

Different expansions of the KIK formula can be considered depending on the strength of the noise affecting the execution of a single KIK cycle, i.e., an effective identity block operator [symbol] . For very weak noise, [symbol] would be close to the identity operator [symbol] and therefore all its eigenvalues are expected to be close to 1. Letting λ denote a general eigenvalue of [symbol] , a Taylor expansion of λ^{-1/2} around 1 constitutes a reasonable approximation in the weak noise regime. In this case, the coefficients aₘ^{(M)} match the coefficients a_{Tay,m}^{(M)} that characterize the truncated Taylor expansion λ^{-1/2}≈Σₘ₌₀^{M}a_{Tay,m}^{(M)}λ^{m} .

Further below, the inventors analytically derive the coefficients a_{Tay,m}^{(M)}, for any order M, showing also that these coefficients predict QEM using Richardson ZNE, with linear noise scaling through circuit unitary folding [11]. Nevertheless, the inventors stress that a distinctive characteristic of the approach of the present disclosure is the pulse-based inverse [symbol] . As will be proven further below, for circuits that satisfy [symbol] ²= [symbol] , using instead a “circuit-based” inverse [symbol] = [symbol] introduces an additional error term that afflicts [symbol] _{KIK}^{(M)} (cf. Eq. (28)) for any M. Thus, ignoring the pulse inverse hinders QEM in paradigmatic gates such as the CNOT, swap, or Toffoli gate.

In addition, standard circuit folding makes no distinction between noise amplification using powers of [symbol] or [symbol] , as both choices reproduce the identity operation in the absence of noise. However, proper QEM involves powers of [symbol] . Specifically, it is shown that

$${𝒦𝒦}_{I} = {𝒰𝒦}_{I} {𝒦𝒰}^{†} . \qquad ( 29 )$$

which clearly implies that [symbol] cannot be substituted by [symbol] , in the KIK formula or in the corresponding expansions. In particular, the coincidence with Richardson ZNE applying unitary folding, discussed further below, is sound whenever noise amplification is performed using the correct ordering [symbol] . This is different from the heuristic approach taken in Ref. [11], where [symbol] could be an equally valid choice because it also reproduces the identity operation in the absence of noise.

More specifically, the inventors have shown that the relation of Eq. (29) holds under the same approximation that leads to Eq. (15). Namely, when the Magnus expansion used to express the evolution [symbol] is also truncated to the first Magnus term. Following the noise model of the present disclosure, this evolution is the solution to the equation:

$$\frac{d}{dt} \vert ρ 〉 = ( - i \overline{ℋ} ( t ) + \overline{ℒ} ( t ) ) \vert ρ 〉 , \qquad ( 30 )$$

$$where :$$

$$\begin{matrix}\overline{ℋ} ( t ) = \{ \begin{matrix}{ℋ}_{I} ( t ) for t ∈ ( 0 , T ) \\ ℋ ( t - T ) for t ∈ ( T , 2 T )\end{matrix} \\ \overline{ℒ} ( t ) = \{ \begin{matrix}{ℒ}_{I} ( t ) for t ∈ ( 0 , T ) \\ ℒ ( t - T ) for t ∈ ( T , 2 T ) .\end{matrix}\end{matrix} \qquad ( 31 )$$

In interaction picture, the first Magnus term for the solution of Eq. (30) at time t=2T reads ∫₀^{2T} [symbol] ᵢₙₜ(t)dt, where [symbol] ᵢₙₜ(t)= [symbol] †(t) [symbol] (t) [symbol] (t). Taking this into account, it is shown that:

$${\int }_{0}^{2 T} {\overline{ℒ}}_{i n t} ( t ) dt = 𝒰 ( T ) {\int }_{0}^{2 T} {\tilde{ℒ}}_{i n t} ( t ) dt {𝒰}^{†} ( T ) . \qquad ( 32 )$$

Accordingly, up to first order in the Magnus expansion the following relation holds:

$${𝒦𝒦}_{I} \approx {e}^{{\int }_{0}^{2 T} {\overline{ℒ}}_{i n t ( t ) dt}} = 𝒰 ( T ) {e}^{{\int }_{0}^{2 T} {\overline{ℒ}}_{i n t ( t ) dt}} {𝒰}^{†} ( T ) \approx 𝒰 ( T ) {𝒦}_{I} {𝒦𝒰}^{†} ( T ) ,$$

which is tantamount to Eq. (28).

To prove Eq. (32), the following two alternative forms of ∫₀^{T} [symbol] ᵢₙₜ(t)dt are derived:

$$\begin{matrix}{\int }_{0}^{T} {\overline{ℒ}}_{i n t} ( t ) dt = 𝒰 ( T ) {\int }_{0}^{T} {\tilde{ℒ}}_{i n t} ( t ) dt {𝒰}^{†} ( T ) \\ = {\int }_{T}^{2 T} {\overline{ℒ}}_{i n t} ( t ) dt\end{matrix} \qquad ( 33 )$$

Noting that [symbol] (t)= [symbol] (t) for t∈(0, T), one obtains

$$\begin{matrix}{\int }_{0}^{T} {\overline{ℒ}}_{i n t} ( t ) dt = {\int }_{0}^{T} {\overline{𝒰}}^{†} ( t ) {ℒ}_{I} ( t ) \overline{𝒰} ( t ) dt \\ = {\int }_{0}^{T} 𝒰 ( t ) ℒ ( T - t ) {𝒰}^{†} ( t ) dt \\ = {\int }_{0}^{T} 𝒰 ( T - {t}^{′} ) ℒ ( {t}^{′} ) {𝒰}^{†} ( T - {t}^{′} ) {dt}^{′} \\ = 𝒰 ( T ) ( {\int }_{0}^{T} {𝒰}^{†} ( {t}^{′} ) ℒ ( {t}^{′} ) 𝒰 ( {t}^{′} ) {dt}^{′} ) {𝒰}^{†} ( T )\end{matrix} \qquad ( 34 )$$

Where the change of variable t′=T−t is performed in the third line, and in the last line the relation [symbol] (T)= [symbol] (T−t′) [symbol] (t′) is used. This proves the first line of Eq. (33). For the time interval t∈(T, 2T), the evolution [symbol] (t) reads [symbol] (t)= [symbol] (t−T) [symbol] †(T) . Therefore,

$$\begin{matrix}{\int }_{T}^{2 T} {\overline{ℒ}}_{i n t} ( t ) dt = {\int }_{T}^{2 T} {\overline{𝒰}}^{†} ( t ) ℒ ( t - T ) \overline{𝒰} ( t ) dt \\ = {\int }_{T}^{2 T} 𝒰 ( T ) {𝒰}^{†} ( t - T ) ℒ ( t - T ) 𝒰 ( t - T ) {𝒰}^{†} ( T ) dt \\ = 𝒰 ( T ) ( {\int }_{0}^{T} {𝒰}^{†} ( {t}^{′} ) ℒ ( {t}^{′} ) 𝒰 ( {t}^{′} ) {dt}^{′} ) {𝒰}^{†} ( T ) ,\end{matrix} \qquad ( 35 )$$

which (in combination with Eq. (34)) proves the second line of Eq. (33). Eq. (32) follows straightforwardly by combining the two lines of Eq. (33).

It is to be noted that the examples studied in Ref. [11] are mostly based on the assumption of a global depolarizing channel that is identical for [symbol] and [symbol] . Because global depolarizing noise commutes with any unitary [symbol] , in this case the total noise channel for both [symbol] and [symbol] is simply another depolarizing channel with an increased error rate. Hence, for this simple model both the KIK formula and unitary folding can be applied using either [symbol] or [symbol] . However, as it was shown here, in a more realistic scenario the proper time ordering corresponding to [symbol] is crucial for a correct application of QEM.

Further below, several polynomial approximations to ( [symbol] )^{-1/2} will be considered, of the form:

$${( {𝒦}_{I} 𝒦 )}^{- \frac{1}{2}} \approx {\sum }_{m = 0}^{M} {{b}_{m} ( {𝒦}_{I} 𝒦 )}^{m} . \qquad ( 36 )$$

Here, it is shown that, for any M, analogous approximations hold under an alternative representation of the KIK formula of Eq. (15) given by

$${𝒰}_{KIK} = {( {𝒦𝒦}_{I} )}^{- \frac{1}{2}} 𝒦 . \qquad ( 37 )$$

In this case, rather than expanding ( [symbol] )^{-1/2} in powers of [symbol] , the inventors approximate ( [symbol] )^{-1/2} as a polynomial in powers of

[symbol]

Substitution of Eq. (35) into Eq. (15) leads to

$$\begin{matrix}{𝒰}_{KIK} \approx 𝒦 [ {\sum }_{m = 0}^{M} {{b}_{m} ( {𝒦}_{I} 𝒦 )}^{m} ] \\ = {\sum }_{m = 0}^{M} {b}_{m} {𝒦 ( {𝒦}_{I} 𝒦 )}^{m} \\ = [ {\sum }_{m = 0}^{M} {{b}_{m} ( {𝒦𝒦}_{I} )}^{m} ] 𝒦 ,\end{matrix} \qquad ( 38 )$$

where the third line is obtained by simply shifting one position to the left the two-term groups in the second line. If Σₘ₌₀^{M}bₘ( [symbol] )^{m} is associated with ( [symbol] )^{-1/2}, it is straightforward to identify the alternative KIK formula of Eq. (36).

Coming back to exemplifying QEM using the KIK formula of Eq. (15), the inventors use the fact that for very weak noise K_{I}K is close to the identity operator.

In this case any eigenvalue λ of [symbol] is close to 1, and one can obtain the eigenvalues of ( [symbol] )^{-1/2} by Taylor expanding λ^{-1/2} around λ=1. Note that here it is assumed that noise is such that [symbol] is still diagonalizable, and therefore the eigenvalues of ( [symbol] )^{-1/2} can be obtained as λ^{-1/2}.

A Taylor expansion of λ^{-1/2} around λ=1 is thus equivalent to expanding ( [symbol] )^{-1/2} around the identity [symbol] . Namely,

$$\begin{matrix}{( {𝒦}_{I} 𝒦 )}^{- \frac{1}{2}} = {\sum }_{m = 0}^{∞} {{c}_{m} ( {𝒦}_{I} 𝒦 - 𝒥 )}^{m} \\ = {\sum }_{m = 0}^{∞} {c}_{m} {\sum }_{k = 0}^{m} \frac{m ! {( - 1 )}^{m - k}}{k ! ( m - k ) !} {( {𝒦}_{I} 𝒦 )}^{k}\end{matrix} \qquad ( 39 )$$

$$where$$

$${c}_{m} = \frac{1}{m !} \frac{{d}^{m} {λ}^{- \frac{1}{2}}}{d {λ}^{m}} {\vert}_{λ = 1} = {( - 1 )}^{m} \frac{( 2 m - 1 ) !!}{m ! {2}^{m}} . \qquad ( 40 )$$

Since the series in Eq. (39) involves infinite powers of [symbol] , it must be truncated to some fixed order M for the implementation of ( [symbol] )^{-1/2}. In this way,

$$\begin{matrix}{( {𝒦}_{I} 𝒦 )}^{- \frac{1}{2}} \approx {\sum }_{m = 0}^{M} {c}_{m} {\sum }_{k = 0}^{m} \frac{m ! {( - 1 )}^{m - k}}{k ! ( m - k ) !} {( {𝒦}_{I} 𝒦 )}^{k} \\ = {\sum }_{m = 0}^{M} {{a}_{Tay , m}^{( M )} ( {𝒦}_{I} 𝒦 )}^{m} ,\end{matrix} \qquad ( 41 )$$

$$where :$$

$${a}_{Tay , m}^{( M )} = {( - 1 )}^{m} \frac{( 2 M + 1 ) !!}{{2}^{M} [ ( 2 m + 1 ) m ! ( M - m ) ! ]} . \qquad ( 42 )$$

The first few mitigation orders are:

$${𝒰}_{KIK}^{( 1 )} \begin{matrix} \\ \end{matrix} = \frac{1}{2} ( 3 K - {KK}_{I} K ) \qquad ( 44 )$$

$${𝒰}_{KIK}^{( 2 )} = \frac{1}{8} [ 10 K - 15 K ( {K}_{I} K ) + 3 K ( {KK}_{I} ) ( {KK}_{I} ) ] \qquad ( 45 )$$

$${𝒰}_{KIK}^{( 3 )} = \frac{1}{16} [ 35 K - 35 K ( {K}_{I} K ) + 21 K ( {KK}_{I} ) ( {KK}_{I} ) - 5 K ( {KK}_{I} ) ( {KK}_{I} ) ( {KK}_{I} ) ] \qquad ( 46 )$$

$${𝒰}_{KIK}^{( 4 )} = \frac{1}{128} [ 315 K - 420 K ( {K}_{I} K ) + 378 K ( {KK}_{I} ) ( {KK}_{I} ) - 180 K ( {KK}_{I} ) ( {KK}_{I} ) ( {KK}_{I} ) + 35 K ( {KK}_{I} ) ( {KK}_{I} ) ( {KK}_{I} ) ( {KK}_{I} ) ] \qquad ( 47 )$$

Unlike Eq. (15), these expressions have an explicit operational meaning: for example, when evaluating the 2^{nd} order mitigated expectation value:

$${〈 A 〉}_{( 2 )}^{m i t} = \frac{10}{8} 〈 A \vert K \vert {ρ}_{0} 〉 - \frac{15}{8} 〈 A \vert {KK}_{I} K \vert {ρ}_{0} 〉 + \frac{15}{8} 〈 A \vert {KK}_{I} {KK}_{I} K \vert {ρ}_{0} 〉 , \qquad ( 48 )$$

three different experiments have to be executed (see FIG. 1 for [symbol] A [symbol] ₍₁₎^{mit} illustration). The first is the regular noisy evolution, the second is KK_{I}K and the third KK_{I}KK_{I}K and in each evolution the expectation value is measured. Denoting the “noise-amplified expectation” value by [symbol] A [symbol] ₗ= [symbol] A|K(K_{I}K)^{l}|ρ₀ [symbol] the mitigated expectation value is given by

$${〈 A 〉}_{( m )}^{m i t} = {\sum }_{l = 0}^{m} {a}_{l} {〈 A 〉}_{l} . \qquad ( 49 )$$

FIGS. 4A to 4E illustrate an exemplary QEM using the above Taylor expansion of Eq. (15). In FIG. 4A an ideal expectation value of some observable A is obtained by executing an ideal, noiseless unitary circuit. FIG. 4B schematically shows that in practice, the circuit is never perfectly isolated from the environment, and therefore the value of [symbol] A [symbol] is modified by the presence of noise. FIG. 4C exemplifies schematically the first-order protocol (“first-order KIK”) according to the present disclosure, based on running a sequence of the noisy circuit, its noise inverse, and finally another run of the noisy circuit. In addition, the regular noisy value is measured as shown in FIG. 4B. By combining the outcomes of FIG. 4B and FIG. 4C as shown in FIG. 4D, the inventors mitigate the leading order of the Markovian noise. FIG. 4C shows that the mitigation can be improved by running more K_{I}K cycles.

Although in this form the KIK protocol is written in terms of specific observables, the “KIK” protocol is observable agnostics. This protocol should be distinguished from zero noise extrapolation since it makes no assumption on the structure of the noise (other than the fact that second-order effect in the noise can be neglected). In zero noise extrapolation, the noise needs to be time independent for the extrapolation to work. Such an assumption does not hold for error mechanisms such as leakage to higher levels that arise due to nonadiabatic couplings as in superconducting qubits.

In the following, it is shown that the expansion coefficients in Eq. (42) predict the result of QEM using Richardson ZNE and noise amplification through a method known as unitary folding [8], under the assumption of a linear scaling of the noise. To put this result into context, the basics of Richardson ZNE and unitary folding are presented first.

The goal of ZNE is to infer the noise-free expectation value of an observable A, by measuring this observable at different levels of noise and then extrapolating to the zero-noise limit. Therefore, the application of ZNE requires assuming a certain functional dependence [symbol] A [symbol] (λ), between the expectation value [symbol] A [symbol] and some noise parameter λ over which the experimentalist should have control. By measuring expectation values [symbol] A [symbol] ₖ corresponding to different levels of noise λₖ, the experimentalist can fit the data [λₖ, [symbol] A [symbol] ₖ] to the model [symbol] A [symbol] (λ) and thereby estimate the noiseless expectation value as [symbol] A [symbol] (0). In the case of Richardson extrapolation, for M+1 data points [λₖ, [symbol] A [symbol] ₖ], [symbol] A [symbol] (λ) is taken as a polynomial in λ of degree M.

There exists a unique polynomial P(λ) of degree M that intersects all the points [λₖ, [symbol] A [symbol] ₖ]. This polynomial can be constructed as P(λ)=Σₘ₌₀^{M} [symbol] A [symbol] ₘlₘ(λ), where

$${l}_{m} ( λ ) := {\prod }_{0 \leq k \leq M , k \neq m} \frac{λ - {λ}_{k}}{{λ}_{m} - {λ}_{k}} \qquad ( 50 )$$

is a Lagrange polynomial of degree M. Noting that lₘ(λₖ)=δₖₘ, it follows that P(λₖ)= [symbol] A [symbol] ₖ for 0≤k≤M. Therefore, the noise-free expectation value is estimated by

$$\begin{matrix}〈 A 〉 ( 0 ) = P ( 0 ) \\ = {\sum }_{m = 0}^{M} {〈 A 〉}_{m} {l}_{m} ( 0 ) \\ = {\sum }_{m = 0}^{M} {〈 A 〉}_{m} {\prod }_{0 \leq k \leq M , k \neq m} \frac{{λ}_{k}}{{λ}_{k} - {λ}_{m}} .\end{matrix} \qquad ( 51 )$$

Eq. (51) gives [symbol] A [symbol] (0) in terms of [symbol] A [symbol] ₖ and the noise strengths λₖ. One of the first techniques proposed to artificially increase the value of λ is pulse stretching [1], which involves pulse control from the user. In addition, it should be noted that pulse stretching also assumes that the noise is time-independent. Unitary folding is an alternative that supposedly does not require this level of control. If [symbol] describes the target ideal evolution, unitary folding operates by adding quantum gates to [symbol] that in the noise-free case are just identity operations. This can be done either by using “circuit foldings” [symbol] † [symbol] , or by inserting products between gates and their own inverses. Noting that the polynomial of Eq. (41) contains powers of the (noisy) implementation of [symbol] † [symbol] , the inventors are specifically interested in the connection between this polynomial and the use of circuit folding for ZNE. In this context, the assumption of linear scaling of the noise means that each power ( [symbol] )^{k} increases the noise characteristic of [symbol] by a factor of 2k, i.e., that the noise increases proportionally to the depth of the circuit ( [symbol] )^{k}. If λ₀ corresponds to the natural noise in the target circuit [symbol] , then, the folding [symbol] ( [symbol] )^{k} results in λₖ=(2k+1)λ₀. By susbstituting this expression of λₖ into

$${\prod }_{0 \leq k \leq M , k \neq m} \frac{{λ}_{k}}{{λ}_{k} - {λ}_{m}} ,$$

one obtains:

$$\begin{matrix}{\prod }_{0 \leq k \leq M , k \neq m} \frac{{λ}_{k}}{{λ}_{k} - {λ}_{m}} = {\prod }_{0 \leq k \leq M , k \neq m} \frac{2 k + 1}{2 ( k - m )} \\ = \frac{{\prod }_{0 \leq k \leq M , k \neq m} ( 2 k + 1 )}{{2}^{M} {\prod }_{0 \leq k \leq M , k \neq m} ( k - m )} \\ = \frac{( 2 M + 1 ) !! / ( 2 m + 1 )}{{2}^{M} [ ( - m ) ( 1 - m ) … ( - 1 ) ] [ ( 1 ) ( 2 ) … ( M - m ) ]} \\ = {( - 1 )}^{m} \frac{( 2 M + 1 ) !!}{{2}^{M} [ ( 2 m + 1 ) m ! ( M - m ) ! ]} ,\end{matrix} \qquad ( 52 )$$

which coincides with the coefficient a_{Tay, m}^{(M)} [cf. Eq. (42)].

Taking into account that [symbol] A [symbol] ₘ= [symbol] A| [symbol] ( [symbol] )^{m}|ρ [symbol] , it follows that the application of the KIK formula in the weak noise limit reproduces the prediction of Richardson ZNE, with circuit folding and linear scaling of noise [cf. Eqs. (51) and (52)]. As a final remark, it is worth noting that in circuit folding the realization of [symbol] † using circuit level control does not involve modifying gates that are their own inverse. A fundamental example in this respect is the CNOT gate, which is the basic unit of two-qubit interactions. In contrast, the pulse inverse [symbol] _{I}(t) used in the method of the present disclosure reverses also the schedules of the CNOT gates, to keep consistency with the pulse-based inverse [symbol] appearing in the KIK formula of Eq. (15).

In what follows, it is also shown that using [symbol] = [symbol] in the case of target circuits that are their own inverse introduces an additional error term that is absent when [symbol] is the pulse inverse. This further demonstrates the importance of the correct implementation of [symbol] for KIK QEM.

It was shown above that the coefficients a_{Tay ,m}^{(M)} reproduce Richardson ZNE when noise (M) is linearly scaled through circuit folding. However, even in this limit of weak noise the KIK method provides insights that escape from a naive application of circuit folding. It was already shown above that, even though [symbol] and [symbol] are equivalent in the noiseless scenario, the product [symbol] is the correct choice for using the KIK formula of Eq. (15). This is valid in particular for Eq. (41).

Here, it will be shown that ignoring the pulse inverse [symbol] also has negative consequences for QEM using Eq. (41), which for simplicity the inventors call “Taylor mitigation”. Specifically, consider circuits such that

$${𝒰}^{2} = 𝒥 , \qquad ( 53 )$$

which suggests the application of (41) with [symbol] = [symbol] . In this way, the Mth order approximation to [symbol] (cf. Eq. (28)) reads:

$$\begin{matrix}{𝒰}_{KIK}^{( M )} = {\sum }_{m = 0}^{M} {a}_{Tay , m}^{( M )} {𝒦 ( 𝒦𝒦 )}^{m} \\ = {\sum }_{m = 0}^{M} {{a}_{Tay , m}^{( M )} ( 𝒦 )}^{2 m + 1} \\ = {\sum }_{m = 0}^{M} {{a}_{Tay , m}^{( M )} ( 𝒰 {e}^{{Ω}_{1}} )}^{2 m + 1} ,\end{matrix} \qquad ( 54 )$$

where [symbol] has been replaced by Eq. (23) and Ω₁=Ω₁(T).

Next, [symbol] e^{Ω}^{₁} is approximated by [symbol] e^{Ω}^{₁}≈ [symbol] + [symbol] Ω₁, and only terms that are linear in Ω₁ in [symbol] _{KIK}^{(M)} are kept. Using [symbol] ^{2m+1}= [symbol] , it is shown that

$${( 𝒰 + {𝒰Ω}_{1} )}^{2 m + 1} \approx 𝒰 + {\sum }_{k = 1}^{2 m + 1} {𝒰}^{k} {Ω}_{1} {𝒰}^{2 m + 1 - k} , \qquad ( 55 )$$

for m≥1. Therefore,

$$\begin{matrix}{𝒰}_{KIK}^{( M )} \approx {a}_{Tay , 0}^{( M )} , ( 𝒰 + {𝒰Ω}_{1} ) + {\sum }_{m = 1}^{M} {{a}_{Tay , m}^{( M )} ( 𝒰 {e}^{{Ω}_{1}} )}^{2 m + 1} \\ \approx {a}_{Tay , 0}^{( M )} , ( 𝒰 + {𝒰Ω}_{1} ) + {\sum }_{m = 1}^{M} {a}_{Tay , m}^{( M )} \\ [ 𝒰 {\sum }_{k = 1}^{2 m + 1} {𝒰}^{k} {Ω}_{1} {𝒰}^{2 m + 1 - k} ] \\ = 𝒰 + {a}_{Tay , 0}^{( M )} {𝒰Ω}_{1} + {\sum }_{m = 1}^{M} {a}_{Tay , m}^{( M )} {\sum }_{k = 1}^{2 m + 1} {𝒰}^{k} {Ω}_{1} {𝒰}^{2 m + 1 - k}\end{matrix} \qquad ( 56 )$$

where Σₘ₌₀^{M}a_{Tay, m}^{(M)}=1 was applied.

Now, the sum Σₖ₌₁^{2m+1} [symbol] ^{k}Ω₁ [symbol] ^{2m+1-k} is divided into two sums such that one of them contains only even powers [symbol] ^{k}, and the other contains only odd powers [symbol] ^{k}. Taking into account that [symbol] ⁻¹= [symbol] and that any even power of [symbol] yields [symbol] , one obtains

$$\begin{matrix}{\sum }_{k = 1}^{2 m + 1} {𝒰}^{k} {Ω}_{1} {𝒰}^{2 m + 1 - k} = {\sum }_{k = 1}^{m + 1} {𝒰}^{2 k - 1} {Ω}_{1} {𝒰}^{2 m + 2 - 2 k} + \\ {\sum }_{k = 1}^{m} {𝒰}^{2 k} {Ω}_{1} {𝒰}^{2 m + 1 - 2 k} \\ = {\sum }_{k = 1}^{m + 1} {𝒰Ω}_{1} + {\sum }_{k = 1}^{m} {Ω}_{1} 𝒰 \\ = ( m + 1 ) {𝒰Ω}_{1} + m {Ω}_{1} 𝒰\end{matrix} \qquad ( 57 )$$

Substituting Eq. (57) into Eq. (56), it is found that

$$\begin{matrix}{𝒰}_{KIK}^{( M )} \approx 𝒰 + {a}_{Tay , 0}^{( M )} {𝒰Ω}_{1} + {\sum }_{m = 1}^{M} {a}_{Tay , m}^{( M )} [ ( m + 1 ) {𝒰Ω}_{1} + m {Ω}_{1} 𝒰 ] \\ = 𝒰 + {a}_{Tay , 0}^{( M )} {𝒰Ω}_{1} + {\sum }_{m = 0}^{M} {a}_{Tay , m}^{( M )} \\ [ ( m + 1 ) {𝒰Ω}_{1} + m {Ω}_{1} 𝒰 ] - {a}_{Tay , 0}^{( M )} {𝒰Ω}_{1} \\ = 𝒰 + {\sum }_{m = 0}^{M} {a}_{Tay , m}^{( M )} [ ( m + 1 ) {𝒰Ω}_{1} + m {Ω}_{1} 𝒰 ] ,\end{matrix} \qquad ( 58 )$$

where in the second line the term corresponding to m=0 was added and subtracted in the sum.

Finally, the inventors use again Σₘ₌₀^{M}a_{Tay, m}^{(M)}=1, and Σₘ₌₀^{M}a_{Tay,}^{(M)}m=−½. In this way, for any M≥1,

$${𝒰}_{KIK}^{( M )} \approx 𝒰 + \frac{1}{2} [ 𝒰 , {Ω}_{1} ] . \qquad ( 59 )$$

Because Taylor mitigation corresponds to weak noise, in the limit when M tends to infinity [symbol] _{KIK}^{(M)} should converge to the evolution [symbol] _{KIK} in the KIK formula of Eq. (15). By construction, this is the case if [symbol] is given by the pulse inverse. However, it can be seen from Eq. (59) that when [symbol] = [symbol] the term ½[ [symbol] , Ω₁] remains in the approximation [symbol] _{KIK}^{(M)}, irrespective of the mitigation order M. Note also that this term cannot be avoided in general by considering higher-order (nonlinear) contributions in Ω₁. Eq. (59) thus shows that KIK QEM is afflicted by an additional error term ½[ [symbol] , Ω₁], if one uses [symbol] = [symbol] instead of the pulse inverse.

Finally, it is noted that for global depolarizing noise the associated noise channel commutes with any unitary [symbol] , and therefore [ [symbol] , Ω₁]=0. In fact, it is not difficult to check that in such a case the KIK formula of Eq. (15) is exact even when [symbol] = [symbol] . It is not thus surprising that for this simplified noise model circuit folding can be applied without worrying about the details analyzed here [8], which are key in practical applications under realistic noise.

In the following the implementation of the KIK formula of the present disclosure to provide QEM in drifting noise conditions is described.

Until now, the time dependence of [symbol] (t) (cf. Eq. (17)) was approached as being a consequence of the time dependence that characterizes the associated pulse schedules, [symbol] (t). In this framework, any implementation of [symbol] or [symbol] would be affected by the same dissipators [symbol] (t) and [symbol] _{I}(t−T). However, it is more realistic to include the possibility of noise sources that also change in time. For example, a varying temperature or external electromagnetic field can be such that the dissipator [symbol] (t) acting during a given implementation of [symbol] differs from the dissipator [symbol] ′(t), associated with a different execution of the same evolution. The present disclosure provides a technique to collect the QEM data that minimizes the effect of noise drifts enabled by distributing the circuits for QEM into suitable sets, and separately applying the KIK formula of Eq. (15) to each of these sets.

As described above, performing QEM with the KIK method involves executing circuits of the form [symbol] ( [symbol] )^{m}, for 0≤m≤M, where M is the mitigation order and in the following, the technique of mitigating noise drift is exemplified a maximum order given by M=3. In general, the time for running [symbol] ( [symbol] )^{m} is (2m+1)T, where T is the evolution time of [symbol] or [symbol] . In the computation of expectation values, it is necessary to implement each [symbol] ( [symbol] )^{m} a certain number of times Nₘ. As already mentioned above, standard terminology of quantum computing is used here, where a single execution of a circuit, including the preparation of the initial state |ρ [symbol] and the measurement of the final state, is dubbed a “shot”. Hence, Nₘ shots are used for each [symbol] ( [symbol] )^{m}, and the “shot budget” to collect all the QEM data characteristic of the KIK method reads N=Σₘ₌₀Nₘ (note that this excludes the shots invested in the estimation of the survival probability μ= [symbol] ρ| [symbol] |ρ [symbol] , in the case of adapted mitigation). Assuming for simplicity that the time for preparing |ρ [symbol] and the time for measuring the corresponding final states are negligible with respect to T, performing N shots takes a total time

$${t}_{N} = {\sum }_{m = 0}^{M} {N}_{m} ( 2 m + 1 ) T . \qquad ( 60 )$$

For the present analysis, it is useful to extend the time domain of [symbol] (t), to account for the behavior of the noise under repetitions of the evolutions [symbol] and [symbol] . In this way, stationary noise is characterized by the conditions [symbol] (t+kT)= [symbol] (t), if the k th pulse schedule is a repetition of [symbol] (t), and [symbol] (t+kT)= [symbol] _{I}(t−T), if the k th pulse schedule is a repetition of [symbol] _{I}(t−T). Conversely, noise drifts take place within the total time interval (0, t_{N}) if, for some integer l and t+lT≤t_{N}, [symbol] (t+lT)≠ [symbol] (t) when the l th pulse schedule is a repetition of [symbol] (t), or [symbol] (t+lT)≠ [symbol] _{I}(t−T) when the l th pulse schedule is a repetition of [symbol] _{I}(t−T).

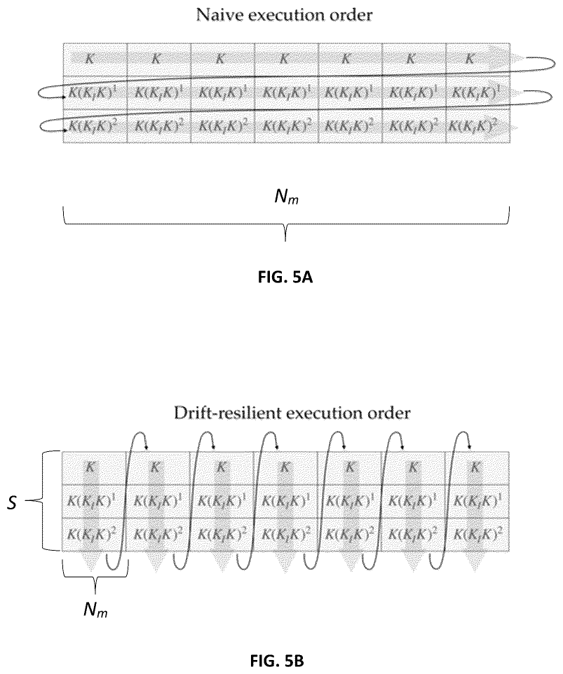

Let us now suppose that noise unavoidably drifts in the interval (0, t_{N}). In this scenario, the consistency of the evolutions [symbol] or [symbol] in different shots can break down, thus preventing a correct implementation of the KIK formula of Eq. (15). However, one can avoid or at least alleviate this effect through a proper distribution of the shot budget N. Reference is made to FIGS. 5A and 5B, where two strategies for implementing the circuits { [symbol] ( [symbol] )^{m}}ₘ₌₀² (second-order mitigation) are illustrated. In the case of FIG. 5A, all the shots corresponding to a given Nₘ are sequentially implemented, i.e., N₀ shots are first performed, followed by N₁ shots, and finally by N₂ shots. This implies that circuits [symbol] ( [symbol] )^{m} corresponding to different values of m are never interleaved. On the other hand, the strategy of FIG. 5B relies on dividing the N shots into S sets {n₀, n₁, n₂} of N_{S}=n₀+n₁+n₂ shots each, where nₘ shots are employed for the circuit [symbol] ( [symbol] )^{m}. Without loss of generality for the present argumentation, it is possible to focus on the simple case (M=3) where nₘ=N_{S}/3 for 0≤m≤2, i.e., when the shots of each set are equally distributed into the different circuits [symbol] ( [symbol] )^{m}. In this way, FIG. 5B shows that each set {n₀, n₁, n₂} is repeated until completing the N shots.

Since each {n₀, n₁, n₂} contains data produced by all the circuits [symbol] ( [symbol] )^{m}, the KIK formula can be individually applied to these data sets. Let

$${𝒰}_{KIK , s} = {{𝒦}_{s} ( {𝒦}_{I ; s} {𝒦}_{s} )}^{- \frac{1}{2}} \qquad ( 61 )$$

denote the KIK formula corresponding to evolutions [symbol] ₛ and [symbol] _{I,s} that are executed in shots of the s-th set {n₀, n₁, n₂}^{(s)}. If there were no noise drifts, [symbol] ₛ= [symbol] ₁= [symbol] and [symbol] _{I;s}= [symbol] _{I;1}= [symbol] for 1≤s≤S. Therefore, the two strategies depicted in FIGS. 5A and 5B would lead to the same result. Nevertheless, the non-stationary character of the noise may cause that [symbol] ₛ or [symbol] _{I;s} change significantly when moving between different sets {n₀, n₁, n₂}^{(s)}, or even within a fixed set. The second possibility is less likely though, if the time Σₘ₌₀^{M}nₘ(2m+1)T=Σₘ₌₀^{M}N_{S}(2m+1)T/3 invested in implementing each set {n₀, n₁, n₂}^{(s)} is smaller than the characteristic time for noise drifts to be significant. Assuming that N_{S} is sufficiently small (equivalently, S sufficiently large) for this to happen, for any 1≤s≤S one can implement the formula of Eq. (61) without worrying about inconsistencies in the evolutions [symbol] ₛ or [symbol] _{I;s} that appear in the corresponding circuits [symbol] ₛ( [symbol] _{I;s} [symbol] ₛ)^{m}. In this way, for the shot budget N the inventors utilize the “average KIK formula”

$${𝒰}_{KIK , av}^{( M )} = \frac{1}{s} {\sum }_{s = 1}^{S} {𝒰}_{KIK , s}^{( M )} . \qquad ( 62 )$$

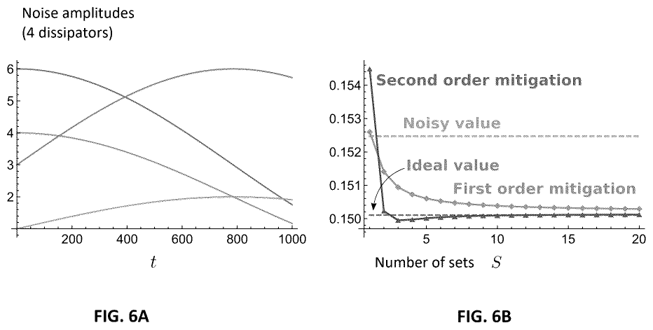

Reference is made to FIGS. 6A and 6B, showing the KIK method applied to a system with noise drifts. FIG. 6A shows four time-dependent amplitudes fₖ(t) that appear in the dissipator (63) below, and characterize the drift in noise parameters. FIG. 6B shows the first order mitigation and second order mitigation using the average formula (62) above, as a function of the number of sets S.

In FIGS. 6A and 6B, two qubits are considered, subjected to a dissipator:

$$\tilde{ℒ} ( t ) = ξ {\sum }_{k = 1}^{4} {f}_{k} ( t ) {ℒ}_{k} , where ξ = 0.05 , \qquad ( 63 )$$

$${ℒ}_{k} = {A}_{k} ⊗ {A}_{k}^{*} - \frac{1}{2} {A}_{k}^{†} {A}_{k} ⊗ I - \frac{1}{2} I ⊗ {( {A}_{k}^{†} {A}_{k} )}^{T} , \qquad ( 64 )$$

$${A}_{1} = ( \begin{matrix}0 & 1 \\ 0 & 0\end{matrix} ) ⊗ ( \begin{matrix}1 & 0 \\ 0 & 1\end{matrix} ) \qquad ( 65 )$$

$${A}_{2} = ( \begin{matrix}1 & 0 \\ 0 & 0\end{matrix} ) ⊗ ( \begin{matrix}1 & 0 \\ 0 & 1\end{matrix} ) \qquad ( 66 )$$

$${A}_{3} = ( \begin{matrix}1 & 0 \\ 0 & 1\end{matrix} ) ⊗ ( \begin{matrix}0 & 1 \\ 0 & 0\end{matrix} ) \qquad ( 67 )$$

$${A}_{4} = ( \begin{matrix}1 & 0 \\ 0 & 1\end{matrix} ) ⊗ ( \begin{matrix}1 & 0 \\ 0 & 0\end{matrix} ) . \qquad ( 68 )$$

$$And {f}_{1} ( t ) = 3 ( 1 + cos ( 2 t / T ) ) , \qquad ( 69 )$$

$${f}_{2} ( t ) = 1 + sin ( 2 t / T ) , \qquad ( 70 )$$

$${f}_{3} ( t ) = 2 ( 1 + cos ( 2 t / T ) ) , \qquad ( 71 )$$

$${f}_{4} ( t ) = 3 ( 1 + sin ( 2 t / T ) ) . \qquad ( 72 )$$

Moreover, a time-independent Hamiltonian (cf. Eq. (9)) is assumed:

$$ℋ = H ⊗ I - I ⊗ {H}^{T} , \qquad ( 73 )$$

$$H = 3 X ⊗ X + I ⊗ X , \qquad ( 74 )$$

$$where I = ( \begin{matrix}1 & 0 \\ 0 & 1\end{matrix} ) and X = ( \begin{matrix}0 & 1 \\ 1 & 0\end{matrix} ) .$$

It is noted that [symbol] (t) is the Liouville-space representation of the dissipator \hat{L}(t) such that \hat{L}(t)[ρ]=ξΣₖ₌₁⁴fₖ(t)\hat{L}ₖ, with \hat{L}ₖ[ρ]=AₖρA†ₖ−½A†ₖA_{K}ρ−½ρA†ₖAₖ. This follows by applying the vectorization rule of Eq. (5) to each \hat{L}ₖ[ρ], keeping in mind the linearity of this operation. Since the associated master equation

$$\frac{d}{dt} \vert ρ 〉 = ( - i ℋ + \tilde{ℒ} ( t ) ) \vert ρ 〉 \qquad ( 75 )$$

has GKSL (Gorini-Kossakowski-Sudarshan-Lindblad) form, it is guaranteed that its integration results in a completely positive and trace-preserving evolution. The inventors also stress that [symbol] (t) is now defined in the total time interval (0, t_{N}), to account for the many repetitions of the pulses [symbol] (t) and [symbol] _{I}(t−T) that come with the N shots.

The inventors numerically simulate QEM using the average formula of Eq. (65), by setting

$$N = 1000 , \qquad ( 76 )$$

$${N}_{s} = N / S , \qquad ( 77 )$$

$${n}_{1} = {N}_{2} = {n}_{3} = {N}_{s} / 3 \qquad ( 78 )$$

and 1≤S≤20. An execution of [symbol] or [symbol] is performed in a unit of time T=1, for which it is assumed that noise is essentially time independent. In other words, a more precise description of the noise occurring during the N shots is given by the discrete dissipator:

$${\tilde{ℒ}}_{disc} ( t ) = \tilde{ℒ} ( n ) , if n \leq t \leq n + 1 , \qquad ( 79 )$$

with [symbol] (t) satisfying Eq. (63) and 0≤n≤N−1. FIG. 6A shows the noise amplitudes fₖ(t) for the time fluctuating Lindbladian of Eq. (63).

FIG. 6B shows the error-mitigated expectation value [symbol] ρ [symbol] ₘᵢₜ= [symbol] ρ| [symbol] _{KIK, av}^{(M)}|ρ [symbol] , for the initial state ρ=I/2⊗|0 [symbol] 0|. The inventors apply Taylor error mitigation, using the coefficients a_{Tay, m}^{(M)} given in Eq. (42). If S=1, the standard strategy represented in FIG. 6B is recovered. It can be observed in FIG. 6B that in this case [symbol] ρ [symbol] ₘᵢₜ deviates drastically from the noiseless expectation value [symbol] ρ [symbol] _{id}= [symbol] ρ| [symbol] |ρ [symbol] . As S increases, second-order mitigation quickly approaches [symbol] ρ [symbol] _{id} and converges to it at S≈10. It should also be noted that for S≥10 the quality of error mitigation is maintained, both for M=1 and M=2, which shows that averaging the KIK formula over more sets does not degrade the performance of the KIK method. The success of this strategy is explained because

$${〈 ρ 〉}_{mit} = \frac{1}{s} {\sum }_{s = 1}^{S} 〈 ρ \vert {𝒰}_{KIK , s}^{( M )} \vert ρ 〉 ,$$

and if noise is approximately stationary for each [symbol] _{KIK,s}^{(M)} then the corresponding [symbol] ρ| [symbol] _{KIK,s}^{(M)}|ρ [symbol] constitute properly mitigated expectation values. In the present example, this condition holds for S sufficiently large due to the smooth character of the noise amplitudes fₖ(t) (see FIG. 6A). In contrast, for S=1 noise drifts prevent that [symbol] ρ| [symbol] _{KIK}^{(M)}|ρ [symbol] can be estimated with a consistent implementation of [symbol] and [symbol] . This example illustrates that without dividing the N shots into sets the KIK QEM may fail due to noise drifts, but by using KIK sets the method becomes fully resilient to noise drifts.

In the following, the novel aspect of the present disclosure is more specifically described related to an improved mitigation by using alternative polynomials to approximate the KIK formula, thereby providing an adaptive QEM to different noise ranges.

The method of the present disclosure is applicable not only to weak noise conditions, but also to the moderate noise regime where the finite-order Taylor expansion of Eq. (38) may not be optimal. The general idea is to accept low-performance mitigation where the noise is very small for the sake of avoiding large error when the noise is more substantial. Increasing the number of cycles in the KIK protocol improves the mitigation as it facilitates to better approximate the function f(x)=1/√(1−x) in Eq. (15). While the truncated Taylor series works very well when the noise is weak (x˜0), it poorly approximates f(x) for larger x values depending on the number of cycles used which sets the order of the polynomial.

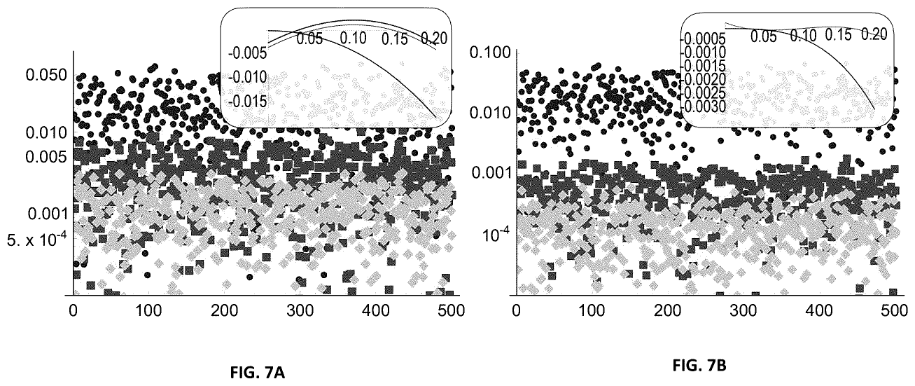

FIGS. 7A and 7B show a comparison between Taylor-expansion-based and Chebyshev-based KIK mitigation. The inset in FIG. 7A shows in red (green) the difference between

$$\frac{1}{\sqrt{1 - x}}$$

and its 1st-order Taylor expansion (2nd-order ChebyshevU). The 1st-order ChebyshevU polynomial P₍₁₎^{ChebU}(x) was fitted for the interval x∈[0,0.2]. While the Chebyshev polynomial is not accurate for small values of x, it is significantly better for larger x values. FIG. 7A shows a random two-qubit unitary (gate) exposed to decoherence in both qubits. The horizontal axis m corresponds to different unitaries, and the vertical axis corresponds to the error in the expectation value of the observable |00 [symbol] 00| (ground state population). The blue points show the deviation of the observable |00 [symbol] 00| from its ideal, decoherence-free value.

The red dots show the error after 1st-order Taylor-based mitigation Eq. (38), and the green points show mitigation based on 1st-order ChebyshevU polynomial, P₍₁₎^{ChebU}(x). One can see that almost in all cases the ChebysevU mitigation performs better than the Taylor expansion with the same number of mitigation cycles. The average error over different circuits, i.e., over m, of the ChebysevU with interpolation interval [0,0.2] is 2.45 smaller compared to the Taylor expansion. Crucially the maximal error is attenuated by a factor of 3.22. As expected, when the error is mild with respect to the observed maximal error, it can happen that the Taylor polynomial performs better.

More explicitly, the KIK protocol using P₍₁₎^{ChebU}(x) reads K_{mit (1)}^{ChebU=}1.58441K−0.58788KK_{I}K. In comparison to Taylor expansion in Eq. (38) that yields 1.5K−0.5KK_{I}K, the difference in the coefficients is small, and therefore the shot overhead of using Chebyshev polynomials instead of Tylor expansion is insignificant in this example. For 1st-order (3rd-order) Chebyshev mitigation based on the interval [0,0.2] the overhead is ˜6% (15%) with respect to the Taylor expansion. Finally, by using the purple polynomial in the inset FIG. 4a we get Kₘᵢₜ=1.5855K−0.588KK_{I}K which yield about 24% improvement in the average error with respect to the Chebyshev K_{mit (1)}^{ChebU}. FIG. 7B shows the same comparison for 2nd-order KIK. The attenuation of the mean (maximal) error is 3.84 (3.45) stronger with respect to the 2nd order Taylor expansion. The inset shows the difference between

$$\frac{1}{\sqrt{1 - x}}$$

and the 2nd-order Taylor expansion (red) and the 2nd-order Chebyshev polynomial (green).

The present disclosure provides QEM method that adapts to the noise strength of the target device and therefore can handle moderate to strong noise, as will be detailed in the following.

The inventors introduce the following quantity to address cases of moderate and strong noise

$${ε}_{L 2}^{( M )} := {\int }_{g ( μ )}^{1} {( {\sum }_{m = 0}^{M} {a}_{m}^{( M )} {λ}^{m} - {λ}^{\frac{1}{2}} )}^{2} d λ , \qquad ( 80 )$$

where μ=Tr(ρ′ρ), ρ is the initial state, and ρ′ is the state obtained by evolving ρ with the KIK cycle [symbol] .

For a pure state ρ, μ is the survival probability under the evolution [symbol] , and the lower limit g(μ) in the integration interval [g(μ),1] is a monotonically increasing function of μ such that 0≤g(μ)≤1 for 0≤μ≤1. Because (Σₘ₌₀^{M}aₘ^{(M)}λ^{m}−λ^{-1/2})² quantifies the deviation of λ^{-1/2} from Σₘ₌₀^{M}aₘ^{(M)}λ^{m}, for any eigenvalue λ of [symbol] , ε_{L2}^{(M)} can be interpreted as the total error in the approximation of Eq. (80), over the interval [g(μ),1]. The coefficients aₘ^{(M)} can be chosen to minimize ε_{L2}^{(M)}, under the condition that [symbol] _{KIK}^{(M)} constitutes a trace-preserving map. This leads to the coefficients {a_{Adap,m}^{(M)}}ₘ₌₀^{M}, which are analytically derived further below for 0≤M≤3. It should be noted that, by virtue of Eq. (80), these coefficients are functions of g(μ).

When the noise is strong one can expect the smallest eigenvalue [symbol] to be substantially smaller than one, and the function g(μ) should be chosen accordingly. In particular, if g(μ) is much larger than this eigenvalue the quantity ε_{L2}^{(M)} may fail to properly quantify the error in the approximation [symbol] _{KIK}^{(M)}. On the contrary, if g(μ) is smaller than the lowest λ, it is always possible to systematically improve the approximation by increasing the mitigation order M. The inventors confirmed this through a simulation of the transverse Ising model of five qubits described further below, implemented with ten cycles of Trotterization. In this simulation, functions {g(μ)}={1, μ, μ², μ^{2.5}} were used, and it was observed that μ² features the best performance with respect to the final fidelity. This fact was corroborated by additional simulations (not detailed in the present disclosure), and by the 10-swap experiment presented in the following. One could also explore the use of norms other than the L2 norm employed in Eq. (80), and weight functions w(λ)≠1 in the integrand of this expression.

It should be noted that, apart from the circuits [symbol] ( [symbol] )^{m}, used for the error mitigation itself, the estimation of μ only involves the additional circuit [symbol] . The variance in this estimation is given by μ(1−μ) and has the maximum value 0.25, irrespective of the size of the system. Therefore, the number of shots needed to estimate μ is small (below 1000).

To obtain the coefficients a_{Adap,m}^{(M)}, the inventors minimize the quantity

$${ε}_{L 2}^{( M )} := {\int }_{g ( μ )}^{1} {( {\sum }_{m = 0}^{M} {a}_{m}^{( M )} {λ}^{m} - {λ}^{\frac{1}{2}} )}^{2} d λ \qquad ( 81 )$$

with respect to the first M coefficients {aₘ^{(M)}}ₘ₌₀^{M-1} Therefore, one needs to solve the equations:

$$\frac{\partial {ε}_{L 2}^{( M )}}{\partial {a}_{m}^{( M )}} = 0 , for 0 \leq m \leq M - 1. \qquad ( 82 )$$

The M th coefficient is obtained by imposing the constraint a_{Adap, M}^{(M)}=1−Σₘ₌₀^{M-1}a_{Adap m}^{(M)}. This is equivalent to the normalization condition Σₘ₌₀^{M}a_{Adap,m}^{(M)}=1, which ensures that the map [symbol] _{KIK}^{(M)}=Σₘ₌₀^{M}a_{Adap,m}^{(M)}[g(μ)] [symbol] ( [symbol] )^{m} is trace-preserving if [symbol] and [symbol] are trace-preserving. For the sake of notational simplicity, in the following g(μ) will be written as g.

By explicitly evaluating ε_{L2}^{(M)} with M=1, 2, 3, it is found that

$${ε}_{L 2}^{( 1 )} = ( 1 - g ) {( {a}_{0}^{( 1 )} )}^{2} + \frac{1}{3} ( 1 - {g}^{3} ) {( {a}_{1}^{( 1 )} )}^{2} + ( 1 - {g}^{2} ) {a}_{0}^{( 1 )} {a}_{1}^{( 1 )} - 4 ( 1 - {g}^{\frac{1}{2}} ) {a}_{0}^{( 1 )} - \frac{4}{3} ( 1 - {g}^{\frac{3}{2}} ) {a}_{1}^{( 1 )} - ln ( g ) , \qquad ( 83 )$$

$${ε}_{L 2}^{( 2 )} = ( 1 - g ) {( {a}_{0}^{( 2 )} )}^{2} + \frac{1}{3} ( 1 - {g}^{3} ) {( {a}_{1}^{( 2 )} )}^{2} + \frac{1}{5} ( 1 - {g}^{5} ) {( {a}_{2}^{( 2 )} )}^{2} + ( 1 - {g}^{2} ) {a}_{0}^{( 2 )} {a}_{1}^{( 2 )} + \frac{2}{3} ( 1 - {g}^{3} ) {a}_{0}^{( 2 )} {a}_{2}^{( 2 )} + \frac{1}{2} ( 1 - {g}^{4} ) {a}_{1}^{( 2 )} {a}_{2}^{( 2 )} - 4 ( 1 - {g}^{\frac{1}{2}} ) {a}_{0}^{( 2 )} - \frac{4}{3} ( 1 - {g}^{\frac{3}{2}} ) {a}_{1}^{( 2 )} - \frac{4}{5} ( 1 - {g}^{\frac{5}{2}} ) {a}_{2}^{( 2 )} - ln ( g ) , \qquad ( 84 )$$

$${ε}_{L 2}^{( 3 )} = ( 1 - g ) {( {a}_{0}^{( 3 )} )}^{2} + \frac{1}{3} ( 1 - {g}^{3} ) {( {a}_{1}^{( 3 )} )}^{2} + \frac{1}{5} ( 1 - {g}^{5} ) {( {a}_{2}^{( 3 )} )}^{2} + \frac{1}{7} ( 1 - {g}^{7} ) {( {a}_{3}^{( 3 )} )}^{2} + ( 1 - {g}^{2} ) {a}_{0}^{( 3 )} {a}_{1}^{( 3 )} + \frac{2}{3} ( 1 - {g}^{3} ) {a}_{0}^{( 3 )} {a}_{2}^{( 3 )} + \frac{1}{2} ( 1 - {g}^{4} ) {a}_{0}^{( 3 )} {a}_{3}^{( 3 )} + \frac{1}{2} ( 1 - {g}^{4} ) {a}_{1}^{( 3 )} {a}_{2}^{( 3 )} + \frac{2}{5} ( 1 - {g}^{5} ) {a}_{1}^{( 3 )} {a}_{3}^{( 3 )} + \frac{1}{3} ( 1 - {g}^{6} ) {a}_{2}^{( 3 )} {a}_{3}^{( 3 )} - 4 ( 1 - {g}^{\frac{1}{2}} ) {a}_{0}^{( 3 )} - \frac{4}{3} ( 1 - {g}^{\frac{3}{2}} ) {a}_{1}^{( 3 )} - \frac{4}{5} ( 1 - {g}^{\frac{5}{2}} ) {a}_{2}^{( 3 )} - \frac{4}{7} ( 1 - {g}^{\frac{7}{2}} ) {a}_{0}^{( 3 )} - ln ( g ) . \qquad ( 85 )$$

By taking the partial derivatives according to Eq. (82) and solving the resulting linear equations, the corresponding coefficients read:

$${a}_{Adap , 0}^{( 1 )} = 1 + \frac{1}{{( 1 + \sqrt{g} )}^{3}} + \frac{3}{2 {( 1 + \sqrt{g} )}^{2}} , \qquad ( 86 )$$

$${a}_{Adap , 1}^{( 1 )} = - \frac{5 + 3 \sqrt{g}}{2 {( 1 + \sqrt{g} )}^{3}} . \qquad ( 87 )$$

$$for M = 1 , {a}_{Adap , 0}^{( 2 )} = 1 + \frac{16}{3 {( 1 + \sqrt{g} )}^{5}} - \frac{14}{3 {( 1 + \sqrt{g} )}^{4}} + \frac{4}{{( 1 + \sqrt{g} )}^{2}} , \qquad ( 88 )$$

$${a}_{Adap , 1}^{( 2 )} = - 4 \frac{10 + 8 \sqrt{g} + 9 g + 3 {g}^{\frac{3}{2}}}{3 {( 1 + \sqrt{g} )}^{5}} , \qquad ( 89 )$$

$${a}_{Adap , 2}^{( 2 )} = 2 \frac{13 + 5 \sqrt{g}}{3 {( 1 + \sqrt{g} )}^{5}} , for M = 2 , and \qquad ( 90 )$$

$${a}_{Adap , 0}^{( 3 )} = \frac{31 + 97 \sqrt{g} + 276 g + 300 {g}^{\frac{3}{2}} + 270 {g}^{2} + 114 {g}^{\frac{5}{2}} + 28 {g}^{3} + 4 {g}^{\frac{7}{2}}}{4 {( 1 + \sqrt{g} )}^{7}} , \qquad ( 91 )$$

$${a}_{Adap , 1}^{( 3 )} = - 5 \frac{29 + 35 \sqrt{g} + 84 g + 44 {g}^{\frac{3}{2}} + 26 {g}^{2} + 6 {g}^{\frac{5}{2}}}{4 {( 1 + \sqrt{g} )}^{7}} , \qquad ( 92 )$$

$${a}_{Adap , 2}^{( 3 )} = 3 \frac{81 + 47 \sqrt{g} + 76 g + 20 {g}^{\frac{3}{2}}}{4 {( 1 + \sqrt{g} )}^{7}} , \qquad ( 93 )$$

$${a}_{Adap , 3}^{( 3 )} = - 5 \frac{25 + 7 \sqrt{g}}{4 {( 1 + \sqrt{g} )}^{7}} , for M = 3. \qquad ( 94 )$$

Let us now check that the obtained coefficients minimize ε_{L2}^{(M)} in the subspace determined by the variables {aₘ^{(M)}}ₘ₌₀^{M-1}. For M=1, the second derivative

$$\frac{{\partial }^{2} {ε}_{L}^{( 1 )}}{\partial {a}_{0}^{( 1 ) 2}} = 2 ( 1 - g )$$

is positive if g≤1, and therefore a_{Adap,0}⁽¹⁾ minimizes ε_{L2}⁽¹⁾ with respect to a₀⁽¹⁾. To see if a_{Adap, 0}⁽²⁾ and a_{Adap,1}⁽²⁾ in Eqs. (86) and (87) minimize ε_{L2}⁽²⁾, the inventors evaluate the determinant of the Hessian matrix of ε_{L2}⁽²⁾ and the second partial derivative

$$\frac{{\partial }^{2} {ε}_{L 2}^{( 2 )}}{\partial {a}_{0}^{( 2 ) 2}} ,$$

and check their positivity. Since

$$\frac{{\partial }^{2} {ε}_{L}^{( 2 )}}{\partial {a}_{0}^{( 2 ) 2}} = 2 ( 1 - g ) \geq 0 ,$$

one only needs to check the determinant of the Hessian matrix

$$H = ( \begin{matrix}\frac{{\partial }^{2} {ε}_{L}^{( 2 )}}{\partial {a}_{0}^{( 2 ) 2}} & \frac{{\partial }^{2} {ε}_{L}^{( 2 )}}{\partial {a}_{0}^{( 2 )} \partial {a}_{1}^{( 2 )}} \\ \frac{{\partial }^{2} {ε}_{L 2}^{2 )}}{\partial {a}_{1}^{( 2 )} \partial {a}_{0}^{( 2 )}} & \frac{{\partial }^{2} {ε}_{L}^{( 2 )}}{\partial {a}_{1}^{( 2 ) 2}}\end{matrix} ) = ( \begin{matrix}2 ( 1 - g ) & 1 - {g}^{2} \\ 1 - {g}^{2} & \frac{2}{3} ( 1 - {g}^{3} )\end{matrix} ) \qquad ( 95 )$$

Such a determinant is given by det(H)=− 4/3[1−g][1−g³]−[1−g²]², which is also positive in the interval 0≤g≤1. Finally, for M=3 the Hessian matrix is obtained:

$$H = ( \begin{matrix}\frac{{\partial }^{2} {ε}_{L 2}^{( 3 )}}{\partial {a}_{0}^{( 3 ) 2}} & \frac{{\partial }^{2} {ε}_{L 2}^{( 3 )}}{\partial {a}_{0}^{( 3 )} \partial {a}_{1}^{( 3 )}} & \frac{{\partial }^{2} {ε}_{L}^{( 3 )}}{\partial {a}_{0}^{( 3 )} \partial {a}_{2}^{( 3 )}} \\ \frac{{\partial }^{2} {ε}_{L 2}^{( 3 )}}{\partial {a}_{1}^{( 3 )} \partial {a}_{0}^{( 3 )}} & \frac{{\partial }^{2} {ε}_{L 2}^{( 3 )}}{\partial {a}_{1}^{( 3 ) 2}} & \frac{{\partial }^{2} {ε}_{L 2}^{( 3 )}}{\partial {a}_{1}^{( 3 )} \partial {a}_{2}^{( 3 )}} \\ \frac{{\partial }^{2} {ε}_{L 2}^{( 3 )}}{\partial {a}_{2}^{( 3 )} \partial {a}_{0}^{( 3 )}} & \frac{{\partial }^{2} {ε}_{L 2}^{( 3 )}}{\partial {a}_{2}^{( 3 )} \partial {a}_{1}^{( 3 )}} & \frac{{\partial }^{2} {ε}_{L}^{( 3 )}}{\partial {a}_{2}^{( 3 ) 2}}\end{matrix} ) = ( \begin{matrix}2 ( 1 - g ) & 1 - {g}^{2} & \frac{2}{3} ( 1 - {g}^{3} ) \\ 1 - {g}^{2} & \frac{2}{3} ( 1 - {g}^{3} ) & \frac{1}{2} ( 1 - {g}^{4} ) \\ \frac{2}{3} ( 1 - {g}^{3} ) & \frac{1}{2} ( 1 - {g}^{4} ) & \frac{2}{5} ( 1 - {g}^{5} )\end{matrix} ) \qquad ( 96 )$$

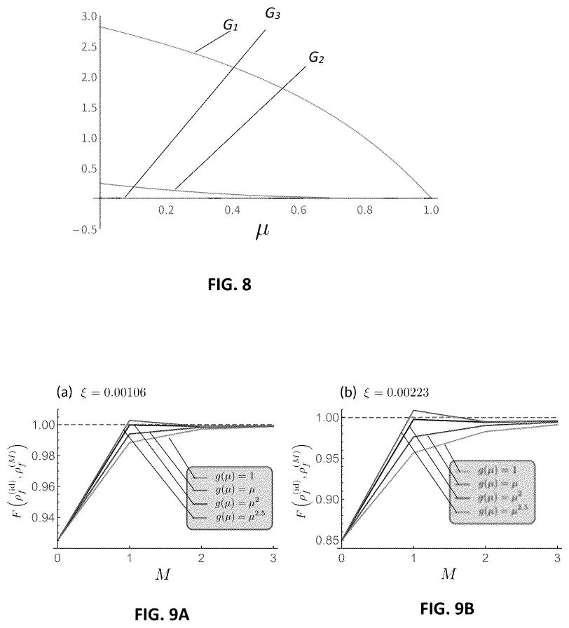

FIG. 8 shows eigenvalues G1, G2, G3 of the Hessian matrix (96), as a function g=g(μ), where the eigenvalue G3 is not visible because of its closeness to zero for 0≤g≤1. Since all of them are positive in the interval 0≤g≤1, the inventors conclude that Eqs. (91)-(94) provide the coefficients a_{Adap,m}⁽³⁾ that minimize ε_{L2}⁽³⁾ with respect to {aₘ^{(M)}}ₘ₌₀².

In the following, the inventors simulate the application of the KIK method to a noisy implementation of the transverse Ising model. This model is characterized by the Hamiltonian:

$$H = g {\sum }_{i = 1}^{n} {X}_{i} + J {\sum }_{i = 1}^{n - 1} {Z}_{i} ⊗ {Z}_{i + 1} := {gH}_{X} + {JH}_{ZZ} \qquad ( 97 )$$

where H_{zz} accounts for the magnetic interactions between nearest-neighbor spins, and the transverse magnetic fields are represented by the local term Hₓ. The inventors consider n=5 spins and set g=0.2 and J=0.1. There is not a particular reason for choosing these parameter values. However, similar performance was obtained with simulations using alternative values (not shown here).

For the simulation, it is assumed that the target evolution U=e^{31 iHT} is implemented in a quantum computer via Trotterization. Taking into account that the X and Z Pauli matrices do not commute, an approximation to U involving n Trotter steps has the form:

$$U \approx {U}_{n} := {( {e}^{- {igH}_{X} \frac{T}{n}} {e}^{- {iJH}_{ZZ} \frac{T}{n}} )}^{n} , \qquad ( 98 )$$

where T is the total evolution time. Assuming T=10 and 10 Trotter steps, it can be written:

$$U \approx {U}_{10} := {( {e}^{- {igH}_{X}} {e}^{- {iJH}_{ZZ}} )}^{10} . \qquad ( 99 )$$

In what follows, Iⱼ will denote the identity matrix of dimension 2^{j}×2^{j}, with I=Iₙ. It should be noted that inventors' goal is not to test the accuracy of the Trotter approximation of Eq. (99), but to study the performance of the KIK method to mitigate errors in a noisy implementation of U₁₀. To this end, the inventors model the noisy evolution [symbol] associated with U₁₀ using:

$$𝒦 = {( {e}^{- ig {ℋ}_{X} + ξ ℒ} {e}^{- iJ {ℋ}_{ZZ} + ξℒ} )}^{10} , \qquad ( 100 )$$

$${ℋ}_{X} = {H}_{X} ⊗ I - I ⊗ {( {H}_{X} )}^{T} , \qquad ( 101 )$$

$${ℋ}_{ZZ} = {H}_{ZZ} ⊗ I - I ⊗ {( {H}_{ZZ} )}^{T} , where \qquad ( 102 )$$

$$ℒ = S ⊗ {S}^{*} - \frac{1}{2} {S}^{†} S ⊗ I - \frac{1}{2} I ⊗ {( {S}^{†} S )}^{T} , \qquad ( 103 )$$

$$S = 0.5 {S}_{1} + 1.7 {S}_{2} + 0.3 {S}_{3} + 2 {S}_{4} + {S}_{5} , \qquad ( 104 )$$

$${S}_{j} + {I}_{j - 1} ⊗ A ⊗ {I}_{n - j} , for 1 \leq j \leq 5 , \qquad ( 105 )$$

$$A = ( \begin{matrix}0 & 1 \\ 0 & 0\end{matrix} ) . \qquad ( 106 )$$

The initial state in the present simulation is the ground state ρ=|0 [symbol] [symbol] 0|^{⊗5}.

To assess the performance of the KIK QEM, the inventors use the fidelity between the ideal final state |ρ_{f}^{(id)} [symbol] := [symbol] ₁₀|ρ [symbol] (being [symbol] ₁₀ the Liouville-space representation of U₁₀) and the error-mitigated final state |ρ_{f}^{(M)} [symbol] := [symbol] _{KIK}^{(M)}|ρ [symbol] , which reads:

$$F ( {ρ}_{f}^{( id )} , {ρ}_{f}^{( M )} ) = {[ Tr \sqrt{\sqrt{{ρ}_{f}^{( id )}} {ρ}_{f}^{( M )} \sqrt{{ρ}_{f}^{( id )}}} ]}^{2} . \qquad ( 107 )$$

Notice that the fidelity must be computed using the density matrices ρ_{f}^{(id)} and ρ_{f}^{(M)}, and not their vector representations |ρ_{f}^{(id)} [symbol] and |ρ_{f}^{(M)} [symbol] . The inventors consider values of ξ given by ξ=0.00223 and ξ=0.00106, which lead to fidelities of unmitigated final states (M=0)

$$F ( {ρ}_{f}^{( id )} , {ρ}_{f}^{( M )} ) = 0.85 , for ξ = 0.00223 , \qquad ( 108 )$$

$$F ( {ρ}_{f}^{( id )} , {ρ}_{f}^{( M )} ) = 0.925 , for ξ = 0.00106 . \qquad ( 109 )$$

QEM is performed by choosing functions {g(μ)}={1, μ, μ², μ^{2.5}}, and 1≤M≤3. It is recalled that the function g(μ) determines the lower limit of integration in ε_{L2}^{(M)} (see above in reference to Eq. (80)), and that for each g(μ) QEM is applied with [symbol] _{KIK}^{(M)}=Σₘ₌₀^{M}aₘ^{(M)}[g(μ)] [symbol] ( [symbol] )^{m}, using coefficients aₘ^{(M)}[g(μ)] evaluated at g=g(μ). In particular, g(μ)=1 corresponds to Taylor mitigation. Keeping in mind Eq. (88), the inverse [symbol] is given by:

$${𝒦}_{I} = {( {e}^{iJ {𝒦}_{ZZ} + ξℒ} {e}^{ig {ℋ}_{X} + ξℒ} )}^{10} . \qquad ( 110 )$$

FIGS. 9A and 9B show the fidelity F(ρ_{f}^{(id)}, ρ_{f}^{(M)}) as a function of M, for ξ=0.00106 and ξ=0.00223, respectively. Overall, it is observed that the best performance is achieved by the function g(μ)=μ² (blue curve). In particular, F(ρ_{f}^{(id)}, ρ_{f}^{(M)}) reaches a value extremely close to one already for M=1. The function g(μ)=μ^{2.5} (magenta curve) also produces a large fidelity, but for M=1 it results in unphysical values that are significantly above 1. A clearer comparison between the different functions g(μ) is possible by looking at the ratio between the infidelity before QEM and after QEM,

$${r}_{F} ( M ) = \frac{1 - F ( {ρ}_{f}^{( id )} , {ρ}_{f}^{( 0 )} )}{1 - F ( {ρ}_{f}^{( id )} , {ρ}_{f}^{( M )} )} , \qquad ( 111 )$$

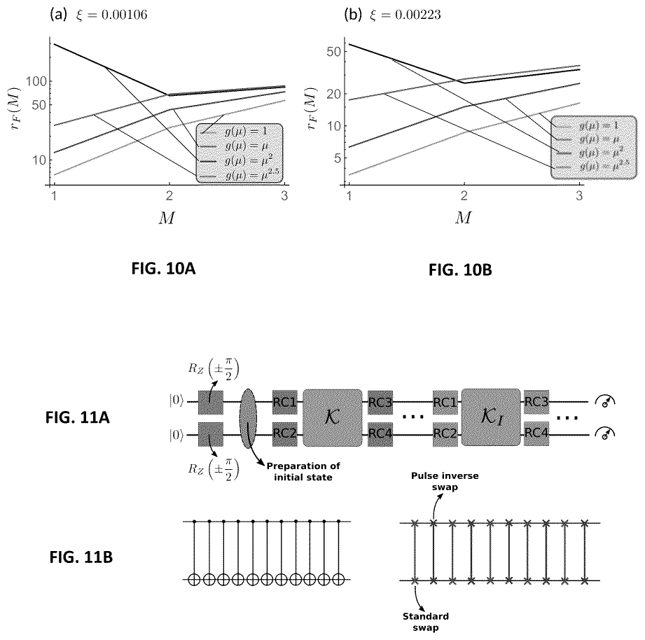

which quantifies the infidelity suppression provided by the KIK method. This quantity is plotted in FIGS. 10A and 10B. In both figures, it can be seen that g(μ)=μ² outperforms g(μ)=1 and g(μ)=μ for all 1≤M≤3. Although the ratio r_{F}(M) corresponding to g(μ)=μ² is slightly below that associated with g(μ)=μ^{2.5}, in the case of M=2, 3, g(μ)=μ² yields a substantially larger r_{F}(M) if M=1.

Finally, it is interesting to observe how the different functions g(μ) produce physically consistent fidelities F(ρ_{f}^{(id)}, ρ_{f}^{(M)})≤1 as M increases. In particular, it can be seen that the unphysical fidelity F(ρ_{f}^{(id)}, ρ_{f}⁽¹⁾)>1 corresponding to g(μ)=μ^{2.5} is quickly fixed by going to the next mitigation order M=2. The explanation for this behavior is as follows. The quality of the approximation Σₘ₌₀^{M}a_{Adap ,m}^{(M)}[g(μ)]( [symbol] )^{m} to ( [symbol] )^{-1/2} is determined by how well the polynomial Σₘ₌₀^{M}a_{Adap, m}^{(M)}[g(μ)]λₘ approximates the function λ^{-1/2}, where λ is an eigenvalue of [symbol] . If g(μ) is too small, as compared to the smallest eigenvalue of ( [symbol] )^{-1/2}, a polynomial Σₘ₌₀^{M}a_{Adap m}^{(M)}[g(μ)]( [symbol] )^{m} with low M may be a rough approximation to ( [symbol] )^{-1/2}. This leads to undesired effects such as the aforementioned fidelity F(ρ_{f}^{(id)}, ρ_{f}⁽¹⁾)>1 (note that in the example of the disclosure, the function g(μ)=μ^{2.5} yields the smallest g(μ) for any value of μ). However, by increasing M the inventors can always improve the approximation in the whole interval (g(μ),1), which by assumption contains all the eigenvalues of ( [symbol] )^{-1/2}. This would explain not only the recovery of a physical fidelity but also that for M=2 and M=3 the maximum values of this quantity correspond to g(μ)=μ^{2.5}.

On the contrary, when g(μ) is larger than the smallest eigenvalue of ( [symbol] )^{-1/2}, the interval (g(μ),1) does not contain all the eigenvalues of ( [symbol] )^{-1/2} and increasing M does not necessarily improves the QEM. This is likely the reason that g(μ)=μ² yields fidelities smaller for M=2 and M=3, as compared to M=1.

As mentioned above, the inventors tested the KIK method of the present disclosure by performing experiments using the IBM quantum computing platform. Specifically, two experiments were performed, a ten-swap circuit calibration of a CNOT gate. The ten-swap experiment shows the added value of the additive nature of the method and the calibration experiment shows how the present method performs as expected and observed in simulation while circuit folding based QEM produced non-meaningful and erroneous results. In the following, a detailed description of experimental techniques and procedures used is presented.

A usual approach to handle coherent errors in QEM is to first transform them into incoherent errors via randomized compiling, and then apply QEM. Here, the inventors discuss the application of the KIK formula to directly mitigate the coherent errors caused by a faulty calibration of the CNOT gate. The same approach can be used in the case of single-qubit gates. Further below, the inventors describe a technique to complement the KIK mitigation for a whole circuit [symbol] , with a KIK-based calibration of the individual CNOT gates.

In the following, the details of the integration of KIK-based method of the presently disclosed subject matter with complementary error mitigation methods, e.g., random compiling, are described.

Reference is made to FIGS. 11A and 11B showing schematically the QEM circuits used in the experiments. FIG. 11A shows a general form of a KIK circuit [symbol] ( [symbol] )^{m}, and FIG. 11B shows the evolution [symbol] used for the CNOT calibration experiment (left), and for the ten-swap experiment (right). It should be noted that only in the case of CNOT calibration experiment the initial state is prepared (i.e., it is not part of the ten-swap experiment) and only in the case of the ten-swap experiment, the evolutions [symbol] and [symbol] are interleaved by randomized compiling operations, as will be described in detail below.

The inventors consider three complementary techniques for addressing errors that can affect an experiment in the three stages of its execution. Namely, the preparation of the initial state, the evolution, and the measurement.

In the IBM quantum processors the preparation of the single-qubit (default) computational state |0 [symbol] may possess a small deviation angle δθ. As a result, the prepared state is given by

$$\vert ψ ( δθ ) 〉 = cos ( \frac{δ θ}{2} ) \vert 0 〉 + {e}^{i φ} sin ( \frac{δθ}{2} ) \vert 1 〉 .$$

To cope with this error, the inventors apply rotations

$${R}_{Z} ( \pm π / 2 ) = {e}^{∓ i \frac{π}{4} Z}$$

on each qubit (in both experiments), in such a way that R_{z}(π/2) and R_{z}(−π/2) are equally distributed among the number of shots. This produces a mixed state

$$ϱ = {cos}^{2} ( \frac{δθ}{2} ) \vert 0 〉 〈 0 \vert + {sin}^{2} ( \frac{δθ}{2} ) \vert 1 〉 〈 1 \vert , \qquad ( 112 )$$

whose population

$$Tr ( \vert 0 〉 〈 0 \vert ϱ ) = {cos}^{2} ( \frac{δθ}{2} )$$

coincides with | [symbol] 0|ψ(δθ) [symbol] |². However, the coherent error associated with the rotation angles δθ and φ is eliminated through this procedure. Since both experiments involve circuits acting on two qubits, there are four possible rotation operations characterized by the pairs of angles {(π/2, π/2), (π/2, −π/2), (−π/2, π/2), (−π/2, −π/2)}. This is illustrated by the green squares in FIG. 11A.

Coherent errors present during the evolution stage of a quantum circuit can be specially harmful for quantum computing. Randomized compiling (RC) is a standard method that allows to transform these errors into stochastic noise, which is more amenable to the application of QEM. The essential idea of RC is to replace the target circuit by an average over compiled realizations that are logically equivalent to the original evolution. Each RC realization is obtained by randomly replacing and/or adding some gates that leave the noise-free target circuit invariant. However, in the presence of coherent errors, different RC realizations produce different evolutions, and coherent errors characteristic of single realizations can be averaged out into stochastic noise.

In the method of the present disclosure, the implementation [symbol] _{KIK}^{(M)} of the KIK formula contains both the target evolution [symbol] and its inverse [symbol] . Therefore, for each KIK power [symbol] ( [symbol] )^{m} RC is independently applied on [symbol] and [symbol] , as indicated in FIG. 11A. This is done by using the Pauli gates shown in Table 1, which are performed before and after the execution of [symbol] and [symbol] in the ten-swap experiment. In Table 1, RC1 and RC2 stand for Pauli gates that are performed as indicated in FIG. 11A. Since in this circuit the ideal unitary associated with [symbol] and [symbol] is the identity, the gate RC3 must coincide with RC1, and the gate RC4 must coincide with RC2. A sequence of ten swap gates is logically equivalent to the identity operation, and one can straightforwardly check that each RC realization in Table 1 reproduces this operation. Furthermore, it should be noted that an independent application of RC on [symbol] and [symbol] is important to perform an effective randomization of the coherent errors affecting both evolutions. This ensures that the first Magnus terms appearing in the evolutions [symbol] and [symbol] (cf. Eqs. (23) and (24)) are still related through Eq. (25), and thus validates the KIK formula with the randomized versions of [symbol] and [symbol] . Along the same line, the inventors avoid the simplification of RC layers in any sequence [symbol] ( [symbol] )^{m}. This means that consecutive single-qubit gates used for RC are not merged into a single gate. Otherwise, the independency of the randomization would be affected by preventing that the gates of the original pair act separately on [symbol] and [symbol] .

On the other hand, for the CNOT calibration experiment the use of RC is omitted. The reason is that, in this experiment, the inventors explored an alternative mitigation of coherent errors affecting the calibrated gate, which operates differently from RC. More specifically, a KIK-based mitigation of stochastic noise in the calibration process can improve the quality of the calibration, which translates into a calibrated gate with reduced coherent errors.

TABLE 1

| RC1 | RC2 |
|---|---|
| I | I |
| I | X |
| I | Y |
| I | Z |
| X | I |
| X | X |
| X | Y |
| X | Z |
| Y | I |
| Y | X |
| Y | Y |
| Y | Z |
| Z | I |
| Z | X |
| Z | Y |
| Z | Z |

A final ingredient for the QEM experiments described herein, is the mitigation of readout errors. For a circuit executed on N qubits, the measurement process outputs counts of the states |i₁i₂ . . . i_{N} [symbol] (iⱼ∈{0,1} for 1≤j≤N) in the computational basis. A readout error occurs when the state registered upon the measurement is incorrect. For example, for a single qubit whose final state is |1 [symbol] , some counts may erroneously register the state as being |0 [symbol] .

Let us denote a general N-bit string by k=(k₁k₂ . . . k_{N}), and the corresponding computational state by |k [symbol] . When a quantum circuit produces a final state σ, readout errors cause wrong estimates of the probabilities pₖ=Tr(|k [symbol] k|σ). A simple way to relate the ideal probabilities pₖ and the erroneous ones is by considering the probability distributions associated with each computational state.

If p(l|k) denotes the conditional probability to register the state |l [symbol] , given that the actual state is |k [symbol] , for the final state σ the probability to measure |l [symbol] in the presence of readout errors is given by

$${q}_{l} = {\sum }_{k} p ( l \vert k ) {p}_{k} . \qquad ( 113 )$$

Thus, the information about the readout errors is contained in a 2 ^{N}×2^{N} matrix M with entries p(l|k), whose columns and rows are associated with k and l, respectively. To counteract the effect of the readout errors, we can invert the “measurement matrix” M can be inverted. In this way, the vector of error-free probabilities can be obtained by applying the inverse M⁻¹ to the vector of measured probabilities.

Although the procedure described above is not scalable in N, because the size of M is exponential in the number of qubits, the experiments described herein involve two qubits and admit an efficient estimation of the p(l|k). To this end, the inventors prepared the four computational states {|ij [symbol] }_{i,j=0}¹ using circuits with the appropriate X gates. For example, |01 [symbol] is prepared by applying X on the second qubit. The measurement matrices were experimentally determined and then inverted for readout error mitigation in both the CNOT calibration experiment and the ten-swap experiment. The number of shots invested in the estimation of the the distributions {p(l|k)}ₗ is given in Table 2 shown further below.

As a final comment, it is important to mention that the study of methods to efficiently cope with readout errors in circuits containing a large number of qubits is an active area of research. For example, readout errors with a low degree of correlations can be addressed by considering measurement matrices of reduced dimension. The extreme scenario corresponds to completely uncorrelated errors, where it is sufficient to compute measurement matrices for each qubit and the ensuing (readout) error mitigation cost is linear in the number of qubits.

The experimental estimates of different probability distributions are computed as frequencies over the number of shots. Ultimately, the goal is to estimate probability distributions {pₖ^{(m,i)}}ₖ for each m and i, where pₖ^{(m,i)} denotes the probability to measure |k [symbol] when the circuit [symbol] ( [symbol] )^{m} is implemented in combination with the ith RC realization. These probabilities are the key element for the computation of expectation values and the application of QEM.

In the case of the ten-swap experiment, the inventors applied 16 RC realizations of each circuit [symbol] ( [symbol] )^{m} as will be described further below). Hence, for any m the expectation value Tr(Oσ) of an observable O is estimated as

$${〈 O 〉}_{m} = \frac{1}{{N}_{RC}} {\sum }_{i = 1}^{{N}_{RC}} {〈 O 〉}_{m , i} , \qquad ( 114 )$$

$${〈 O 〉}_{m , i} = {\sum }_{k} {p}_{k}^{( m , i )} {O}_{k} , \qquad ( 115 )$$

where N_{RC}=16. Importantly, for observables that are not diagonal in the computational basis, the final state σ in Tr(Oσ) must contain a rotation that performs the corresponding change of basis. For example, to measure the observable O=Y₁ on qubit 1, for the CNOT calibration experiment, before the measurement the inventors applied a rotation

$${R}_{{X}_{1}} ( π / 2 ) = {e}^{- i \frac{π}{4} {X}_{1}}$$

on this qubit.

Since different RC realizations correspond to independent experiments, the variance for [symbol] O [symbol] ₘ reads

$$\begin{matrix}Var ( {〈 O 〉}_{m} ) = \frac{1}{{N}_{RC}^{2}} {\sum }_{i = 1}^{{N}_{RC}} Var ( {〈 O 〉}_{m , i} ) \\ = \frac{1}{{N}_{RC}^{2}} {\sum }_{i = 1}^{{N}_{RC}} [ \frac{{\sum }_{k} {p}_{k}^{( m , i )} {O}_{k}^{2} - {〈 O 〉}_{m , i}^{2}}{{N}_{i}} ] ,\end{matrix} \qquad ( 116 )$$

where Nᵢ is the number of shots used in the ith RC realization. In the CNOT calibration experiment RC was not implemented, as mentioned before. However, Eqs. (114)-(116) are still applicable in this case, with N_{RC}=8 being the number of circuits associated with different initial rotations, and the index i labeling any of these circuits.

The KIK method provides the error-mitigated expectation value

$${〈 O 〉}_{M} = {\sum }_{m = 0}^{M} {a}_{m}^{( M )} {〈 O 〉}_{m} , \qquad ( 117 )$$

with the coefficients aₘ^{(M)} chosen depending on the QEM strategy. Namely, Taylor mitigation, or adaptive mitigation. The independency of the experiments associated with different circuits [symbol] ( [symbol] )^{m} leads to the variance

$$Var ( {〈 O 〉}_{m} ) = {\sum }_{m = 0}^{M} {( {a}_{m}^{( M )} )}^{2} Var ( {〈 O 〉}_{m} ) . \qquad ( 118 )$$

The error bars in the plots of the experimental results shown in FIGS. 14A-14C and 15A-15B described further below, correspond to one standard deviation. That is, half of each error bar is given by \sqrt{Var( [symbol] O [symbol] _{M})}.

In the following, the results of the CNOT calibration experiment are described.

The calibration experiment was performed on the IBM processor Jakarta, using the qubits labeled by 0 and 1. The qubit 0 was employed as control for the CNOT gate and the qubit 1 as target. In the IBM processors, the two-qubit interaction used to generate the CNOT gate is effectively implemented via the so called cross resonance interaction H_{CR}=Z⊗X, where Z and X are the Pauli matrices

$$Z = ( \begin{matrix}1 & 0 \\ 0 & - 1\end{matrix} ) and X = ( \begin{matrix}0 & 1 \\ 1 & 0\end{matrix} )$$

acting on the control qubit and target qubit, respectively. The CNOT thus involves a π/2 rotation with the Hamiltonian H_{CR}. This operation is performed in the quantum processor by applying a microwave pulse characterized by various calibrated parameters such as amplitude and duration. However, the values obtained for these parameters may be affected by systematic errors, due to noise present in the measurements used for calibration.

The inventors focus on the calibration of the pulse amplitude, using the KIK method to mitigate the effect of noise. The initial state

$$\frac{1}{\sqrt{2}} ( \vert 0 〉 + ( \vert 1 〉 ) ⊗ \vert 0 〉$$

is prepared and the observable

$$Y = ( \begin{matrix}0 & - i \\ i & 0\end{matrix} )$$

is measured on the target qubit for different pulse amplitudes. For amplitude factors F∈{0.98, 0.9866, 0.9933, 1, 1.0066, 1.0133, 1.02}, where F=1 corresponds to the default value used by IBM, this choice of initial state and observable is convenient because it produces a calibration curve that is very well described by a straight line. Therefore, the calibration process only involves the fitting of two parameters to the experimental data. One of these parameters is the intersection of the calibration curve with the x axis. This corresponds to [symbol] Y₁ [symbol] =0, and yields the value of the calibrated amplitude, taking into account that the ideal final state is the Bell state

$$\frac{1}{\sqrt{2}} ( \vert 00 〉 + \vert 11 〉 ) .$$

To increase the precision of the calibration, the experiment was performed using a sequence of 11 CNOT gates. Ideally, this circuit is equivalent to a single CNOT, and the repetition of CNOTs has the effect of amplifying the variations of [symbol] Y₁ [symbol] associated with different values of F. Accordingly, the inverse [symbol] for the left circuit in FIG. 11B consists of a sequence of gates such that each of them is the pulse inverse of a single CNOT.

In the processor Jakarta, the maximum number of shots per circuit is 32000. For the mitigation of readout errors, the inventors repeated four times the circuits employed in the preparation of each computational state, which yields a total of 4×32000=128000 shots used to estimate each probability distribution {p(l|k)}ₗ. The circuits [symbol] ( [symbol] )^{m}, used for QEM, were preceded by any of the four rotation operations used to mitigate the preparation coherent error. These rotations were executed before the preparation of the initial state, as shown in FIG. 11A. The inventors repeated two times the circuit corresponding to any rotation. Hence, 8×32000=256000 shots were employed to measure the expectation value of Y₁ on each [symbol] ( [symbol] )^{m}, for each amplitude F. Since KIK mitigation was applied up to order 3, the value of m varies between 0 and 3. These experimental details are summarized in Table 2 summarizing the experimental resources. In Table 2 the “shots per KIK circuit” are the number of shots associated with each circuit [symbol] ( [symbol] )^{m}, for 0≤m≤3. For both experiments, these shots include the initial rotations, and also RC operations in the case of the ten-swap experiment. The “shots for readout mitigation” are the total number of shots used to compute M⁻¹.

TABLE 2

| | shots per KIK | shots for readout | |
|---|---|---|---|
| | circuit | mitigation | RC operations |
| CNOT calibration | 256000 | 512000 | n/a |
| experiment | | | |
| ten-swap experiment | 320000 | 240000 | 16 |

FIGS. 12A and 12B show the results of the effective calibration of a CNOT in the IBM processor Jakarta using the KIK method.) In FIG. 12A [symbol] is given by the pulse inverse, whereas in FIG. 12B [symbol] is given by the circuit inverse [symbol] = [symbol] . As described above, the CNOT gate is applied on the prepared initial state

$$ρ = \frac{1}{\sqrt{2}} ( \vert 0 〉 + \vert 1 〉 ) ⊗ \vert 0 〉 ,$$

and the expectation value of the observable Y₂ (where Y₂ is the y-Pauli matrix acting on the target qubit 2) is measured at different pulse amplitudes of the cross resonance pulse, which constitutes the two-qubit interaction in the IBM CNOT implementation.

Each data point of FIGS. 12A and 12B is obtained by applying “Taylor mitigation” (i.e. using Eq. (28) with the coefficients aₘ^{(M)}=a_{Tay,m}^{(M)}), for 0≤M≤3, and linear regression (least squares) is applied to determine the line that best fits the experimental data. The inventors also verify that in this case mitigation with the adapted coefficients a_{Adap,m}^{(M)} does not yield a noticeable advantage. This indicates that the noise is sufficiently weak, which is further evidenced by the quick convergence of the lines corresponding to M≥1 in FIG. 12A.

Keeping in mind that the calibrated amplitude must reproduce the ideal expectation value [symbol] Y₂ [symbol] =0, the fact that the factors [symbol] associated with the magenta and black dashed lines L1 and L2 in FIG. 12A are different, indicates that the predicted amplitude without QEM (M=0) and with QEM are different. Since the CNOT is subjected to stochastic noise, without QEM the measured expectation values will be shifted and the corresponding linear regression results in a calibrated amplitude that is also shifted with respect to the correct value. The ensuing effect is a coherent error due to unmitigated stochastic noise. By using the KIK method, the error-mitigated expectation values mitigate such a coherent error. It is important to stress that the benefit of this calibration would manifest when combined with QEM of the circuit [symbol] in which the CNOTs participate. The reason is that the calibrated field is consistent with gates of reduced (stochastic) noise (due to the use of QEM in the calibration process), and therefore it is not useful if the target circuit is implemented with all its original noise.

FIGS. 12A and 12B also exemplify that a proper implementation of KIK QEM requires the pulse-based inverse [symbol] (used in FIG. 12A), characterized in detail above (refer to Eq. (14)), while the use of another CNOT for [symbol] (used in FIG. 12B) does not show the expected convergence as the mitigation order M increases. Note also that despite a CNOT is its own inverse in the noiseless scenario, it leads to a coefficient of determination R² whose values evidence a poor linear fit. It should be noted that the linear behavior is consistent with the behaviour observed in simulation as shown in FIGS. 16 and 17.

In the following, the results of the Ten-swap experiments are described in detail.

In this experiment, the error-mitigated quantity was the probability for the system to remain in the initial state |00 [symbol] , after applying a sequence of ten swap gates. The IBM processor employed was Quito. Reference is made to FIG. 13A showing the results of QEM for a circuit [symbol] given by a sequence of ten swap gates, and FIG. 13B showing the schematic of [symbol] .

In practice, three CNOT gates were used to implement each swap, as shown in FIG. 13B. Apart from the application of RC, detailed below, the inventors reduced the action of coherent errors by alternating a normal swap with a pulse-based inverse swap (see FIG. 11B). This strategy has been previously applied to gates that are their own inverse, with the purpose of mitigating coherent errors such as overrotations [22]. Since a swap gate is its own inverse, the ideal target circuit of the experiment is not modified by interleaving standard swaps with their pulse-inverse counterparts.

The idea behind this strategy is that coherent errors such as overrotations can be compensated via the pulse-inverse evolutions. In short, the execution of a pulse inverse produces an overrotation in a direction opposite to that of the original gate, thus canceling it out. Furthermore, since any sequence of two swaps is equivalent to the identity operation, the ideal target circuit of the experiment is not modified by the use of these alternating swaps.

Apart from the error mitigation associated with [symbol] itself, the inventors separately tackle readout errors, and a small preparation error that affects the default computational state ρ=|00 [symbol] 00|. The results shown here are further enhanced by applying randomized compiling to the evolutions [symbol] and [symbol] , where circuits logically equivalent to the ideal evolution [symbol] are randomly implemented. This is useful for turning coherent noise into incoherent noise, which can be addressed by the method of the present disclosure. In this way, the results of FIG. 13A are obtained by combining the KIK method with auxiliary techniques for handling preparation errors, readout errors, and coherent errors, using strategies detailed below.

The inventors mitigate errors in the survival probability Tr(ρσ), where σ is the noisy final state that results from applying [symbol] to ρ. To perform QEM, the truncated expansion of Eq. (28) is considered with mitigation orders 1≤M≤3. The blue curve in FIG. 13A corresponds, to Taylor mitigation aₘ^{(M)}=a_{Tay,m}^{(M)}. Coefficients aₘ^{(M)}=a_{Adap,m}^{(M)} that are adapted with functions g(μ)=μ and g(μ)=μ² in Eq. (80) give rise to the orange and green curves, respectively. Furthermore, for [symbol] the pulse-based inverse is performed according to the pulse schedule described above (refer to Eq. (14)). While in the absence of noise there is no difference between different realizations of the inverse evolution, the pulse-inverse used by the KIK method is preferable over other alternatives. This is in contrast with circuit folding [8], which does not make this distinction. Importantly, using the proper inverse is relevant even for evolutions where noise is likely to be time-independent.

FIG. 13A shows that the adapted coefficients a_{Adap,m}^{(M)} outperform Taylor mitigation. This proves that, beyond the limit of weak noise, QEM using the technique of the present disclosure can be substantially improved by adapting it to the noise intensity. Although it can also be seen that in this experiment the noise-free survival probability is almost fully recovered, the inventors emphasize that Eq. (15) only includes the first Magnus term in the solution of the noisy dynamics that produces [symbol] . In cases where the noise is even stronger, or when very high accuracy is needed, the higher-order Magnus terms cannot be ignored. This aspect is missing in the circuit folding analysis. Further below, the inventors present a numerical example that illustrates a situation where neglecting higher-order Magnus terms limits the accuracy of QEM.

Due to experimental limitations, it was not possible to implement the 10-swap circuit using CNOTs calibrated through the KIK method. Specifically, the inventors could not guarantee that calibration circuits and error mitigation circuits would run sequentially, and without the interference of intrinsic (noncontrollable) calibrations from the processor. Moreover, this demonstration requires that all the parameters of the gate are calibrated using the KIK method, and not just the cross resonance amplitude. However, the inventors numerically verified that coherent errors vanish for a gate calibrated using KIK QEM, to the point that randomized compiling is no longer needed, as will be described in detail further below.

In the following, the distribution of the different circuits for this experiment is described in more detail. As in the previous case (i.e., CNOT calibration experiment), any of the circuits [symbol] ( [symbol] )^{m} was preceded by one of the four rotation operations applied on the state |00 [symbol] . For 0≤m≤3, a circuit [symbol] ( [symbol] )^{m} is acompanied by a rotation operation and a RC operation chosen at random from Table 1. The inventors repeated four times each possible rotation, which results in a total of 16 circuits per each value of m, involving 16 (not necessarily different) RC realizations. Keeping in mind that the maximum number of shots for the IBM Quito device is 20000, the total number of shots used for each circuit [symbol] ( [symbol] )^{m} was 16×20000=320000. For readout mitigation, the circuits that prepare the computational states were repeated three times. Therefore, 3×20000=60000 shots were employed to estimate each probability distribution {p(l|k)}ₗ.

Also considered here are the error mitigation curves for initial states |01 [symbol] , |10 [symbol] , and |11 [symbol] , which complement the curves shown in FIG. 13A. FIGS. 14A to 14C show, respectively, the error-mitigated survival probability for the ten-swap experiment, for initial states |01 [symbol] , |10 [symbol] , and |11 [symbol] . The ideal survival probability is 1 (dashed red line). Green and orange curves show QEM adaptive to the noise intensity, and the blue curve stands for mitigation assuming weak noise (Taylor mitigation). The thin colored areas connect small experimental error bars. As in the case of the state |00 [symbol] , it can be seen that adaptive mitigation with the function g(μ)=μ² leads to the best results.

It should also be noted that the slightly worse results corresponding to the state |11 [symbol] may be due to several experimental factors. Namely, imperfect averaging of the initial state (see Eq. (119)), drifts in gate parameters that characterize the single-qubit gates used for RC, and drifts in the measurement matrix M. However, for the present experiment, sufficient information is lacking for determining the most dominant factor.

In order to study the effect of coherent errors in the ten-swap circuit, the inventors executed an additional experiment on the IBM processor Quito. As in the case of FIG. 14C, the quantity measured was the survival probability for the system to remain in the initial state |11 [symbol] .

FIGS. 15A and 15B show the effect of unmitigated coherent errors on the error-mitigated survival probability in the ten-swap experiment. The initial state is |11 [symbol] and the ideal survival probability is 1 (dashed black lines). The thin colored areas connect small experimental error bars. In all the cases, the curves are obtained by applying adaptive mitigation with g(μ)=μ², at the level of single initial rotations (FIG. 15A) or single RC realizations (FIG. 15B). Coherent errors are manifested in FIG. 15A by the significant separation between different QEM curves, which correspond to different initial rotations. Furthermore, FIG. 15B shows how the application of RC (blue curve) produces substantially more accurate QEM, for all 1≤M≤3. It is also worth stressing that in the absence of KIK QEM the enhancement provided by RC disappears, as evidenced by the matching of the blue and orange curves at M=0.

Each curve in FIG. 15A shows the survival probability for a given rotation operation, obtained by averaging over the associated RC realizations.

Coherent errors are manifested in FIG. 15A by the significant separation between different QEM curves, which correspond to different initial rotations. Furthermore, FIG. 15B shows how the application of RC (blue curve) produces substantially more accurate QEM, for all 1≤M≤3. It is also worth stressing that in the absence of KIK QEM the enhancement provided by RC disappears, as evidenced by the matching of the blue and orange curves at M=0.

Each curve in FIG. 15A shows the survival probability for a given rotation operation, obtained by averaging over the associated RC realizations. If the subscript r is used to label any of the four possible initial rotations, and iᵣ to label RC realizations that acompany the rotation r, for Mth order mitigation, the corresponding survival probability is given by

$${〈 O 〉}_{M , r} = {\sum }_{m = 0}^{M} {a}_{Adap , m}^{( M )} ( {μ}^{2} ) {〈 O 〉}_{m , r} , \qquad ( 119 )$$

$$where O = ρ = \vert 00 〉 〈 00 \vert and$$

$${〈 O 〉}_{m , r} = \frac{1}{4} {\sum }_{{i}_{r} = 1}^{4} {〈 O 〉}_{m , {i}_{r}} = \frac{1}{4} {\sum }_{{i}_{r} = 1}^{4} {\sum }_{k} {p}_{k}^{( m , {i}_{r} )} {O}_{k} . \qquad ( 120 )$$

Once again, the calculation of the corresponding variances takes into account the independency of different RC realizations for a given rotation.

As compared to FIG. 14C, the blue curve in FIG. 15B features a performance more consistent with that observed in FIGS. 14A and 14B. This provides strong evidence that the modest performance observed in FIG. 14C is not intrinsic to the state |11 [symbol] , but possibly related to experimental factors already mentioned. We also remark that the orange curve in FIG. 15B is obtained by omitting the application of RC in any of the four repetitions of each initial rotation operation. The construction of both curves in FIG. 15B involves the same number of shots per KIK circuit, as per Table 2.

In the following, a simulation of a noisy calibration of a CNOT gate conducted by the inventors using the KIK method is presented to complement the CNOT calibration experiment described above. In other words, the same calibration process described above is simulated.

The ideal CNOT gate is simulated through the unitary evolution

$$U = {R}_{Z}^{( 0 )} ( - π / 2 ) {e}^{- i \frac{θ}{2} {H}_{CR}} {R}_{X}^{( 1 )} ( - π / 2 ) , \qquad ( 121 )$$

with the cross resonance interaction H_{CR}=Z⊗X, and the rotations

$${R}_{Z}^{( 0 )} ( - π / 2 ) = {e}^{i \frac{π}{4} Z} and {R}_{X}^{( 1 )} ( - π / 2 ) = {e}^{i \frac{π}{4} X}$$

acting on the target qubit and the control qubit, respectively. The angle θ depends on the strength and the duration of the pulse used to generate the cross resonance interaction. An ideal (noise-free) CNOT gate corresponds to the angle θ=π/2.

For the effect of noise, the following dissipator is considered

$$ℒ = ξ {\sum }_{i = 1}^{2} {γ}_{i} [ {A}_{i} ⊗ {A}_{i}^{*} - \frac{1}{2} {A}_{i}^{†} {A}_{i} ⊗ I - \frac{1}{2} I ⊗ {( {A}_{i}^{†} {A}_{i} )}^{T} ] , \qquad ( 122 )$$

$${A}_{1} = Z , \qquad ( 123 )$$

$${A}_{2} = ( \begin{matrix}0 & 1 \\ 0 & 0\end{matrix} ) , \qquad ( 124 )$$

where γ₁=1 and γ₂= 1/10. FIGS. 16A-16B and FIGS. 17A-17B show, respectively, the calibration curves for ξ= 2/100) and ξ= 1/100. Since the action of noise produces an imperfect CNOT gate, the angle θ obtained under a noisy calibration is in general different from π/2. This angle is expressed as θ=A_{θ}(π/2), and the “angle amplitude” A_{θ} is taken as the parameter for calibration.

As in the experimental case, the initial state and observable used for calibration are

$$\frac{1}{\sqrt{2}} ( \vert 0 〉 + \vert 1 〉 ) ⊗ \vert 0 〉 and {Y}_{1} = I ⊗ Y ,$$

respectively. Furthermore, the target circuit consists of a sequence of 11 CNOTs, in order to increase the sensitivity of [symbol] Y₁ [symbol] to variations of A_{θ}. Therefore, the noisy target circuit and its inverse are given by

$$𝒦 = {( {e}^{- i \frac{π}{2} {A}_{θ} {ℋ}_{CR} + ℒ} )}^{11} , \qquad ( 125 )$$

$${𝒦}_{I} = {( {e}^{i \frac{π}{2} {A}_{θ} {ℋ}_{CR} + ℒ} )}^{11} , \qquad ( 126 )$$

where [symbol] _{CR} is the Liouville space representation of H_{CR}.

The amplitudes A_{θ} obtained for error mitigation orders 0≤M≤4 are given in Table 3. Due to the small values of the noise strength ξ, the inventors apply Taylor mitigation with the coefficients a_{Tay,m}^{(M)}. Table 3, shows that A_{θ} tends to one as M increases. This reflects the fact that higher mitigation orders produce an evolution [symbol] _{KIK}^{(M)} closer to the ideal CNOT gate, and therefore the resulting calibrated angle θ also approaches its noise-free value θ=π/2.

TABLE 3

| | M (mitigation order) | | | | |
|---|---|---|---|---|---|
| | 0 | 1 | 2 | 3 | 4 |
| A_{θ} for ξ = | 0.991671 | 0.996210 | 0.998235 | 0.999181 | 0.999631 |
| 2/100 | | | | | |
| A_{θ} for ξ = | 0.995830 | 0.998836 | 0.999673 | 0.999909 | 0.999977 |
| 1/100 | | | | | |

To test the calibrated gate, the inventors simulate the average gate fidelity after applying Mth order Taylor mitigation to the noisy evolution

$${𝒦}_{CNOT} = {e}^{- i \frac{{θ}_{M}}{2} {ℋ}_{CR} + ℒ} , \qquad ( 127 )$$

where θ_{M} is the angle calibrated via Mth order mitigation. In other words, the same order of mitigation is used for the calibration of the CNOT and for the evaluation of its average fidelity. This strategy is consistent with the idea that a calibration assisted by QEM is not useful if the gate is tested by applying a lower degree of QEM. For example, in the extreme case when the fidelity test is performed on the unmitigated evolution of Eq. (121), it does not make sense to consider an angle θ_{M} different from the angle that a direct (unmitigated) calibration of [symbol] produces.

The average gate fidelity between a quantum channel Λ and a unitary evolution U is defined by

$$F ( Λ , U ) = \int d ψ 〈 ψ \vert {U}^{†} Λ ( \vert ψ 〉 〈 ψ \vert ) U \vert ψ 〉 , \qquad ( 128 )$$

where the integral is taken over all the pure states |ψ [symbol] with respect to the Haar measure. Here, Λ(|ψ [symbol] ψ|) denotes the state obtained by applying Λ on |ψ [symbol] ψ|. For quantum channels acting on N qubits, the fidelity of Eq. (128) can be computed by using the Pauli transfer matrices of Λ and U. The Pauli transfer matrix R_{Λ} for a general quantum channel Λ has elements

$${( {R}_{Λ} )}_{ij} = \frac{1}{d} Tr [ {P}_{i} Λ ( {P}_{j} ) ] , \qquad ( 129 )$$

where Pᵢ, Pⱼ∈{I, X, Y, Z}^{⊗N} are Pauli operators and d=2^{N} is the dimension of the Hilbert space.

In this way, the fidelities F_{M} are calculated as

$$F ( Λ , U ) = \frac{Tr ( {R}_{Λ}^{- 1} {R}_{U} ) + d}{d ( d + 1 )} , \qquad ( 130 )$$

with

$$U = {e}^{- i \frac{θ}{2} {H}_{CR}}$$

and the channel Λ corresponding to Mth order mitigation,

$${𝒰}_{KIK}^{( M )} = {\sum }_{m = 0}^{M} {a}_{Tay , m}^{( M )} {{𝒦}_{CNOT} ( {𝒦}_{I , CNOT} {𝒦}_{CNOT} )}^{m} , \qquad ( 131 )$$

$${𝒦}_{I , CNOT} = {e}^{i \frac{{θ}_{M}}{2} {ℋ}_{CR} + ℒ} . \qquad ( 132 )$$

Using the Liouville space formalism, the matrix elements of R_{Λ} and R_{U} are given by

$${( {R}_{Λ} )}_{ij} = \frac{1}{d} 〈 {P}_{i} \vert {𝒰}_{KIK}^{( M )} \vert {P}_{j} 〉 , \qquad ( 133 )$$

$${( {R}_{U} )}_{ij} = \frac{1}{d} 〈 {P}_{i} \vert 𝒰 \vert {P}_{j} 〉 , \qquad ( 134 )$$

where [symbol] =U⊗U* and |Pⱼ [symbol] is the vector representation of Pⱼ. It is noted that different values of M in Eq. (133) correspond to different rows in Tables 4 and 5. On the other hand, F₀ is computed by replacing [symbol] _{CNOT} and [symbol] _{I,CNOT} in Eq. (119), by

$${e}^{- i \frac{{θ}_{0}}{2} {ℋ}_{CR} + ℒ} and {e}^{i \frac{{θ}_{0}}{2} {ℋ}_{CR} + ℒ} ,$$

respectively.

Tables 4 and 5 show the simulated fidelities for ξ= 2/100 and ξ= 1/100, respectively. The second column (F₀) in these tables gives the error-mitigated fidelities without a KIK-based calibration, i.e. when θ_{M}=θ₀. The third column (F_{M}) contains the fidelity values simulated by following the M-order mitigation strategy previously described. Finally, fidelities obtained without KIK-based calibration and RC integrated into the KIK mitigation are presented in the fourth column. Both tables show that KIK-based calibration and RC yield similar fidelities, which surpass the values obtained when none of these methods is employed. The effect of these two approaches is different though. On the one hand, RC provides an a posteriori mitigation of the coherent error that characterizes the biased angle θ₀. On the other hand, it can be stated that the angle θ_{M} calibrated with the KIK method features an a priori reduction of the bias, which is suited to the application of Mth order mitigation.

TABLE 4

| M | | | |
|---|---|---|---|
| (mitigation | | | |
| order) | F₀ | F_{M} | F₀ with RC |
| 0 | 0.967325 | 0.967325 | 0.967325 |
| 1 | 0.997270 | 0.997298 | 0.997388 |
| 2 | 0.999692 | 0.999725 | 0.999743 |
| 3 | 0.999934 | 0.999968 | 0.999972 |
| 4 | 0.999961 | 0.999996 | 0.999997 |

TABLE 5

| M | | | |
|---|---|---|---|
| (mitigation | | | |
| order) | F₀ | F_{M} | F₀ with RC |
| 0 | 0.983434 | 0.983434 | 0.983434 |
| 1 | 0.999288 | 0.999296 | 0.999320 |
| 2 | 0.999954 | 0.999963 | 0.999965 |
| 3 | 0.999989 | 0.999998 | 0.999998 |
| 4 | 0.999991 | 1.000000 | 1.000000 |

In the following, a numerical example is considered where the accuracy of QEM using the KIK method saturates at approximately the mitigation order M=4. The accuracy is quantified by the relative error:

$$\frac{{ε}_{KIK}^{( M )}}{\vert 〈 A \vert 𝒰 \vert ρ 〉 \vert} = \frac{\vert 〈 A \vert 𝒰 \vert ρ 〉 - 〈 A \vert {𝒰}_{KIK}^{( M )} \vert ρ 〉 \vert}{\vert 〈 A \vert 𝒰 \vert ρ 〉 \vert} , \qquad ( 135 )$$

where ε_{KIK}^{(M)}=| [symbol] A| [symbol] |ρ [symbol] − [symbol] A| [symbol] _{KIK}^{(M)}|ρ [symbol] | is the difference between the ideal expectation value [symbol] A| [symbol] |ρ [symbol] , and the error-mitigated expectation value [symbol] A| [symbol] _{KIK}^{(M)}|ρ [symbol] , for the observable A and the initial state ρ. In the present example, the error (Eq. (139)) first decreases as a function of M, attaining a value approximately constant for M≥4 as shown in FIG. 18. The inventors apply QEM with Taylor mitigation, characterized by:
[symbol] _{KIK}^{(M)}=Σₘ₌₀^{M}a_{Tay,}^{(M)} [symbol] ( [symbol] )^{m}, and the coefficients a_{Tay,m}^{(M)} in Eq. (42) The present example refers to a four-qubit system characterized by the time-independent Hamiltonian:

$$H = X ⊗ X ⊗ I ⊗ I + I ⊗ X ⊗ X ⊗ I + I ⊗ I ⊗ X ⊗ X , \qquad ( 136 )$$

$$ℋ = H ⊗ I - I ⊗ {H}^{T} , \qquad ( 137 )$$

where

$$X = ( \begin{matrix}0 & 1 \\ 1 & 0\end{matrix} ) and I = ( \begin{matrix}1 & 0 \\ 0 & 1\end{matrix} ) .$$

Here, [symbol] is the Liouville space representation of H, taking into account Eq. (5). Each qubit is subjected to spontaneous emission, which can be described via a GKLS (Gorini-KossakowskiSudarshan-Lindblad) master equation with dissipator \hat{L} such that:

$$\hat{L} [ ρ ] = {\sum }_{k = 1}^{4} {ξ}_{k} ( {A}_{k} ρ {A}_{k}^{†} - \frac{1}{2} {A}_{k}^{†} {A}_{k} ρ - \frac{1}{2} ρ {A}_{k}^{†} {A}_{k} ) \qquad ( 138 )$$

$${A}_{1} = ( \begin{matrix}0 & 1 \\ 0 & 0\end{matrix} ) ⊗ I ⊗ I ⊗ I \qquad ( 139 )$$

$${A}_{2} = I ⊗ ( \begin{matrix}0 & 1 \\ 0 & 0\end{matrix} ) ⊗ I ⊗ I \qquad ( 140 )$$

$${A}_{3} = I ⊗ I ⊗ ( \begin{matrix}0 & 1 \\ 0 & 0\end{matrix} ) ⊗ I \qquad ( 141 )$$

$${A}_{4} = I ⊗ I ⊗ I ⊗ ( \begin{matrix}0 & 1 \\ 0 & 0\end{matrix} ) \qquad ( 142 )$$

The inventors assume that all the qubits are affected by the same relaxation rate ξ=ξₖ=0.02, for 1≤k≤4. Using the vectorization rule (cf. Eq. (5)), in Liouville space the dissipator of Eq. (138) takes the form:

$$ℒ = ξ {\sum }_{k = 1}^{4} ( {A}_{k} ⊗ {A}_{k}^{*} - \frac{1}{2} {A}_{k}^{†} {A}_{k} ⊗ I - \frac{1}{2} I ⊗ {A}_{k}^{†} {A}_{k} ) , \qquad ( 143 )$$

where A*ₖ denotes the complex conjugate of Aₖ.

Assuming a time unit T=1 for the evolution time, it is shown that:

$$𝒰 = {e}^{- i ℋ} , \qquad ( 144 )$$

$$𝒦 = {e}^{- i ℋ + ℒ} , \qquad ( 145 )$$

$${𝒦}_{I} = {e}^{i ℋ + ℒ} \qquad ( 146 )$$

The total system starts in the ground state

$$ρ = {( \begin{matrix}1 & 0 \\ 0 & 0\end{matrix} )}^{⊗ 4} ,$$

whose vector form is given by:

$$\vert ρ 〉 = {( 1 , 0 , 0 , … , 0 )}^{T} .$$

The observable A is the projector onto the ground state, and thus:

$$〈 A \vert = ( 1 , 0 , 0 , … , 0 ) .$$

The saturation of the relative error can be understood as being a consequence of the approximations involved in the derivation of the KIK formula. More specifically, it is related to the fact that in the derivation of Eq. (26) the inventors have discarded higher-order Magnus terms Ω_{n≥2}. Nevertheless, it is worth noting that, according to FIG. 18, a relative error as small as ˜10⁻⁴ can already be achieved with a mitigation order M=3. When the initial error is smaller (i.e., when ξ is smaller), the improvement is even more substantial.

A complete assessment of a QEM technique requires establishing bounds for the error incurred in the estimation of expectation values. Furthermore, these bounds should be applicable to general observables A and circuits [symbol] of arbitrary size. The goal of the following description is to derive such bounds, in the case of QEM using the KIK method. In particular, some technical results and physically realistic assumptions will be described, which will be used for the derivation of the bounds of the present technique.

In the following, the lower bound on the smallest eigenvalue of [symbol] is estimated.

Assuming that [symbol] is diagonalizable, i.e. [symbol] =Σₖλₖ|k)(k|, where |k) and (k| denote respectively right and left eigenvectors (note that in general one may have (k|≠|k)†), the following bound is obtained:

$${min}_{k} {λ}_{k} \geq {e}^{- 2 {\int }_{0}^{T} ‖ ℒ ( t ) ‖ dt} . \qquad ( 147 )$$

Recall that [symbol] (t) is the dissipator introduced in Eq. (10), and T is the evolution time for [symbol] . The norm ∥*∥ in Eq. (147) is the spectral norm.

First, the equivalent expression of Eq. (20) is considered,

$$\frac{d}{dt} {\tilde{𝒦}}_{int} ( t ) = {\tilde{ℒ}}_{int} ( t ) {\tilde{𝒦}}_{int} ( t ) , \qquad ( 148 )$$

with the interaction-picture evolution [symbol] ᵢₙₜ(t)= [symbol] †(t) [symbol] (t), and dissipator [symbol] ᵢₙₜ(t)= [symbol] †(t) [symbol] (t) [symbol] (t). The inverse evolution [symbol] ᵢₙₜ⁻¹(t)= [symbol] ⁻¹(t) [symbol] (t) satisfies the equation:

$$\frac{d}{dt} {\tilde{𝒦}}_{int}^{- 1} ( t ) = - {\tilde{ℒ}}_{int} ( T - t ) {\tilde{𝒦}}_{int}^{- 1} ( t ) , \qquad ( 149 )$$

which will be used in the derivation of Eq. (147). Here, it is important to remark that [symbol] ᵢₙₜ⁻¹(t) is the mathematical inverse of [symbol] ᵢₙₜ(t) and must not be confused with [symbol] .

By taking the spectral norm at both sides of Eq. (149), one gets

$$‖ \frac{d}{dt} {\tilde{𝒦}}_{int}^{- 1} ( t ) ‖ = ‖ {\tilde{ℒ}}_{int} ( T - t ) {\tilde{𝒦}}_{int}^{- 1} ( t ) ‖ \leq ‖ \tilde{ℒ} ( T - t ) ‖ ‖ {\tilde{𝒦}}^{- 1} ( t ) ‖ , \qquad ( 150 )$$

where the inequality follows from the sub-multiplicativity and unitary invariance of the spectral norm. On the other hand, one can apply the reverse triangle inequality ∥x−y∥≥|∥x∥−∥y∥| to obtain:

$$\begin{matrix}‖ \frac{d}{dt} {\tilde{𝒦}}_{int}^{- 1} ( t ) ‖ = {lim}_{Δ t \to 0} ‖ \frac{{\tilde{𝒦}}_{int}^{- 1} ( t + Δ t ) - {\tilde{𝒦}}_{int}^{- 1} ( t )}{Δ t} ‖ \geq \\ {lim}_{Δ t \to 0} \vert \frac{‖ {\tilde{𝒦}}_{int}^{- 1} ( t + Δ t ) ‖ - ‖ {\tilde{𝒦}}_{int}^{- 1} ( t ) ‖}{Δ t} \vert \\ = \frac{d}{dt} ‖ {\tilde{𝒦}}_{int}^{- 1} ( t ) ‖ = \frac{d}{dt} ‖ {\tilde{𝒦}}^{- 1} ( t ) ‖ .\end{matrix} \qquad ( 151 )$$

By combining this result with Eq. (150), the following inequality emerges:

$$\frac{d}{dt} ‖ {\tilde{𝒦}}^{- 1} ( t ) ‖ \leq ‖ \tilde{ℒ} ( T - t ) ‖ ‖ {\tilde{𝒦}}^{- 1} ( t ) ‖ , \qquad ( 152 )$$

which upon integration yields

$$‖ {\tilde{𝒦}}^{- 1} ( T ) ‖ \leq {e}^{{\int }_{0}^{T} ‖ \tilde{ℒ} ( T - t ) ‖ dt} . \qquad ( 153 )$$

Taking into account that [symbol] (T)= [symbol] and [symbol] (T−t)= [symbol] (T−t) for 0≤t≤T (cf. Eq. (17)), the change of variable t′=T−t straightforwardly leads to

$$‖ {𝒦}^{- 1} ‖ \leq {e}^{{\int }_{0}^{T} ‖ ℒ ( t ) ‖ dt} \qquad ( 154 )$$

Consider now the singular value decomposition (SVD) [symbol] = [symbol] , where [symbol] is a diagonal matrix with the singular values of [symbol] and [symbol] and [symbol] are unitary matrices. Then, the SVD of [symbol] ⁻¹ reads [symbol] † [symbol] ⁻¹ [symbol] †, and the spectral norm (maximum singular value) of [symbol] ⁻¹ is given by ∥ [symbol] ⁻¹∥=1/sₘᵢₙ, where sₘᵢₙ is the minimum singular value of [symbol] . Accordingly, Eq. (154) can be rewritten as

$${s}_{m i n} \geq {e}^{- {\int }_{0}^{T} ‖ ℒ ( t ) ‖ dt} . \qquad ( 155 )$$

The singular values of [symbol] are the eigenvalues of ( [symbol] † [symbol] )^{1/2}, where [symbol] † is the Hermitian conjugate of [symbol] . If the evolution [symbol] coincides with [symbol] †, it follows that sₘᵢₙ is also the minimum eigenvalue of ( [symbol] † [symbol] )^{1/2}, or, equivalently, the minimum eigenvalue of [symbol] satisfies the inequality of Eq. (147). Hence, the last step in proving this inequality is to show that [symbol] = [symbol] †, under sound physical conditions. This is done in the following.

Suppose that the dissipator [symbol] (t) is Hermitian, i.e., [symbol] †(t)= [symbol] (t) for 0≤t≤T. Then, from the definition of the first-order Magnus term (22) it also follows that:

$${Ω}_{1}^{†} ( T ) = {Ω}_{1} ( T ) . \qquad ( 156 )$$

If one can prove that, up to first order in the Magnus expansion (where Ω(T) is approximated by Ω₁(T)),

$${𝒦}_{I} \approx {e}^{{Ω}_{1} ( T )} {𝒰}^{†} , \qquad ( 157 )$$

then, Eqs. (23) and (157) imply that [symbol] = [symbol] † within this approximation.

Before discussing under which circumstances the property [symbol] †(t)= [symbol] (t) is satisfied, Eq. (157) will be derived first. The inventors start by writing the formal solution to the inverse evolution [symbol] . Denoting the corresponding Magnus expansion by Ω₁, and assuming for simplicity that [symbol] _{I}(t) acts on the time interval (0,T) (as opposed to the interval (T, 2T), used in the derivation of the KIK formula), Eq. (23) leads to:

$$\begin{matrix}{𝒦}_{I} = {𝒰}^{†} {e}^{{Ω}_{I} ( T )} \\ \approx {𝒰}^{†} {e}^{{Ω}_{I , 1} ( T )}\end{matrix} , \qquad ( 158 )$$

with the first-order Magnus term

$$\begin{matrix}{Ω}_{I , 1} ( T ) = {\int }_{0}^{T} {ℒ}_{i n t} ( t ) dt \\ = {\int }_{0}^{T} 𝒰 ( t ) ℒ ( T - t ) {𝒰}^{†} ( t ) dt\end{matrix} \qquad ( 159 )$$

Writing [symbol] (t) as [symbol] (t)= [symbol] (T) [symbol] †(T−t), and performing the change of variable t′=T−t in the integral, one obtains:

$$\begin{matrix}{Ω}_{I , 1} ( T ) = - 𝒰 ( T ) ( {\int }_{T}^{0} {𝒰}^{†} ( {t}^{′} ) ℒ ( {t}^{′} ) 𝒰 ( {t}^{′} ) {dt}^{′} ) {𝒰}^{†} ( T ) \\ = 𝒰 ( {\int }_{0}^{T} {𝒰}^{†} ( {t}^{′} ) ℒ ( {t}^{′} ) 𝒰 ( {t}^{′} ) {dt}^{′} ) {𝒰}^{†} \\ = {𝒰Ω}_{1} ( T ) {𝒰}^{†}\end{matrix} \qquad ( 160 )$$

Note that the simplified notation [symbol] (T)= [symbol] was also used. In this way, the inventors conclude that:

$$\begin{matrix}{𝒦}_{I} \approx {𝒰}^{†} {e}^{{𝒰Ω}_{1} ( T ) {𝒰}^{†}} \\ = {e}^{{Ω}_{1} ( T )} {𝒰}^{†}\end{matrix} . \qquad ( 161 )$$

Now, coming back to the subject of the Hermiticity of [symbol] (t). A sufficient condition to have this property is that:

$$ℒ ( t ) = {\sum }_{\vec{k}} {α}_{\vec{k}} ( t ) ( {P}_{\vec{k}} ⊗ {P}_{\vec{k}}^{T} - 𝒥 ) , \qquad ( 162 )$$

where P_{\vec{k}}=σₖ_{₁}⁽¹⁾⊗σₖ_{₂}⁽²⁾⊗ . . . ⊗σₖ_{ₙ}⁽ⁿ⁾⊗ . . . ⊗σₖ_{_{N}}^{(N)} is a Pauli operator acting on N qubits, σₖ_{ₙ}⁽ⁿ⁾∈{I, X, Y, Z} is a Pauli matrix acting on the nth qubit, and the time-dependent coefficients α_{\vec{k}}(t) are real. It is noted that a time-independent version of this dissipator was recently considered in Ref. [29]. For a given state ρ, one can check by direct application of the identity of Eq. (5) that Eq. (162) is the Liouville space representation of the superoperator \hat{L}(t) such that:

$$\hat{L} ( t ) [ ρ ] = {\sum }_{\vec{k}} {α}_{\vec{k}} ( t ) ( {P}_{\vec{k}} ρ {P}_{\vec{k}} - ρ ) . \qquad ( 163 )$$

The noise model of Ref. [29] relies on a time-independent \hat{L}(t)=\hat{L}, characterized by time-independent coefficients α_{\vec{k}}(t)=α_{\vec{k}}. In addition, α_{\vec{k}}≠0 only if the index \vec{k}={k₁, k₂, . . . , k_{N}} contains at most two components kₙ different from 1, which limits correlated errors to occur at most between pairs of qubits. On the other hand, the more general dissipator of Eq. (162) guarantees the condition [symbol] = [symbol] †. It should be noted that the time-dependent coefficients α_{\vec{k}}(t) in Eq. (162) can also be different from zero for arbitrary indices \vec{k}, thereby allowing for correlated errors between any number of qubits in the system.

In the following, first error bounds for adapted mitigation and Taylor mitigation with pulse-inverse are derived. As described above, the error-mitigated evolution [symbol] _{KIK}= [symbol] ( [symbol] )^{-1/2} is implemented through M-order approximations of the form [symbol] _{KIK}^{(M)}=Σₘ₌₀^{M}aₘ^{(M)} [symbol] ( [symbol] )^{m}. The goal here is to obtain an upper bound on the error:

$${ε}_{KIK}^{( M )} = \vert 〈 A \vert 𝒰 \vert ρ 〉 - 〈 A \vert {𝒰}_{KIK}^{( M )} \vert ρ 〉 \vert , \qquad ( 164 )$$

which quantifies how much the ideal expectation value [symbol] A| [symbol] |ρ [symbol] deviates from the error-mitigated expectation value [symbol] A| [symbol] _{KIK}^{(M)}|ρ [symbol] . Here, A is an arbitrary observable and ρ is an arbitrary initial state.

The inventors start by deriving a bound for the error associated with adapted mitigation, with the coefficients a_{Adap,m}^{(M)}[g(μ)] evaluated at g(μ)=μ, and 1≤M≤3. Further below, another bound will be derived, that in spite of being looser has the advantage of being independent of μ, and is also valid for both adapted mitigation and Taylor mitigation.

Using the conventional approximations of the disclosure, [symbol] ≈ [symbol] e^{Ω}^{₁} and [symbol] ≈e^{2Ω}^{₁}, [symbol] _{KIK}^{(M)} can be written as:

$$\begin{matrix}{𝒰}_{KIK}^{( M )} \approx 𝒰 {\sum }_{m = 0}^{M} {a}_{Adap , m}^{( M )} ( μ ) {e}^{( 2 m + 1 ) {Ω}_{1}} \\ \approx 𝒰 {\sum }_{m = 0}^{M} {a}_{Adap , m}^{( M )} ( μ ) {( {𝒦}_{I} 𝒦 )}^{m + 1 / 2}\end{matrix} . \qquad ( 165 )$$

$$\begin{matrix}{ε}_{KIK}^{( M )} = \vert 〈 A \vert ( 𝒰 - {𝒰}_{KIK}^{( M )} ) \vert ρ 〉 \vert \\ \leq \sqrt{〈 A \vert A 〉} \sqrt{〈 ρ \vert ρ 〉} ‖ 𝒰 ( 𝒥 - {\sum }_{m = 0}^{M} {a}_{Adap , m}^{( M )} ( μ ) {( {𝒦}_{I} 𝒦 )}^{m + 1 / 2} ) ‖ \\ = \sqrt{〈 A \vert A 〉} ‖ ( 𝒥 - {\sum }_{m = 0}^{M} {a}_{Adap , m}^{( M )} ( μ ) {( {𝒦}_{I} 𝒦 )}^{m + 1 / 2} ) ‖\end{matrix} , \qquad ( 166 )$$

### Therefore,

$$\begin{matrix}{ε}_{KIK}^{( M )} = \vert 〈 A \vert ( 𝒰 - {𝒰}_{KIK}^{( M )} ) \vert ρ 〉 \vert \leq \\ \sqrt{〈 A \vert A 〉} \sqrt{〈 ρ \vert ρ 〉} ‖ 𝒰 ( 𝒥 - {\sum }_{m = 0}^{M} {a}_{Adap , m}^{( M )} ( μ ) {( {𝒦}_{I} 𝒦 )}^{m + 1 / 2} ) ‖ \\ = \sqrt{〈 A \vert A 〉} ‖ ( 𝒥 - {\sum }_{m = 0}^{M} {a}_{Adap , m}^{( M )} ( μ ) {( {𝒦}_{I} 𝒦 )}^{m + 1 / 2} ) ‖\end{matrix} , \qquad ( 166 )$$

where the first inequality follows from the definition in Eq. (165) and the definition of the spectral norm ∥*∥. In the last line, the unitary invariance of this norm is used. Moreover, an initial pure state ρ is assumed, which implies [symbol] ρ|ρ [symbol] =1. Assuming as before that [symbol] (t) satisfies Eq. (162), and hence [symbol] = [symbol] †, provides that the operator [symbol] is Hermitian. Since this implies that [symbol] −Σₘ₌₀^{M}a_{Adap,m}^{(M)}(μ)( [symbol] )^{m+1/2} is also Hermitian, the corresponding spectral norm is simply the absolute value of its maximum eigenvalue. In this way, Eq. (166) leads to:

$${ε}_{KIK}^{( M )} \leq \sqrt{〈 A \vert A 〉} {max}_{k} \vert 1 - {\sum }_{m = 0}^{M} {a}_{Adap , m}^{( M )} ( μ ) {( {λ}_{k} )}^{m + 1 / 2} \vert , \qquad ( 167 )$$

where again the eigenvalues of [symbol] =Σₖλₖ|k [symbol] k| are denoted by {λₖ}.

Next, another upper bound to ε_{KIK}^{(M)} is established for mitigation orders M=1, 2, 3, by looking at the behavior of the function f_{M}(μ, λ):=|1−Σₘ₌₀^{M}a_{Adap, m}^{(M)}(μ)(λ)^{m+1/2}| in the plots shown in FIGS. 19A to 19F. The streamlines depict the gradient of f_{M}(μ, λ). In particular, it can be seen that for λ≤μ the functions f_{M}(μ, λ) are monotonically decreasing with respect to λ, and monotonically increasing with respect to μ. The plots of FIGS. 19D, 19E and 19F are color density plots of f_{M}(μ, μ)−f_{M}(μ, λ) (with 1≤M≤3 increasing from left to right), for λ≥μ, and show that in this interval f_{M}(μ, μ)≥f_{M}(μ, λ).

The purpose of the inventors is to show that maxₖf_{M}(μ, λₖ)≤f_{M}(μ, [symbol] ) Keeping in mind Eq. (167), this leads to the bound

$${ε}_{KIK}^{( M )} \leq \sqrt{〈 A \vert A 〉} \vert 1 - {\sum }_{m = 0}^{M} {a}_{Adap , m}^{( M )} ( μ ) {( {e}^{- {2}_{0}^{T} ‖ ℒ ( t ) ‖ dt} )}^{m + 1 / 2} \vert , \\ for M = 1 , 2 , 3 . \qquad ( 168 )$$

The inequality maxₖf_{M}(μ, λₖ)≤f_{M}(μ, [symbol] ) is stated by considering two separate cases. Namely, when the eigenvalue λₖ that maximizes f_{M}(μ, λₖ) is smaller than μ, and when it is larger than μ.

For the first case reference is made to the plots shown in FIGS. 19A to 19C. These plots show that if λ≤μ the function f_{M}(μ, λₖ) is monotonically decreasing with respect to λ. Therefore, from minₖλₖ≥ [symbol] (cf. Eq. (139), and

$$μ = 〈 ρ \vert {𝒦}_{I} 𝒦 \vert ρ 〉 = {\sum }_{k} {λ}_{k} {\vert 〈 k \vert ρ 〉 \vert}^{2} \geq {min}_{k} {λ}_{k} , \qquad ( 169 )$$

it is concluded that

$${f}_{M} ( μ , {λ}_{k} ) \leq {f}_{M} ( μ , {min}_{k} {λ}_{k} ) \leq {f}_{M} ( μ , {e}^{- {2}_{0}^{T} ‖ ℒ ( t ) ‖ dt} ) , \qquad ( 170 )$$

for any eigenvalue λₖ such that λ≤μ.

If λ≥μ, the plots shown in FIGS. 21D to 21F show that f_{M}(μ, λ)≤f_{M}(μ, μ). Since f_{M}(μ, μ)≤f_{M}(μ, minₖλₖ), according to Eq. (169) and the plots of FIGS. 19A to 19C, it follows that f_{M}(μ, λ)≤f_{M}(μ, μ)≤f_{M}(μ, minₖλₖ) when λ≥μ. Therefore, the inequalities of Eq. (170) also hold when λₖ≥μ. This implies that maxₖf_{M}(μ, λₖ)≤f_{M}( μ, [symbol] ) , because Eq. (170) is valid for any eigenvalue λₖ.

Although the bound of Eq. (168) is tighter than the bound of Eq. (171), computed below, it depends on the survival probability μ. In contrast, the bound of Eq. (171) only depends on ∫₀^{T}∥ [symbol] (t)∥dt. Since this quantity is the integral of the spectral norm of the dissipator [symbol] (t), over the time T consumed by the evolution [symbol] , it can be seen as a quantifier of the total error rate in the approach of the present disclosure. Hence, the bound of Eq. (171) has the advantage of being given only in terms of this error rate.

It is to be noted first that the plots of FIGS. 19A to 19C indicate the inequality f_{M}(μ, [symbol] )≤f_{M}(1, [symbol] ). By combining this with Eq. (170), the bound is obtained:

$$\begin{matrix}{ε}_{KIK}^{( M )} \leq \sqrt{〈 A \vert A 〉} {f}_{M} ( μ , {e}^{- 2 {\int }_{0}^{T} ‖ ℒ ( t ) ‖ dt} ) \\ \leq \sqrt{〈 A \vert A 〉} {f}_{M} ( 1 , {e}^{- 2 {\int }_{0}^{T} ‖ ℒ ( t ) ‖ dt} ) \\ = \sqrt{〈 A \vert A 〉} \vert 1 - {\sum }_{m = 0}^{M} {a}_{Adap , m}^{( M )} ( 1 ) {( {e}^{- 2 {\int }_{0}^{T} ‖ ℒ ( t ) ‖ dt} )}^{m + 1 / 2} \vert\end{matrix} , \\ for M = 1 , 2 , 3. \qquad ( 171 )$$

It will be shown now that this bound is also applicable to Taylor mitigation. For M arbitrary, that the following is fulfilled:

$$\begin{matrix}{𝒰}_{KIK}^{( M )} \approx 𝒰 {\sum }_{m = 0}^{M} {{a}_{Tay , m}^{( M )} ( {𝒦}_{I} 𝒦 )}^{m + 1 / 2} \\ {ε}_{KIK}^{( M )} = \vert 〈 A \vert ( 𝒰 - {𝒰}_{KIK}^{( M )} ) \vert ρ 〉 \vert \\ \leq \sqrt{〈 A \vert A 〉} ‖ 𝒰 ( 𝒥 - {\sum }_{m = 0}^{M} {{a}_{Tay , m}^{( M )} ( {𝒦}_{I} 𝒦 )}^{m + 1 / 2} ) ‖\end{matrix} . \qquad ( 172 )$$

If 1≤M≤3, a direct calculation allows one to corroborate that (cf. Eqs. (42) and (86)-(94)) a_{Tay, m}^{(M) =a}_{Adap ,m}^{(M)}(1). Therefore, in this case Eq. (172) can be rewritten as

$${ε}_{KIK}^{( M )} \leq \sqrt{〈 A \vert A 〉} ‖ 𝒰 ( 𝒥 - {\sum }_{m = 0}^{M} {a}_{Adap , m}^{( M )} ( 1 ) {( {𝒦}_{I} 𝒦 )}^{m + 1 / 2} ) ‖ . \qquad ( 173 )$$

Finally, it is not difficult to check that f_{M}(1, λ)=|1−Σₘ₌₀^{M}a_{Adap ,m}^{(M)}(1)(λ)^{m+1/2} is monotonically decreasing in λ, which leads to the inequalities:

$${f}_{M} ( 1 , {e}^{- 2 {\int }_{0}^{T} ‖ ℒ ( t ) ‖ dt} ) \geq {f}_{M} ( 1 , {min}_{k} {λ}_{k} ) \geq {f}_{M} ( 1 , {λ}_{k} ) . \qquad ( 174 )$$

From this result and Eq. (173), it follows that the bound (171) is also valid for Taylor mitigation.

In the following, another bound on ε_{KIK}^{(M)} is derived, applicable to Taylor error mitigation. While this bound is looser than Eq. (171), it holds for any M≥1 and not only for 1≤M≤3. To this end, the Taylor remainder is applied:

$${R}_{M} ( x ) = {\int }_{a}^{x} \frac{1}{M !} {( \frac{{d}^{M + 1} f}{{dx}^{M + 1}} )}_{x = t} {( x - t )}^{M} dt , \qquad ( 175 )$$

which gives the error R_{M}(x)=f(x)−P_{M}(x) when approximating a function f(x) with the M-degree Taylor polynomial:

$${P}_{M} ( x ) = {\sum }_{m = 0}^{M} \frac{1}{m !} {( \frac{{d}^{m} f}{{dx}^{m}} )}_{x = a} {( x - a )}^{m} . \qquad ( 176 )$$

In Taylor mitigation, the eigenvalues f(λ)=λ^{-1/2} of ( [symbol] )^{-1/2} are approximated using the Taylor polynomial

$${P}_{M} ( λ ) = {\sum }_{m = 0}^{M} \frac{1}{m !} {( \frac{( 2 m - 1 ) ! !}{{2}^{m}} {λ}^{- m - \frac{1}{2}} )}_{λ = 1} {( λ - 1 )}^{m} .$$

The corresponding Taylor remainder is:

$${R}_{M} ( λ ) = {\int }_{1}^{λ} \frac{1}{M !} \frac{( 2 M + 1 ) ! !}{{2}^{M + 1}} {{t}^{- M - \frac{3}{2}} ( λ - t )}^{M} dt . \qquad ( 177 )$$

The eigenvalues of the Hermitian operator [symbol] = [symbol] † [symbol] must satisfy λ≤1. Otherwise, many applications of the evolution [symbol] would lead to a non-physical operation, characterized by divergent eigenvalues. Taking this into account, the absolute value of R_{M}(λ) is upper bounded by

$$\begin{matrix}\vert {R}_{M} ( λ ) \vert \leq \frac{1}{M !} \frac{( 2 M + 1 ) ! !}{{2}^{M + 1}} {λ}^{- M - \frac{3}{2}} {\int }_{λ}^{1} \vert {( λ - t )}^{M} \vert dt \\ = \frac{1}{M !} \frac{( 2 M + 1 ) ! !}{{2}^{M + 1}} {λ}^{- M - \frac{3}{2}} {\int }_{λ}^{1} {( t - λ )}^{M} dt \\ = \frac{( 2 M + 1 ) ! !}{{2}^{M + 1} ( M + 1 ) !} {{λ}^{- M - \frac{3}{2}} ( 1 - λ )}^{M + 1}\end{matrix} . \qquad ( 178 )$$

Using the diagonal form [symbol] =Σₖλₖ|k [symbol] k|, the approximation Σₘ₌₀^{M}a_{Tay, m}^{(M)}( [symbol] )^{m} to the inverse ( [symbol] )^{-1/2} can be expressed as

$${\sum }_{m = 0}^{M} {{a}_{Tay , m}^{( M )} ( {𝒦}_{I} 𝒦 )}^{m} = {( {𝒦}_{I} 𝒦 )}^{- \frac{1}{2}} + {\sum }_{k} ( \pm \vert {R}_{M} ( {λ}_{k} ) \vert ) \vert k 〉 〈 k \vert \qquad ( 179 )$$

$$Therefore ,$$

$$\begin{matrix}{𝒰}_{KIK}^{( M )} = 𝒦 [ {\sum }_{m = 0}^{M} {{a}_{Tay , m}^{( M )} ( {𝒦}_{I} 𝒦 )}^{m} ] \\ = 𝒰 {( {𝒦}_{I} 𝒦 )}^{\frac{1}{2}} [ {( {𝒦}_{I} 𝒦 )}^{- \frac{1}{2}} + {\sum }_{k} ( \pm \vert {R}_{M} ( {λ}_{k} ) \vert ) \vert k 〉 〈 k \vert ] \\ = 𝒰 + {\sum }_{k} ( \pm {λ}_{k}^{\frac{1}{2}} \vert {R}_{M} ( {λ}_{k} ) \vert ) \vert k 〉 〈 k \vert\end{matrix} \qquad ( 180 )$$

where [symbol] is written as [symbol] = [symbol] ( [symbol] )^{1/2} in the second line, and ( [symbol] )^{1/2} is written as ( [symbol] )^{1/2} =Σₖλₖ^{1/2}|k [symbol] k| in the third line. Accordingly, for Taylor mitigation the following is fulfilled:

$$\begin{matrix}{ε}_{KIK}^{( M )} = \vert 〈 A \vert ( 𝒰 - {𝒰}_{KIK}^{( M )} ) \vert ρ 〉 \vert \\ \leq \frac{( 2 M + 1 ) ! !}{{2}^{M + 1} ( M + 1 ) !} \sqrt{〈 A \vert A 〉} ‖ {\sum }_{k} {( \frac{1}{{λ}_{k}} - 1 )}^{M + 1} \vert k 〉 〈 k \vert ‖ \\ = \frac{( 2 M + 1 ) ! !}{{2}^{M + 1} ( M + 1 ) !} \sqrt{〈 A \vert A 〉} {( \frac{1}{{min}_{k} {λ}_{k}} - 1 )}^{M + 1} \\ \leq \frac{( 2 M + 1 ) ! !}{{2}^{M + 1} ( M + 1 ) !} \sqrt{〈 A \vert A 〉} {( {e}^{2 {\int }_{0}^{T} ‖ ℒ ( t ) ‖ dt} - 1 )}^{M + 1}\end{matrix} \qquad ( 181 )$$

where it is assumed again [symbol] ρ|ρ [symbol] =1, and Eqs. (178) and (147) are respectively applied in the second line and the last line.

In the following n, the inventors take advantage of an important property of the coefficients a_{Adap ,m}^{(M)}(μ) and a_{Tay, m}^{(M)}, in order to further tighten the bounds of Eqs. (170), (155), and (165).

In the following, traceless observables and second (tighter) error bounds for adapted error mitigation and Taylor error mitigation are derived.

Given an arbitrary observable A, it is already known that the error-mitigated expectation value in the case of M th order mitigation is given by

$${〈 A 〉}_{mit} = 〈 A \vert {\sum }_{m = 0}^{M} {a}_{m}^{( M )} {𝒦 ( {𝒦}_{I} 𝒦 )}^{m} \vert ρ 〉 , \qquad ( 182 )$$

where aₘ^{(M)}=a_{Adap ,m}^{(M)}(μ) for adapted mitigation and aₘ^{(M)}=a_{Tay, m}^{(M)} for Taylor mitigation.

Now, it is shown that the error ε_{KIK}^{(M)} is invariant under a transformation A→A+bI, where I is the identity operator and b is a real number. This shifts the trace of A by the value bTr(I). Letting ε_{KIK}^{(M)}(b) denote the error corresponding to the observable A+bI, it follows that:

$$\begin{matrix}{ε}_{KIK}^{( M )} ( b ) = \vert 〈 A + bI \vert {\sum }_{m = 0}^{M} {a}_{m}^{( M )} {𝒦 ( {𝒦}_{I} 𝒦 )}^{m} \vert ρ 〉 - 〈 A + bI \vert 𝒰 \vert ρ 〉 \vert \\ = \vert {\sum }_{m = 0}^{M} {a}_{m}^{( M )} 〈 A \vert {𝒦 ( {𝒦}_{I} 𝒦 )}^{m} \vert ρ 〉 - 〈 A \vert 𝒰 \vert ρ 〉 + b {\sum }_{m = 0}^{M} {a}_{m}^{( M )} - b \vert\end{matrix} , \qquad ( 183 )$$

Where in the second line the fact that [symbol] I| [symbol] ( [symbol] )^{m}|ρ [symbol] =Tr(ρ^{(m)})=1 is used, being ρ^{(m)} the state resulting from the circuit [symbol] ( [symbol] )^{m}.

In the case of adapted mitigation, for all M, Σₘ₌₀^{M}aₘ^{(M)}=Σₘ₌₀^{M}a_{Adap ,m}^{(M)}(μ)=1 by construction. Since in the limit of zero noise the Taylor approximation converges to ( [symbol] )⁻¹= [symbol] , it also follows from Eq. (41) that:

$${\sum }_{m = 0}^{M} {a}_{Tay , m}^{( M )} = 1 , for all M \qquad ( 184 )$$

Therefore, Eq. (167) is equivalent to (both for adapted mitigation and Taylor mitigation)

$${ε}_{KIK}^{( M )} ( b ) = {ε}_{KIK}^{( M )} ( 0 ) , \qquad ( 185 )$$

for all b real. This result implies that the error ε_{KIK}^{(M)}(0), associated with the actual observable A, can be evaluated using instead the shifted observable A+bI. By combining this property with Eqs. (154), (171), and (181), the inventors obtain the families of b-dependent bounds:

$${ε}_{KIK}^{( M )} ( 0 ) \leq \sqrt{Tr [ {( A + bI )}^{2} ]} \vert 1 - {\sum }_{m = 0}^{M} {a}_{Adap , m}^{( M )} ( μ ) ( {e}^{{- 2 {\int }_{0}^{T} ‖ ℒ ( t ) ‖ dt )}^{m + 1 / 2}} \vert , \qquad ( 186 )$$

$${ε}_{KIK}^{( M )} ( 0 ) \leq \frac{( 2 M + 1 ) ! !}{{2}^{M + 1} ( M + 1 ) !} \sqrt{Tr [ {( A + bI )}^{2} ]} {( {e}^{2 {\int }_{0}^{T} ‖ ℒ ( t ) ‖ dt} - 1 )}^{M + 1} \qquad ( 187 )$$

where [symbol] A+bI|A+bI [symbol] is written as Tr[(A+bI)²]. In the case of Eq. (186), values of 0≤μ<1 yield bounds for adapated mitigation, as per Eq. (154), and μ=1 yields bounds applicable to adapted mitigation and Taylor mitigation, cf. Eq. (171). On the other hand, Eq. (187) is a consequence of the Taylor-mitigation bound of Eq. (181).

The tightest bounds in Eqs. (186) and (187) are obtained by minimizing Tr[(A+bI)²]=Tr(A²)+2bTr(A)+b²Tr(I), with respect to b. A simple calculation shows that the minimum is attained by b such that the observable A+bI is traceless, i.e., Tr(A+bI)=0. The resulting expression is:

$$b = - \frac{Tr ( A )}{Tr ( I )} . \qquad ( 188 )$$

By substituting this result into Eqs. (186) and (187), the optimal bounds are obtained:

$${ε}_{KIK}^{( M )} ( 0 ) \leq \sqrt{Tr ( {A}^{2} ) - \frac{{[ Tr ( A ) ]}^{2}}{Tr ( I )}} \vert 1 - {\sum }_{m = 0}^{M} {a}_{Adap , m}^{( M )} ( μ ) {( {e}^{- 2 {\int }_{0}^{T} ‖ ℒ ( t ) ‖ dt} )}^{m + 1 / 2} \vert , \qquad ( 189 )$$

$${ε}_{KIK}^{( M )} ( 0 ) \leq \frac{( 2 M + 1 ) ! !}{{2}^{M + 1} ( M + 1 ) !} \sqrt{Tr ( {A}^{2} ) - \frac{{Tr ( A ) ]}^{2}}{Tr ( I )}} {( {e}^{2 {\int }_{0}^{T} ‖ ℒ ( t ) ‖ dt} - 1 )}^{M + 1} . \qquad ( 190 )$$

To conclude this detailed description of the principles of the present disclosure, the bounds previously derived are merged into a single expression. That is,

$$\begin{matrix}{ε}_{KIK}^{( M )} & \leq & \sqrt{Tr ( {A}^{2} ) - \frac{{[ Tr ( A ) ]}^{2}}{Tr ( I )}} \vert 1 - {\sum }_{m = 0}^{M} {a}_{Adap , m}^{( M )} ( μ ) {e}^{- 2 ( m + 1 / 2 ) {\int }_{0}^{T} ‖ ℒ ( t ) ‖ dt} \vert , & ( 191 ) \\ & & for M = 1 , 2 , 3 & \\ & \leq & \sqrt{Tr ( {A}^{2} ) - \frac{{[ Tr ( A ) ]}^{2}}{Tr ( I )}} \vert 1 - {\sum }_{m = 0}^{M} {a}_{Adap , m}^{( M )} ( 1 ) {e}^{- 2 ( m + 1 / 2 ) {\int }_{0}^{T} ‖ ℒ ( t ) ‖ dt} \vert , & ( 192 ) \\ & & M = 1 , 2 , 3 , & \\ & \leq & \frac{( 2 M + 1 ) ! !}{{2}^{M + 1} ( M + 1 ) !} \sqrt{Tr ( {A}^{2} ) - \frac{{[ Tr ( A ) ]}^{2}}{Tr ( I )}} {( {e}^{2 {\int }_{0}^{T} ‖ ℒ ( t ) ‖ dr} - 1 )}^{M + 1} , & ( 193 )\end{matrix}$$

where Eq. (191) is equivalent to Eq. (188), and Eq. (192) follows by applying the optimization strategy of the previous section to Eq. (155). FIG. 20 graphically shows the upper bounds of Eqs. (191) and (192) on

$${\tilde{ε}}_{KIK}^{( M )} := \frac{{ε}_{KIK}^{( M )}}{\sqrt{Tr ( {A}^{2} ) - \frac{{[ Tr ( A ) ]}^{2}}{Tr ( I )}}} ,$$

for mitigation orders M=1, 2, 3. Eq. (193) corresponds to Eq. (190) and is the looser bound according to FIG. 20. Note that the dashed lines in FIG. 20 are always above the solid line in a given order, indicating that the Taylor bounds with μ=1 are looser than the adaptive bounds. It is also recalled that the bound of Eq. (192) is valid for both adapted mitigation and Taylor mitigation, in addition to being independent of μ. On the other hand, the bound of Eq. (193) is valid for Taylor mitigation and for all M≥1. From this bound it can also be seen that the error ε_{KIK}^{(M)} is exponentially decreasing in M if ∫₀^{T}∥ [symbol] (t)∥dt<½ln (2), since the prefactor

$$\frac{( 2 M + 1 ) ! !}{{2}^{M + 1} ( M + 1 ) !} Satisfies \frac{( 2 M + 1 ) ! !}{{2}^{M + 1} ( M + 1 ) !} \leq \frac{3}{8} .$$

The inventors also stress that, once coherent noise is converted into incoherent noise, via RC, the quantity ∫₀^{T}∥ [symbol] (t)∥dt accounts for the total error rate affecting the evolution [symbol] , irrespective of the depth or the width of the corresponding circuit. Therefore, the bounds of Eqs. (195)-(197) are meaningful to assess the performance of the KIK method applied to circuits [symbol] of arbitrary size. It is also important to note that generic QEM methods can be useful

so long as the total error rate is not excessively high [20]. In the context of the KIK method, QEM can be scalable if ∫₀^{T}∥ [symbol] (t)∥dt is kept below a fixed value for increasingly large circuits, and if for this value the bound of Eq. (191) is sufficiently small.

1. A method for quantum error mitigation (QEM) of noise in a quantum system configured to execute a quantum circuit, said noise inducing an error on a noise-free evolution U of said quantum circuit the method comprising:
defining a noisy evolution operator, [symbol] , associated with a noisy evolution of said quantum circuit, said noisy evolution operator, [symbol] , being configured to execute a Hamiltonian drive H(t) which generates said noise-free evolution U in the absence of noise; and
defining a corresponding inverse noisy evolution operator, [symbol] , being a pulse inverse operator configured to execute a corresponding inverse Hamiltonian drive HI(t)=−H(T−t) where T is total execution time of [symbol] ;
creating an operator [symbol] , which is an approximate square of a noise channel associated with [symbol] , said operator [symbol] representing execution of said Hamiltonian drive H(t) followed by execution of said corresponding inverse Hamiltonian drive HI(t) thereby enabling error mitigation of noise in said quantum system.

2. The method according to claim 1, characterized by at least one of the following,
comprising utilizing said operator [symbol] , to perform the quantum error mitigation of noise in said quantum system by executing a predetermined ensemble of said operators [symbol] and [symbol] in a predetermined order, comprising executing circuits of the form [symbol] ( [symbol] )^{m}, (0≤m≤M), where M is the mitigation order; and
comprising utilizing said approximate square of the noise channel operator [symbol] to define a noise mitigated evolution operator, [symbol] _{KIK}, as
$${𝒰}_{KIK} = 𝒦 \frac{1}{\sqrt{{𝒦}_{I} 𝒦}} ,$$
executing circuits of the form [symbol] ( [symbol] )^{m}, (0≤m≤M), where M is the mitigation order.

3. (canceled)

4. The method according to claim 1, comprising utilizing said approximate square of the noise channel operator [symbol] to define a noise mitigated evolution operator, [symbol] _{KIK}, as
$${𝒰}_{KIK} = 𝒦 \frac{1}{\sqrt{{𝒦}_{I} 𝒦}} ,$$
and executing circuits of the form [symbol] ( [symbol] )^{m}, (0≤m≤M), where M is the mitigation order, by executing the following protocol to perform the quantum error mitigation:
defining an Mth-order (M≥0) approximation [symbol] _{KIK}^{(M)} of said noise mitigated evolution operator [symbol] _{KIK}, as [symbol] _{KIK}^{(M)}=Σₘ₌₀^{M}aₘ^{(M)} [symbol] ( [symbol] )^{m}, with coefficients {aₘ^{(M)}}ₘ₌₀^{M};
choosing said coefficients {aₘ^{(M)}}ₘ₌₀^{M} by minimizing a difference between the function
$$\frac{1}{\sqrt{x}} and {\sum }_{m = 0}^{M} {a}_{m}^{( M )} {x}^{2 m + 1} ;$$
defining (M+1) different circuits, each circuit comprising: preparation of the initial state; a single execution of a circuit sequence in the form of [symbol] ( [symbol] )^{m} on the initial state, for 0≤m≤M; and measurement of a final state;
for each of said (M+1) circuits, executing Nm shots (Nm≥1) to acquire predetermined statistical accuracy of a measured observable A of interest;
for each m-th circuit sequence, calculating mean value of the measured observable [symbol] A [symbol] ₘ; and
calculating an expectation value, being an average [symbol] A [symbol] of a weighted mean of M values of the measured observables [symbol] A [symbol] ₘ, where weights are determined by coefficients {aₘ^{(M)}}ₘ₌₀^{M}.

5. The method according to claim 4, comprising arranging an execution order of said Nₘ shots (Nₘ≥1) by carrying out the following:
dividing a total number N of shots, N=Σₘ₌₀^{M}Nₘ, into S sets {n₀, . . . , n_{M}}, S≥1, where in each set s, nₘ=Nₘ/S shots are executed for each circuit [symbol] ( [symbol] )^{m};
executing said S sets, each comprising Nₛ=Σₘ₌₀^{M}nₘ shots, such that each set is executed faster than a noise drift time scale of the quantum system;
measuring a value [symbol] A [symbol] ₛ corresponding to said observable of interest for each set s; and
calculating a final mitigated value for the observable of interest as
$${〈 A 〉}^{mit} = \frac{1}{s} {\sum }_{s = 1}^{S} {〈 A 〉}_{s} ,$$
thereby minimizing the effect of drift in the noise parameters during the execution of the shots.

6. The method according to claim 1, wherein noise dynamics arises from at least one of the following: (i) different noise of different elements of said quantum circuit; and (ii) uncontrollable changes in noise parameters.

7. The method according to claim 1, wherein the noise inducing the error on the noise-free evolution U of said quantum circuit is spatially correlated.

8. The method according to claim 1, wherein the noise inducing the error on the noise-free evolution U of said quantum circuit is coherent noise, being mitigated by first converting coherent errors into incoherent errors by randomized compiling.

9. The method according to claim 1, wherein the noise inducing the error on the noise-free evolution U of said quantum circuit is Markovian.

10. The method according to claim 1, wherein the noise inducing the error on the noise-free evolution U of said quantum circuit is non-Markovian, the method comprising implementing dynamical decoupling.

11. The method according to claim 4, comprising dividing time t of the noise-free evolution U of said quantum circuit into p several intervals (p=1 . . . P), t₁ . . . t_{P}; defining a total noise mitigated evolution operator [symbol] _{KIK}^{tot}as [symbol] _{KIK}^{tot}= [symbol] _{KIK}^{t1}· . . . · [symbol] _{KIK}^{tP}, thereby enabling to neglect small-magnitude higher order noise components and improve accuracy of the QEM.

12. The method according claim 4, wherein said Mth order approximation is Mth order Taylor expansion.

13. The method according to claim 3, wherein the operator
$$\frac{1}{\sqrt{{K}_{I} K}}$$
is approximated with a power series in a finite noise range, the approximation being chosen adaptively to optimize the QEM in a predetermined desired range of noise.

14. The method according to claim 1, wherein said quantum system is a quantum computer.

15. The method according claim 1, wherein said quantum system is a quantum simulator.

16. The method according to claim 1, wherein said quantum system is a quantum sensor.

17. A control system for controlling operation of a quantum system executing a quantum circuit, by carrying out the method according to claim 1 for quantum error mitigation (QEM) of noise in the quantum system, the control system comprising:
a first processor configured and operable to carry out the following: define a noisy evolution operator, [symbol] , associated with a noisy evolution of the quantum circuit and configured to execute a Hamiltonian drive H(t) which generates noise-free evolution U of the quantum circuit in the absence of noise; define a corresponding inverse noisy evolution operator, [symbol] , being a pulse inverse operator configured to execute a corresponding inverse Hamiltonian drive HI=−H(T−t) T being total execution time of [symbol] ; and create an operator [symbol] , which is an approximate square of a noise channel associated with [symbol] , said operator [symbol] representing execution of said inverse noisy evolution operator, [symbol] , immediately after said noisy evolution operator, [symbol] , thereby enabling error mitigation of noise in said quantum system;
a noise-associated error mitigator utility configured and operable to utilize said operator [symbol] , to execute a predetermined ensemble of said operators [symbol] in a predetermined order.

18. A quantum system configured to execute a quantum circuit on an input state providing a measured observable, the quantum system comprising the control system of claim 17.

19. The quantum system according to claim 18, configured as a quantum computer.

20. The quantum system according to claim 18, configured as a quantum simulator.

21. The quantum system according to claim 18, configured as a quantum sensor.
